(19) United States
(12) Patent Application Publication
(10) Pub. No.: US 2011/0110518 A1
(43) Pub. Date: May 12, 2011

(54) Obfuscating reception of communiqué affiliated with a source entity in response to receiving information indicating reception of the communiqué

(75) Inventors: Alexander J. Cohen, Mill Valley, CA (US); Edward K.Y. Jung, Bellevue, WA (US); Royce A. Levien, Lexington, MA (US); Robert W. Lord, Seattle, WA (US); Mark A. Malamud, Seattle, WA (US); William H. Mangione-Smith, Kirkland, WA (US); John D. Rinaldo, JR., Bellevue, WA (US); Clarence T. Tegreene, Bellevue, WA (US)

(73) Assignee: Searete LLC

(21) Appl. No.: 12/806,738

(22) Filed: Aug. 18, 2010

Related U.S. Application Data
(63) Continuation-in-part of application No. 12/228,664, filed on Aug. 14, 2008.
Application No. 12/228,664 is a continuation-in-part of application No. 12/228,873, filed on Aug. 15, 2008.
Application No. 12/228,873 is a continuation-in-part of application No. 12/287,268, filed on Oct. 7, 2008.
Application No. 12/287,268 is a continuation-in-part of application No. 12/454,113, filed on May 12, 2009.
Application No. 12/454,113 is a continuation-in-part of application No. 12/799,794, filed on Apr. 29, 2010.
Application No. 12/799,794 is a continuation-in-part of application No. 12/802,139, filed on May 27, 2010.
Application No. 12/802,139 is a continuation-in-part of application No. 12/802,136, filed on May 28, 2010.
Application No. 12/802,136 is a continuation-in-part of application No. 12/802,863, filed on Jun. 14, 2010.
Application No. 12/802,863 is a continuation-in-part of application No. 12/802,922, filed on Jun. 15, 2010.
Application No. 12/802,922 is a continuation-in-part of application No. 12/804,765, filed on Jul. 27, 2010.
Application No. 12/804,765 is a continuation-in-part of application No. 12/804,832, filed on Jul. 28, 2010.
Application No. 12/804,832 is a continuation-in-part of application No. 12/806,677, filed on Aug. 17, 2010.

(51) Int. Cl. H04L 9/00

(52) U.S. Cl. 380/255

(57) ABSTRACT

A computationally implemented method includes, but is not limited to: receiving communiqué reception information that indicates reception of a communiqué that is affiliated with a source entity and that is directed to an end user; and presenting, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity. In addition to the foregoing, other method aspects are described in the claims, drawings, and text forming a part of the present disclosure.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 12/228,664, entitled SYSTEM AND METHOD FOR TRANSMITTING ILLUSORY IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Aug. 14, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/228,873, entitled SYSTEM AND METHOD FOR TRANSMITTING ILLUSORY AND NON-ILLUSORY IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Aug. 15, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/287,268, entitled SYSTEM AND METHOD FOR TRANSMITTING ILLUSORY IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Oct. 7, 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/454,113, entitled SYSTEM AND METHOD FOR MODIFYING ILLUSORY USER IDENTIFICATION CHARACTERISTICS, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed May 12, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/799,794, entitled SYSTEM AND METHOD FOR CONDITIONALLY TRANSMITTING ONE OR MORE LOCUM TENENTES, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Apr. 29, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,139, entitled OBFUSCATING IDENTITY OF A SOURCE ENTITY AFFILIATED WITH A COMMUNIQUé IN ACCORDANCE WITH CONDITIONAL DIRECTIVE PROVIDED BY A RECEIVING ENTITY, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed May 27, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,136, entitled OBFUSCATING IDENTITY OF A SOURCE ENTITY AFFILIATED WITH A COMMUNIQUé IN ACCORDANCE WITH CONDITIONAL DIRECTIVE PROVIDED BY A RECEIVING ENTITY, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed May 28, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,863, entitled OBFUSCATING IDENTITY OF A SOURCE ENTITY AFFILIATED WITH A COMMUNIQUé DIRECTED TO A RECEIVING USER AND IN ACCORDANCE WITH CONDITIONAL DIRECTIVE PROVIDED BY THE RECEIVING USER, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Jun. 14, 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/802,922, entitled OBFUSCATING IDENTITY OF A SOURCE ENTITY AFFILIATED WITH A COMMUNIQUé DIRECTED TO A RECEIVING USER AND IN ACCORDANCE WITH CONDITIONAL DIRECTIVE PROVIDED BY THE RECEIVING USER, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Jun. 15, 2010, which is currently co-pending, or is an application of which a currently co-pending application is entitled to the benefit of the filing date.

For purposes of the USPTO extra-statutory requirements, the present application constitutes a continuation of U.S. patent application Ser. No. 12/804,765, entitled OBFUSCATING RECEPTION OF COMMUNIQUé AFFILIATED WITH A SOURCE ENTITY, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Jul. 27, 2010, which is currently co-pending, or is an application of which a currently co-pending application is entitled to the benefit of the filing date.

For purposes of the USPTO extra-statutory requirements, the present application constitutes a continuation of U.S. patent application Ser. No. 12/804,832, entitled OBFUSCATING RECEPTION OF COMMUNIQUé AFFILIATED WITH A SOURCE ENTITY, naming Alexander J. Cohen; Edward K. Y. Jung; Royce A. Levien; Robert W. Lord; Mark A. Malamud; William H. Mangione-Smith; John D. Rinaldo, Jr. and Clarence T. Tegreene as inventors, filed Jul. 28, 2010, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

### SUMMARY

A computationally implemented method includes, but is not limited to receiving communiqué reception information that indicates reception of a communiqué that is affiliated with a source entity and that is directed to an end user; and presenting, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A computationally implemented system includes, but is not limited to: means for receiving communiqué reception information that indicates reception of a communiqué that is affiliated with a source entity and that is directed to an end user; and means for presenting, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity. In addition to the foregoing, other system aspects are described in the claims, drawings, and text forming a part of the present disclosure.

A computationally implemented system includes, but is not limited to: circuitry for receiving communiqué reception information that indicates reception of a communiqué that is affiliated with a source entity and that is directed to an end user; and circuitry for presenting, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity. In addition to the foregoing, other system aspects are described in the claims, drawings, and text forming a part of the present disclosure.

A computer program product including a signal-bearing medium bearing one or more instructions for receiving communiqué reception information that indicates reception of a communiqué that is affiliated with a source entity and that is directed to an end user; and one or more instructions for presenting, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity. In addition to the foregoing, other computer program product aspects are described in the claims, drawings, and text forming a part of the present disclosure.

A method for obfuscating reception of a communiqué that is affiliated with a particular source entity and that is directed to a particular end user in response to receiving communiqué reception information that indicates reception of the communiqué, the obfuscation of the reception of the communiqué being in accordance with one or more conditional directives of the particular end user, the method includes receiving communiqué reception information that indicates reception of a communiqué that is affiliated with a source entity and that is directed to an end user; and presenting, using one or more processors, a covert indicator that covertly indicates reception of the communiqué, the presenting of the covert indicator being in accordance with one or more conditional directives of the end user to conditionally obfuscate the reception of the communiqué affiliated with the source entity, the presenting of the covert indicator being in response to receiving the communiqué reception information and in lieu of presenting direct indication of reception of the communiqué.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1a and 1b show a high-level block diagram of a communication device 10 operating in a network environment.

FIG. 2a shows another perspective of the communiqué reception information receiving module 102 of the communication device 10 of FIGS. 1a and 1b.

FIGS. 2b and 2c show another perspective of the covert indicator presenting module 104 of the communication device 10 of FIGS. 1a and 1b.

FIG. 2d shows another perspective of the conditional directive receiving module 106 of the communication device 10 of FIGS. 1a and 1b.

FIG. 2e shows another perspective of the communiqué reception information presenting module 110 of the communication device 10 of FIGS. 1a and 1b.

FIG. 2f shows another perspective of the memory 140 of the communication device 10 of FIGS. 1a and 1b.

FIG. 3 is a high-level logic flowchart of a process.

FIG. 4a is a high-level logic flowchart of a process depicting alternate implementations of the communiqué reception information receiving operation 302 of FIG. 3.

FIG. 4b is a high-level logic flowchart of a process depicting alternate implementations of the communiqué reception information receiving operation 302 of FIG. 3.

FIG. 4c is a high-level logic flowchart of a process depicting alternate implementations of the communiqué reception information receiving operation 302 of FIG. 3.

FIG. 4d is a high-level logic flowchart of a process depicting alternate implementations of the communiqué reception information receiving operation 302 of FIG. 3.

FIG. 4e is a high-level logic flowchart of a process depicting alternate implementations of the communiqué reception information receiving operation 302 of FIG. 3.

FIG. 4f is a high-level logic flowchart of a process depicting alternate implementations of the communiqué reception information receiving operation 302 of FIG. 3.

FIG. 4g is a high-level logic flowchart of a process depicting alternate implementations of the communiqué reception information receiving operation 302 of FIG. 3.

FIG. 4h is a high-level logic flowchart of a process depicting alternate implementations of the communiqué reception information receiving operation 302 of FIG. 3.

FIG. 5a is a high-level logic flowchart of a process depicting alternate implementations of the covert indicator presenting operation 304 of FIG. 3.

FIG. 5b is a high-level logic flowchart of a process depicting alternate implementations of the covert indicator presenting operation 304 of FIG. 3.

FIG. 5c is a high-level logic flowchart of a process, depicting alternate implementations of the covert indicator presenting operation 304 of FIG. 3.

FIG. 5d is a high-level logic flowchart of a process depicting alternate implementations of the covert indicator presenting operation 304 of FIG. 3.

FIG. 5e is a high-level logic flowchart of a process depicting alternate implementations of the covert indicator presenting operation 304 of FIG. 3.

FIG. 5f is a high-level logic flowchart of a process depicting alternate implementations of the covert indicator presenting operation 304 of FIG. 3.

FIG. 5g is a high-level logic flowchart of a process depicting alternate implementations of the covert indicator presenting operation 304 of FIG. 3.

FIG. 5h is a high-level logic flowchart of a process depicting alternate implementations of the covert indicator presenting operation 304 of FIG. 3.

FIG. 5i is a high-level logic flowchart of a process depicting alternate implementations of the covert indicator presenting operation 304 of FIG. 3.

FIG. 6 is another high-level logic flowchart of another process.

FIG. 7 is a high-level logic flowchart of a process depicting alternate implementations of the communiqué presenting operation 672 of FIG. 6.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In recent years, the computing/communication industry has enjoyed dramatic technological advancement and spectacular commercial popularity, providing numerous benefits for those who choose to enjoy the fruits of technological developments in the computing/communication sectors. For example, with the rapid development of personal communication devices such as cellular telephones, personal digital assistants (PDAs), Smartphones, laptop computers, desktop computers, and so forth, users of such devices are now able to maintain 24/7 connectivity with other users at relatively low costs. Such connectivity may be via a variety of communication channels including, for example, telephone calls, emails, Voice over Internet Protocol (VoIP) calls, text messaging (e.g., short message service or SMS, or multimedia messaging service or MMS), instant messaging (IM), and so forth. Unfortunately, in addition to providing significant benefits to users, users of such technologies must also deal with a whole new slate of issues and problems that have also arisen with these new technologies.

For example, users of such personal communication devices (e.g., cellular telephones, Smartphones, laptop and desktop computers, and so forth) face a number of privacy and security issues. One such issue that has surfaced with respect to users of personal communication devices is that communiqués (e.g., electronic communications including, for example, telephone calls, VoIP, emails, text messages, IMs, and so forth) received through these personal communication devices are often easily accessible by those other than the primary users (e.g., owners) of such devices. As a result, highly sensitive communiqués (e.g., confidential personal or business communiqués) that are directed to the primary users of such devices may often be accessed by others potentially causing embarrassing if not devastating consequences.

For example, it was extensively reported recently that a well-known and well-admired professional athlete was discovered having an extramarital affair by his spouse. It was widely reported that the spouse discovered this affair when she found a voice message from her husband's mistress on her husband's cellular telephone. Because the husband (i.e., famous professional athlete) in that incident had not erased or was not able to hide or disguise the voice message from his mistress, the husband had to endure considerable public humiliation and substantial financial loss due to loss of commercial endorsement income.

Of course the need for maintaining communication or communiqué secrecy is not just limited to personal situations, but may also be necessary in professional/business context. For example, it may be inappropriate for a person to receive certain sensitive communiqués from particular parties (e.g., communiqués from certain clients or competitors, or communiqués from a particular website or business) while at work or while at other locations (e.g., when meeting with clients).

According to various embodiments, methods, systems, and computer program products are provided for obfuscating reception of a communiqué affiliated with a source user and that is directed to an end user, the reception of the communiqué being based on one or more conditional directives provided by the end user. More particularly, the methods, systems, and computer program products may be designed to receive communiqué reception information that indicates reception of a communiqué (e.g., an email, an instant message (IM), a text message, a telephone call, a Voice over Internet Protocol (VoIP) call, a video message, and so forth) that is affiliated with a particular source entity and that is directed to an end user; and to present, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity. As will be further described herein, the methods, systems, and computer program products may be implemented at a client device, herein a “communication device,” (e.g., a computing device capable of electronic communication including, for example, a mobile telephone, a Smartphone, a personal digital assistant, a laptop or desktop computer, and so forth) of an end user.

In some embodiments, the methods, systems, and computer program products may be particularly useful in situations where the communication device of the end user does not at least “successfully” receive the communiqué that is affiliated with the particular source entity but instead only receives, at least initially, information (herein “communiqué reception information”) that indicates the reception of the communiqué. For example, there are at least two situations when this may occur: when the received communiqué is a “missed” communiqué (e.g., a missed telephone call) that is not successfully received or accepted by the communication device; or when the received communiqué is actually received at a server rather than being directly received by the communication device of the end user such as in the case of emails of certain types of email services that employ, for example, pull-type technology (as opposed to employing push-type technology). In either cases, the communication device of the end user may only receive communiqué reception information that indicate certain basic header-type information (e.g., address, username, or telephone number of the sender or source of the communiqué, subject heading if there is one, reception time stamp, and so forth) related to the communiqué (e.g., a communiqué that was received by a server or a communiqué that was unsuccessfully received by the communication device). Note that “unsuccessful” here does not mean that the communiqué was not actually received by the communication device. Instead, it merely means that the communiqué was not picked-up or accepted by the communication device because the communication device was either turned-off or in a low power mode, or there was no end user available at the communication device to pick-up or receive the communiqué.

For purposes of the following description, a “communiqué” may be in reference to any one of a variety of electronic communication means including, for example, a telephone call, an email message, a text message (e.g., short message service “SMS” or multimedia messaging service “MMS”), an instant message (IM), a Voice over Internet Protocol (VoIP) call, a voice message, a video message, and so forth. In contrast, references to “communiqué reception information” may be in reference to any data or information that indicates one or more aspects related to reception of a communiqué. In some cases, communiqué reception information may be header information (i.e., header data), or may include or indicate at least header-type data. For example, in some embodiments, such communiqué reception information may indicate the name, telephone number, or address (e.g., email address, IP address, URL) of a sender or source for the communiqué, the subject heading of the communiqué if there is one, reception time stamp, and so forth. In some cases, a communiqué reception information may be in the form of a header data or information that may be provided in connection with a corresponding communiqué.

As will be further described herein, a “source entity” may be in reference to any entity affiliated with a communiqué that an end user, for example, wishes to obfuscate the identity of. In some instances, a source entity may be the original or an intermediate source for the communiqué. In some cases, a source entity may include, for example, a source user who may be a human or robotic user and/or a source user device such as a cellular telephone, Smartphone, laptop or desktop computer, and so forth. In some cases, a source entity may be an organization such as a business or a trade or interest group. In some instances, a source entity may be a website.

An “end user” may be a human or robotic user that is designated to receive one or more communiqués. In some cases where the end user is a robotic user, the robotic user may be a network device such as a network server for, for example, a voicemail service, a text messaging service, or a web-based application service. In some cases, an end user may receive one or more communiqués through a “communication device” (which may also be referred to as a “receiving device”). A communication device may be any type of computing device that is designed to transmit/receive communiqués including, for example, a cellular telephone, a Smartphone, a personal digital assistant (PDA), a landline telephone, a laptop or desktop computer, a tablet computer, a workstation, and so forth.

A “conditional directive,” as will be discussed herein, relates to a command or instruction to execute one or more actions when one or more conditions have occurred and/or detected. Thus, for purposes of this description, a conditional directive may identify the one or more actions that are to be executed in order to achieve a particular result (e.g., obfuscate reception of a communiqué affiliated with a particular source entity) and/or identify the necessary (e.g., requisite) conditions that may trigger the one or more actions to be executed. For example, a conditional directive may be a command to intercept (e.g., seize) a communiqué reception information that is being transmitted to an end user (or a communication device belonging to the end user) when the communiqué reception information indicates reception of a communiqué that is affiliated with a particular source entity, and to present, in lieu of presenting any direct indication of reception of the communiqué, a covert indicator that covertly (e.g., indirectly) indicates the reception of the communiqué.

A “covert indicator,” as will be described herein, may be in reference to any indicator that may covertly or indirectly indicate reception of a communiqué that is affiliated with a particular source entity and that is directed to a particular end user. Such a covert indicator may only alert certain entities, such as the end user who, the communiqué is directed to and who may have actually selected the covert indicator for presentation. From another perspective, a covert indicator may not, at least, directly indicate the reception of the communiqué that it is covertly indicating, the communiqué itself, the source entity affiliated with received communiqué, the relationship between the source entity and the received communiqué, and/or any other aspect of the communiqué and/or the source entity that would alert a third party regarding the reception of the communiqué, the particular source entity affiliated with the communiqué, and/or the relationship between the communiqué and the particular source entity. As will be further described herein, a covert indicator may come in a variety of different forms. For example, depending on the particular circumstances (e.g., type of communication device presenting the covert indicator as well as the type of communiqué being covertly indicated), a covert indicator may be a covert audio indicator, a covert visual indicator, a covert vibrating indicator, or any combination thereof.

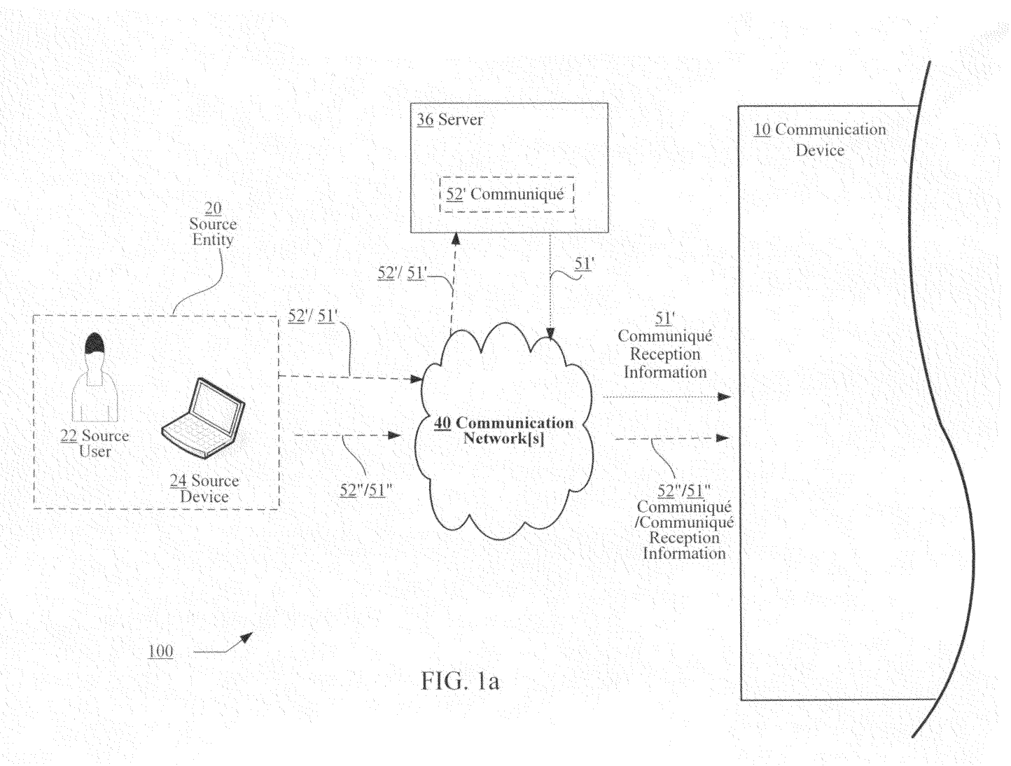

Turning now to FIGS. 1a, and 1b illustrating an example environment 100 in which the methods, systems, circuitry, and computer program products in accordance with various embodiments may be implemented by a communication device 10. Among other things, the methods, systems, circuitry, and computer program products implemented by the communication device 10 may be designed to receive one or more conditional directives 50 from an end user 32, the one or more conditional directives 50 delineating (e.g., indicating or defining) one or more conditions for obfuscating reception of a communiqué 52* (e.g., a communiqué 52′ that is received by a server 36 or a communiqué 52″ that is unsuccessfully received by the communication device 10) that is determined to be affiliated with a particular source entity 20 and directed to the end user 32. In some embodiments, the one or more conditional directives 50 may also define how the reception of the communiqué 52* may be obfuscated from one or more third parties while still covertly indicating the reception of the communiqué 52* to particular entities such as the end user 32. Note that in the following, “*” represents a wildcard. Thus, references to communiqué 52* in the following may be in reference to communiqué 52′ or communiqué 52″ of the example environment 100 of FIGS. 1a and 1b. Similarly, references in the following to communiqué reception information 51* may be in reference to communiqué reception information 51′ or communiqué reception information 51″ of the example environment 100 of FIGS. 1a and 1b.

In any event, the methods, systems, circuitry, and computer program products, when implemented by the communication device 10, may be further designed to receive communiqué reception information 51* that indicates the reception of the communiqué 52* that is affiliated with the source entity 20 and that is directed to the end user 32; and to present, in response to receiving the communiqué reception information 51* and in lieu of presenting direct indication of reception of the communiqué 52*, a covert indicator 54 that covertly indicates reception of the communiqué 52*, the presenting of the covert indicator 54 being in accordance with one or more conditional directives 50 of the end user 32 to conditionally obfuscate the reception of the communiqué 52* affiliated with the source entity 20. In some cases, the methods, systems, circuitry, and computer program products, when implemented by the communication device 10, may be further designed to hold the communiqué reception information 51* without releasing (e.g., presenting by displaying or audioally indicating) the communiqué reception information 51*, and to, upon detecting occurrence of one or more triggering events associated with the communication device 10, presenting the communiqué reception information 51* in accordance with the one or more conditional directives 50.

In various embodiments, the communiqué reception information 51* that may be received by the communication device 10 may come in a variety of different forms. For example, in some embodiments, the communiqué reception information 51* may be in the form of header information (i.e., header data). In some embodiments, header information may be any supplemental data that may be placed at the beginning of a block of data, such as a data packet, that is being transmitted. In some embodiments, the received communiqué reception information 51* may indicate various header-type information including, for example, the identity, address, and/or telephone number of the sender or source for the communiqué 52*, the subject heading for the communiqué 52* if there is one (e.g., such as the case when the communiqué 52* is an email), reception time stamp, and so forth. In embodiments where the communiqué 52* is, for example, a missed telephone call, the communiqué reception information 51* may be received embedded in a ring signal of the missed communiqué 52″ (e.g., a missed telephone call).

The communication device 10 implementing the methods, systems, circuitry, and computer program products may be a computing device (e.g., a device having at least a processor) capable of receiving/transmitting electronic communications such as, for example, emails, text messages, instant messages (IM), telephone calls, Voice over Internet Protocol (VoIP), voice messages, video messages or calls, and/or other forms of electronic communications (e.g., communiqués 52*). In some embodiments, the communication device 10 may be, for example, a cellular telephone, a Smartphone, a personal digital assistant (PDA), a landline telephone, a laptop or desktop computer, a tablet computer, a workstation, and so forth. The communication device 10 may be designed to communicate via one or more communication networks 40. The one or more communication networks 40 may include one or more of a local area network (LAN), metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, a Client/Server network, a virtual private network (VPN), and so forth.

Referring particularly now to the example, environment 100 of FIGS. 1a and 1b, the example environment 100 depicted in FIGS. 1a and 1b illustrates two distinct scenarios. In the first scenario, a communiqué 52′ that is affiliated with (e.g., transmitted by) the source entity 20 and that is directed to the end user 32 (via communication device 10) is transmitted to a server 36 rather than being transmitted directly to the communication device 10 of the end user 32. After receiving the communiqué 52′, the server 36, without transmitting the communiqué 52′, may transmit communiqué reception information 51′ that indicates the reception of the communiqué 52′ to the communication device 10 in order to notify the end user 32 regarding the reception of the communiqué 52′. In some cases, the communiqué reception information 51′ that may be received by the communication device 10 may be in the form of header data or information that may have been originally provided by the source entity 20 in connection with the communiqué 52′. In some cases, the communiqué reception information 51′ that may be received by the communication device 10 may be in the form of a listing on a list of received communiqués 52*(e.g., a list of received emails). This type of scenario may be seen, for example, in communication systems that employ pull technology such as those systems employed by certain email service providers including, for example, Hotmail, Gmail, Yahoo mail, and so forth.

In the second scenario illustrated by the example environment 100 of FIGS. 1a and 1b, a communiqué 52″ that is affiliated with (e.g., transmitted by) the source entity 20 and that is directed to the end user 32 (via communication device 10) is “unsuccessfully” received by the end user 32 via the communication device 10. The reception of the communiqué 52″ may be “unsuccessful” as a result of the end user 32 not being present or available at the communication device 10 to take or accept the communiqué 52″ (e.g., a missed communiqué 52* such as a missed telephone call) or because the communication device 10 was turned-off or was in a lower-power consumption mode when the communiqué 52″ was unsuccessfully received by the communication device 10. As a result of the unsuccessful reception of the communiqué 52″, the communication device 10 may have received communiqué reception information 51″ that may have been transmitted together with the missed communiqué 52″ or may have been embedded with the missed communiqué 52″ (e.g., in the case where the communiqué 52″ is a missed telephone call, the communiqué reception information 51″ may be embedded in the ring signal of the missed telephone call). For ease of illustration and understanding, the communiqué 52″ that may be “unsuccessfully” received by the communication device 10 through this second scenario may be referred to herein as a “missed” or an “unsuccessful” communiqué 52*.

Note that the communication device 10 in either the first scenario or the second scenario will receive communiqué reception information 51*(e.g., communiqué reception information 51′ in the first scenario or communiqué reception information 51″ in the second scenario) rather than successfully receiving the communiqué 52*(e.g., communiqué 52′ in the first scenario or communiqué 52″ in the second scenario) itself. Thus, in order to obfuscate the reception of a communiqué 52* that is affiliated with a particular source entity 20 and that is directed to a particular end user 32, the methods, systems, circuitry, and computer program products, in accordance with various embodiments, may be designed to intercept the communiqué reception information 51* to, among other things, prevent any direct indications of reception of the communiqué 52* from being at least initially (e.g., automatically) presented in response to receiving the communiqué reception information 51*. As with the other operations to be described herein, the interception of the communiqué reception information 51* may be in accordance with one or more conditional directives 50 of the end user 32.

As will be further described herein, in various embodiments the interception of the communiqué reception information 51* may involve holding (e.g., storing), at least temporarily, the communiqué reception information 51* in memory 140 (e.g., volatile or non-volatile memory, cache memory, and so forth) without releasing the communiqué reception information 51*(e.g., without presenting or disseminating the communiqué reception information 51*) at least until the occurrence of one or more triggering events have been detected. As will also be further described herein, detection of various types of triggering events may cause the communiqué reception information 51* to be eventually released (e.g., presented) including, for example, detecting that the end user 32 has possession of the communication device 10 that is executing the one or more conditional directives 50 of the end user 32, detecting that a particular third party is outside the proximate vicinity of the communication device 10, detecting that the communication device 10 is or is not at one or more specified locations (e.g., as specified by the one or more conditional directives 50), and/or detecting that the communication device 10 has reached or is at one or more specified points in time (e.g., as specified by the one or more conditional directives 50).

In embodiments where the communiqué reception information 51* is intercepted in accordance with one or more conditional directives 50 of the end user 32, the interception of the communiqué reception information 51* may be in response to determining that communiqué reception information 51* includes one or more representations (e.g., identifiers) associated with the particular source entity 20. Examples of representations of the source entity 20 that may be included in the communiqué reception information 51* include, for example, an address (email address, Uniform Resource Locator—URL, Internet Protocol or IP address, and so forth), a name such as a username, and/or a telephone number. In some instances, the interception of the communiqué reception information 51* in accordance with the one or more conditional directives 50 of the end user 32 may be in response to determining that the communiqué 52* was provided by the source entity 20.

In some cases, the interception of the communiqué reception information 51* in accordance with the one or more conditional directives 50 of the end user 32 may be as a function of location of the communication device 10 (e.g., intercepting the communiqué reception information 51*only when the communication device 10 is at one or more specified locations as specified by the conditional directives 50) and/or as a function of time with respect to the communication device 10 (e.g., intercepting the communiqué reception information 51*only when the communication device 10 is at one or more specified points in time as specified by the conditional directives 50). In some instances, the interception of the communiqué reception information 51* in accordance with the one or more conditional directives 50 of the end user 32 may be as a function of environmental conditions (e.g., intercepting the communiqué reception information 51* when a particular third party is in the proximate vicinity of the communication device 10). In other instances or in the same instances, the interception of the communiqué reception information 51* in accordance with the one or more conditional directives 50 of the end user 32 may be in response to determining that the end user 32 does not have possession (e.g., control) of the communication device 10 (e.g., may be based on presence or absence of password and/or biometric verification that the end user 32 has possession of the communication device 10). As will be further described herein, the presence or absence of other factors may also be the basis for the communiqué reception information 51* to be intercepted in various alternative embodiments.

As described earlier, in order to conditionally obfuscate the reception of a communiqué 52* that is affiliated with a particular source entity 20, the methods, systems, circuitry, and computer program products, in accordance with various embodiments, may be designed to present, in response to receiving the communiqué reception information 51* and in lieu of presenting direct indication of reception of the communiqué 52*, a covert indicator 54 that covertly indicates reception of the communiqué 52*, the presenting of the covert indicator 54 being in accordance with one or more conditional directives 50 of the end user 32. For these embodiments, the covert indicator 54* that may be presented (e.g., audioally or visually presented) may covertly indicate the reception of the communiqué 52* to only particular entities such as, for example, the end user 32 or other parties that the end user 32 may have confided in regarding the meaning of the covert indicator 54, which the end user 32 may have originally provided or selected through the one or more conditional directives 50.

In various embodiments, the covert indicator 54 that may be presented may not, at least directly, indicate the reception of the communiqué 52*, the communiqué 52* itself, the subject heading of the communiqué 52*(if there is such a heading such as in the case of an email), any representation (e.g., identifier, name, telephone number, email address, image, and so forth) associated with a source entity 20 that is affiliated with the communiqué 52*, or any other aspects of the communiqué 52* or the source entity 20 that may allow a third party to surmise the reception of the communiqué 52*, the identity of the source entity 20 affiliated with the communiqué 52*, and/or the relationship between the communiqué 52* and the source entity 20. As will be further described herein, a variety of covert indicators 54 may be presented in order to covertly indicate the reception of the communiqué 52*. In some embodiments, for example, the covert indicator 54 may be a covert audio indicator that may be audioally presented while in other embodiments, the covert indicator 54 may be a covert display or visual indicator that may be visually presented. In still other embodiments, the covert indicator 54 may be a covert vibration indicator that may be generated. In still other embodiments, the covert indicator 54 that may be presented may be any combination of a covert audio indicator, a covert visual indicator, and/or a covert vibration indicator.

Referring back to FIGS. 1a and 1b, and as briefly described above, an end user 32 may be a human user or robotic user (e.g., a server for an answering service). In various embodiments, a source entity 20 may comprise of a human or robotic source user 22 and/or a source user device 24 (e.g., a laptop computer, a desktop computer, a workstation, a Smartphone, a cellular telephone, a personal digital assistant (PDA), or other computing/communication devices). In some embodiments, and from another perspective, the source entity 20 may be a website or an organization such as a business, a social group, a trade/technical group, or an interest group.

In some cases, the communication device 10 may be designed to receive one or more conditional directives 50 from an end user 32 through a user interface 120. In various embodiments, the user interface 120, which may also be used to present communiqués 52* as well as to present covert indicators 54, may comprise of a display system 121 (e.g., a display monitor such as a touch screen or a liquid crystal display—LCD, and one or more input devices including, for example, a keypad or keyboard, a mouse, and so forth), an audio system 122 (e.g., one or more audio speakers and one, or more input devices including, for example, a microphone), and/or a vibrating system 123 (e.g., many of today's mobile communication devices such as cellular telephones and Smartphones currently include a vibration system for generating vibrations in order to, for example, alert an end user 32 to an incoming communiqué 52* such as a telephone call or a text message).

Among other things, the one or more conditional directives 50 that may be the basis for conditionally obfuscating the reception of a communiqué 52* that is affiliated with a particular source entity 20 may or may not be directly provided by the end user 32. In some cases, the one or more conditional directives 50 may identify the specific conditions that must exist in order to cause the communication device 10 to obfuscate the reception of a communiqué 52*(e.g., reception of a communiqué 52′ at a server 36 or reception of a missed communiqué 52″ at the communication device 10) that is affiliated with a particular source entity 20. Many types of “requisite” conditions may be identified by the one or more conditional directives 50 of the end user 32. For example, in some embodiments, the one or more conditional directives 50 that may be provided by the end user 32 may include a conditional directive 50 that requires that a determination be made that a communiqué reception information 51* that is received includes one or more representations (e.g., name, address, telephone number, and/or other identifiers) associated with the particular source entity 20 before taking specific actions (e.g., as specified by, for example, the one or more conditional directives 50) to conditionally obfuscate the reception of the communiqué 52. In some embodiments, the one or more conditional directives 50 that is executed by the communication device 10 may include a conditional directive 50 that may alternatively or additionally include a conditional directive 50 that requires that a determination be made that the communiqué 52 that was received (e.g., received at a server 36 or received at the communication device 10) was provided by the particular source entity 20 before conditionally obfuscating the reception of the communiqué 52*.

In some embodiments, the one or more conditional directives 50 that may be executed by the communication device 10 may include a conditional directive 50 that makes the conditional obfuscation of the reception of the communiqué 52* affiliated with the particular source entity 20 as a function of location of the communication device 10. For example, the one or more conditional directives 50 may direct the communication device 10 to conditionally obfuscate the reception of the communiqué 52* only when the communication device 10 is determined to be at (or not at) one or more specified locations as specified by, for example, the one or more conditional directives 50.

In some embodiments, the one or more conditional directives 50 that may be executed by the communication device 10 may include a conditional directive 50 that makes the conditional obfuscation of the reception of the communiqué 52* affiliated with the particular source entity 20 as a function of time with respect to the communication device 10. For example, the one or more conditional directives 50 may direct the communication device 10 to conditionally obfuscate the reception of the communiqué 52* only when the communication device 10 is determined to have reached one or more specified times of a day or calendar year as specified by, for example, the one or more conditional directives 50.

In some embodiments, the one or more conditional directives 50 that may be executed by the communication device 10 may include a conditional directive 50 that makes the conditional obfuscation of the reception of the communiqué 52* affiliated with the particular source entity 20 as a function of environmental conditions with respect to the communication device 10. For example, the one or more conditional directives 50 may direct the communication device 10 to conditionally obfuscate the reception of the communiqué 52* only when a particular third party is determined to be in the proximate vicinity (e.g., within 3 feet, 5 feet, 8 feet, or within some other distance from the communication device 10 froth which the third party may be able to see/hear/sense messages that are presented through the communication device 10) of the communication device 10 as specified by, for example, the one or more conditional directives 50. A determination as to whether a particular third party is within the proximate vicinity of the end user 32 may be based on data provided from a number of sources including, for example, a personal management application such as Microsoft Outlook, from microblog entries (e.g., “tweets”), and/or from data provided by one or more sensors 150 (e.g., image capturing device 152, audio capturing device 153, and so forth).

In some embodiments, the one or more conditional directives 50 that may be executed by the communication device 10 may include a conditional directive 50 that requires the communication device 10 to determine that the communication device 10 is not possessed by the end user 32 before obfuscating the reception of the communiqué-52*. For example, the conditional directives 50 may direct the communication device 10 to conditionally obfuscate the reception of the communiqué 52* only in the absence of verification (e.g., password verification or biometric verification such as a facial recognition verification, a retinal scan verification, a voice verification, or a fingerprint verification) of the end user 32 having possession of the communication device 10.

If the “necessary” conditions, as specified by the one or more conditional directives 50 and as described above, have been determined to have occurred, then the communication device 10 may obfuscate reception of the communiqué 52* affiliated with the particular source entity 20 in a variety of different ways depending on the specific circumstances (e.g., the type of communiqué 52* that was received and/or the type of communication device 10 executing the one or more conditional directives 50). For example, in some embodiments, in order to obfuscate reception of a communiqué 52*that is affiliated with a particular source entity 20, the communication device 10, as described earlier, may intercept (e.g., seize or capture) and hold, at least temporarily, communiqué reception information 51* that indicates the reception of the communiqué 52* upon receiving the communiqué reception information 51* in order to prevent any indications of the reception of the communiqué 52 from being presented.

As indicated previously, in order to obfuscate reception of a communiqué 52* that is affiliated with the particular source entity 20, the communication device 10 in accordance with the one or more conditional directives 50 of the end user 32 may present a covert indicator 54 that covertly indicates reception of the communiqué 52* in lieu of presenting any direct indication of reception of the communiqué 52*. The covert indicator 54 that may be presented may covertly indicate the reception of the communiqué 52* by indirectly indicating the reception of the communiqué 52*. That is, the covert indicator 54 that may be presented may not, at least directly, indicate any aspect of the received communiqué 52* that would alert, for example, a third party to the existence of the communiqué 52*, the reception of the communiqué 52*, the source entity 20 affiliated with the communiqué 52*, and/or the relationship between the source entity 20 and the communiqué 52*.

In various embodiments, the one or more conditional directives 50 of the end user 32 may define the covert indicator 54 that may be presented in order to covertly indicate reception of the communiqué 52* affiliated with the particular source entity 20. In some instances, as a result of being based, at least in part, on the one or more conditional directives 50 of (e.g., provided by) the end user 32, only the end user 32, as well as those entities that the end user 32 may have confided in, may recognize the meaning of the covert indicator 54 when the covert indicator 54 is presented through, for example, a user interface 120 (e.g., display system 121, audio system 122, and/or vibrating system 123).

In various embodiments, the covert indicator 54 that may be presented by the communication device 10 may come in a variety of different forms including as a covert visual indicator, as a covert audio indicator, and/or as a covert vibration indicator (note that in some cases a covert indicator 54 may be comprised of two or more types of covert indicators 54 including, for example, a covert visual indicator, a covert audio indicator, and/or a covert vibration indicator). In embodiments where the covert indicator 54 that is presented includes at least an audio element in the form of a covert audio indicator, which may be presented through an audio system 122, the covert audio indicator may be at least one of a ping, a ring, or a hum. Alternatively, or in the same embodiments, the covert indicator 54 that may be presented may include a covert audio indicator that includes one or more simulated natural background noises (e.g., sound of a train or car passing, sounds of birds in the background, and so forth).

In some embodiments, the covert indicator 54 that may be presented by the communication device 10 may comprise a covert audio indicator that includes at least one voice message. Such a voice message may be a fictional voice message or a non-fictional voice message (which may or may not be modified to covertly indicate reception of the communiqué 52) that may have been previously received and/or presented. Further, such a voice message, in some cases, may be or may appear to be a (fictional or non-fictional) communication audio message from a third party such as a telephone or video message from a third party, an (fictional or non-fictional) audio message related to operational aspects of the communication device 10 such as a message related to the operating system of the communication device 10, or a (fictional or non-fictional) communiqué application related audio message, (e.g., a message that appears to be related to, for example, a VoIP application). In order to covertly indicate reception of the communiqué 52* affiliated with the particular source entity 20, the voice message that may be presented may include, in some cases, particular words and/or phrases, and/or the voice used in the voice message may have one or more particular characteristics such as tone, feminine/masculine characteristics, and/or speech pattern (e.g., accent) as defined by the one or more conditional directives 50.

In embodiments where the covert indicator 54 that is presented includes at least a visual element in the form of a covert visual indicator, which may be visually presented through a display system 121, the covert visual indicator may be one or more particular symbols or icons. Alternatively, or additionally, the covert visual indicator that may be presented may merely be the visual presentation of one or more particular colors (e.g., particular background colors or particular colors used for particular words or items). In some cases, the covert visual indicator that may be presented may be in the form of a visual message such as a textual message. As in the case of covert audio indicator that takes the form of a voice message described above, the covert visual indicator in the form of a visual message may be a fictional visual message or a non-fictional message (e.g., a previously received visual message that may or may not have been modified to covertly or indirectly indicate reception of the communiqué 52*).

Also, as before, such a visual message for covertly indicating reception of the communiqué 52* may be or may at least appear to be a (fictional or non-fictional) communication visual message from a third party such as an email or a text message, a (fictional or non-fictional) visual message related to operational aspects of the communication device 10 such as a visual message related to the operating system of the communication device 10, or a (fictional or non-fictional) communiqué application related visual message (e.g., a message that appears to be related to, for example, an email application). In some cases, in order to covertly indicate the reception of the communiqué 52* affiliated with the source entity 20, the visual message that may be presented may include one or more particular words and/or phrases in one or more particular fonts or styles as defined by the one or more conditional directives 50.

In embodiments where the covert indicator 54 that is presented includes at least a vibration element in the form of a covert vibrating indicator, which may be presented through a vibrating system 123 (which many of today's mobile phones have). As will be further described herein, the covert vibrating indicator that may be presented may have particular characteristics (e.g., vibration pattern and/or intensity) in order to covertly indicate reception of the communiqué 52*. As described earlier, the covert indicator 54 that is presented may include one, two, or all three types of covert indicators 54 (e.g., one or more covert audio indicators, one or more covert visual indicators, and one or more covert vibrating indicators).

In accordance with various embodiments, the covert indicator 54 that covertly indicates the reception of the communiqué 52* affiliated with the particular source entity 20 may be presented by presenting, via a display system 121, a graphical user interface (GUI), that includes the covert indicator 54 (e.g., in the form of one or more symbols, one or more icons, one or more colors, one or more words, and/or one or more phrases). In some cases, the GUI that is presented may be a previously presented GUI that has been modified to include the covert indicator 54. In some instances, the GUI that is presented may be an interface for an operating system application (e.g., Windows 7, Windows Vista, Vista Smartphone Interface, Symbian OS, Android, and so forth). Note that for purposes of the following description, references to a “GUI” may be in reference to a GUI for a personal computer (PC), a telephone user interface (TUI) for a telephone device such as a Smartphone or a cellular telephone, or interface for other types of computing/communication devices.

In alternative embodiments, however, the covert indicator 54 that covertly indicates the reception of the communiqué 52* affiliated with the particular source entity 20 may be presented by presenting, via a display system 121 and/or via an audio system 122, a communiqué application interface (e.g., an email application interface, a VoIP application interface, an IM application interface, and so forth) that includes the covert indicator 54. In some embodiments, the communiqué application interface that may be presented may be a modified version of a previously presented communiqué application interface that has been modified to include the covert indicator 54. For these embodiments, the covert indicator 54 that may be presented through the communiqué application interface may be a covert visual indicator, a covert audio indicator, and/or a covert vibrating indicator to covertly indicate the reception of the communiqué 52.

In accordance with some embodiments, and as will be further described herein, after receiving or intercepting the communiqué reception information 51* that indicates the reception of the communiqué 52* affiliated with the particular source entity 20, and after presenting a covert indicator 54 that covertly indicates the reception of the communiqué 52* in lieu of presenting a direct indication of reception of the communiqué 52*, the communication device 10 may subsequently present (e.g., via the user interface 120) the communiqué reception information 51* in response to detecting occurrence of one or more triggering events associated with the communication device 10. Various types of triggering events may cause the communication device 10 to present the communiqué reception information 51*. One example of a triggering event that may cause the communication device 10 to present the communiqué reception information 51* is when there is verification (e.g., a password or biometric verification) that the end user 32 has possession of the communication device 10. For example, after being covertly notified of the reception of the communiqué 52*, the end user 32 may input a password (or a biometric verification) to verify that the end user 32 has possession or control of the communication device 10. After providing the appropriate password (or biometric verification), the end user 32 may be allowed to access the communiqué reception information 51*, which may have been previously saved into a memory 140. Other trigger events that could result in the communiqué reception information 51* being presented include, for example, a determination that the communication device 10 is or is not at one or more specified locations as specified by the one or more conditional directives 50 or a determination that the communication device 10 has reached one or more particular times of a day or calendar year as specified by the one or more conditional directives 50 as will be further described herein.

Turning particularly now to the communication device 10 of FIGS. 1a and 1b. The communication device 10, as illustrated, may include a variety of modules, sub-modules, and various other components. In some embodiments, the communication device 10 may be a network component device designed to communicate with one or more other network devices. The communication device 10 may be any one of a variety of computing/communication devices that include at least a processor (e.g., microprocessor, controller, and so forth) and that can transmit/receive communiqué s including, for example, a cellular telephone, a personal digital assistant (PDA), a Smartphone, a tablet computer, a laptop computer, a desktop computer, a workstation, and so forth.

As illustrated, the communication device 10 may include one or more processors 101 (e.g., one or more microprocessors and/or controllers), a memory 140 (which may be a storage medium) including computer readable instructions 40, a transceiver 112 (e.g., for transmitting and receiving electronic communiqué signals), a network interface 113 (e.g., a network interface card or “NIC”), a user interface 120 (which may further include a display system 121, an audio system 122, and/or a vibrating system 123), and one or more sensors 150. In various implementations, the one or more processors 101 when executing the computer readable instructions 40 may include certain logic blocks for executing the novel operations and processes to be described herein. For example, the one or more processors 101, when executing the computer readable instructions 40 of the memory 140, may include logic blocks including a communiqué reception information receiving module 102 and a covert indicator presenting module 104. In some embodiments, the one or more processors 101, when further executing the computer readable instructions 40 of the memory 140, may further include additional logic blocks such as a conditional directive receiving module 106 and/or a communiqué reception information presenting module 110.

As will be further described herein, the communiqué reception information receiving module 102 may be configured to at least receive communiqué reception information 51* that indicates reception of a communiqué 52* that is affiliated with a source entity 20 and that is directed to an end user 32, while the covert indicator presenting module 104 may be configured to present, in response to receiving the communiqué reception information 51* and in lieu of presenting direct indication of reception of the communiqué 52*, a covert indicator 54 that covertly indicates reception of the communiqué 52*, the presenting of the covert indicator 54 being in accordance with one or more conditional directives 50 of the end user 32 to conditionally obfuscate the reception of the communiqué 52 affiliated with the source entity 20. With respect to the other logic blocks that may be included in the one or more processors 101 when executing the computer readable instructions 40 of the memory 140, the conditional directive receiving module 106 may be configured to receive the one or more conditional directives 50 via, for example, the user interface 120 and the communiqué reception information presenting module 110 may be designed to present the received communiqué reception information 51* in response to detecting occurrence of one or more triggering events associated with the communication device 10.

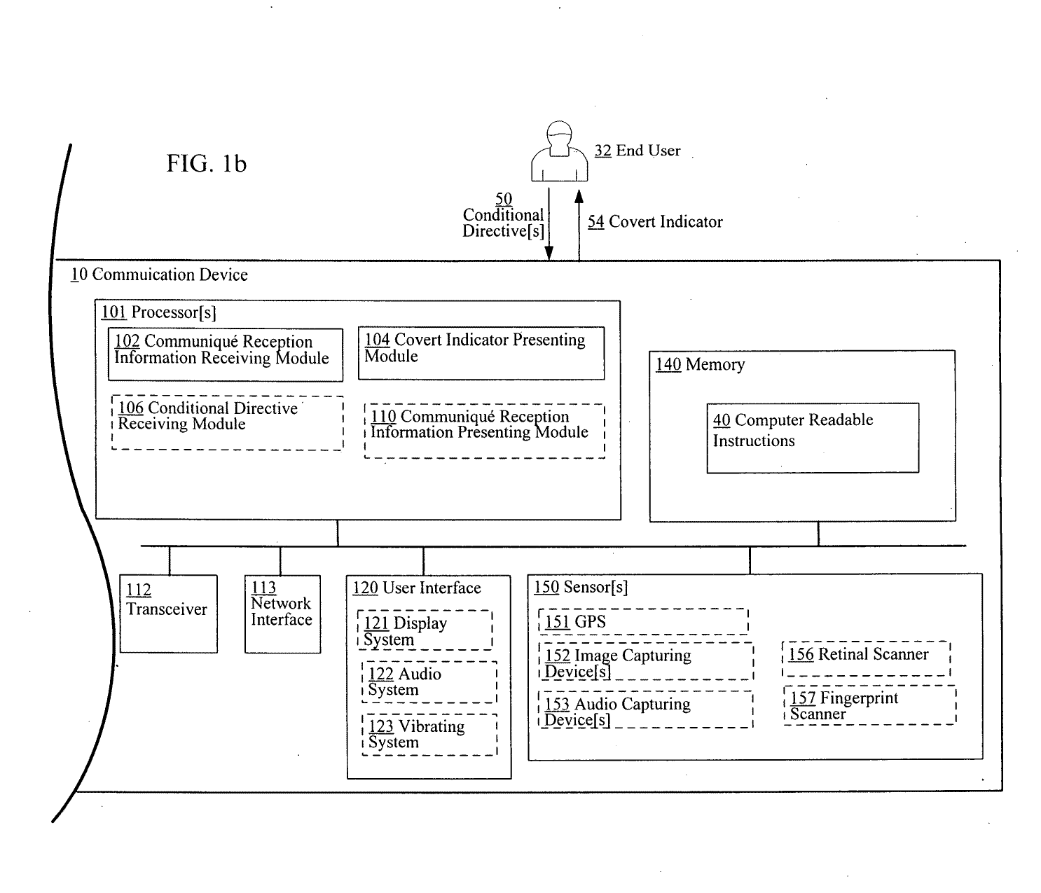

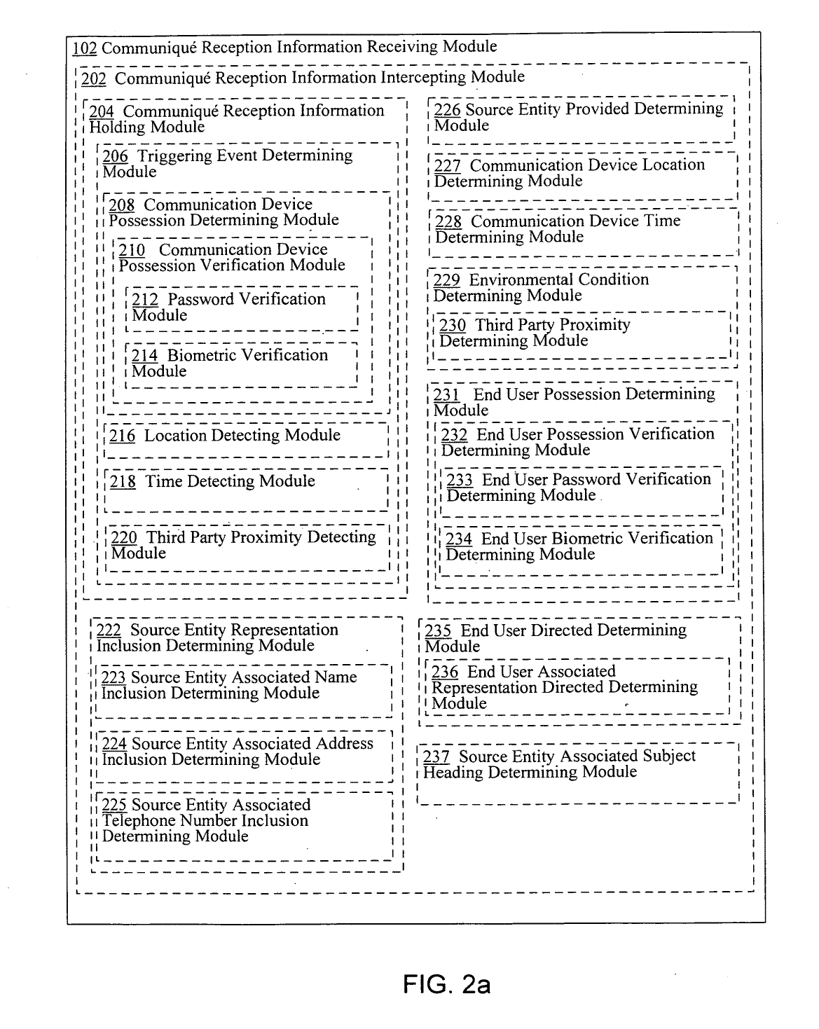

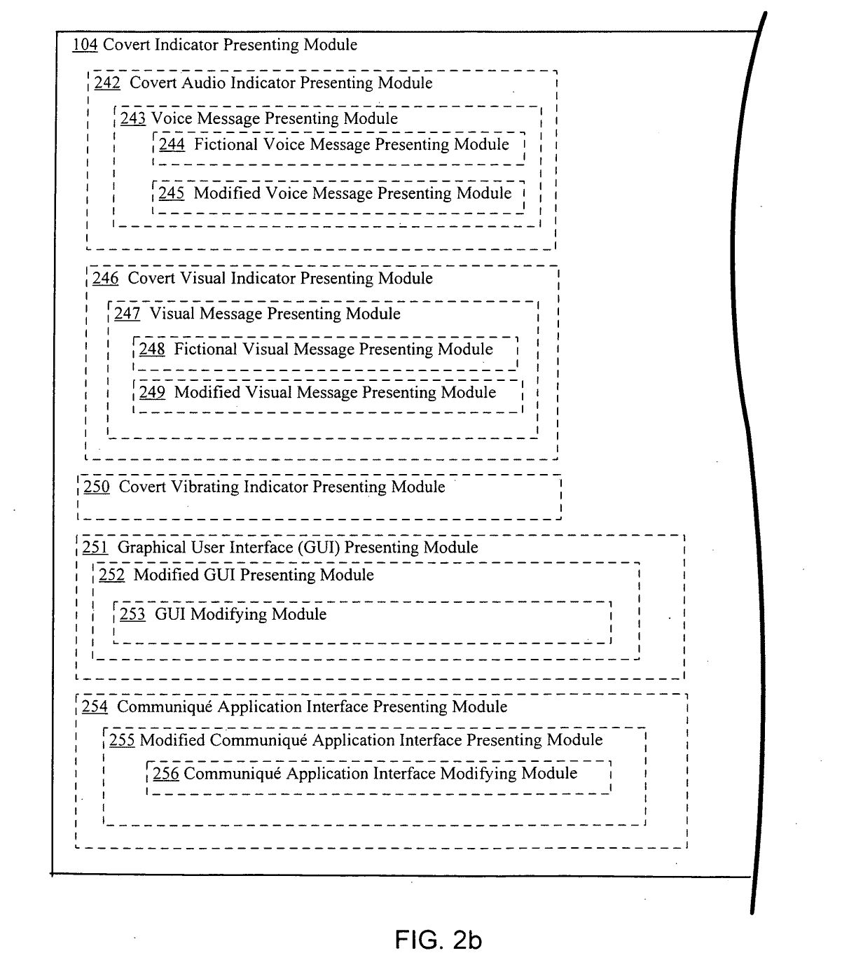

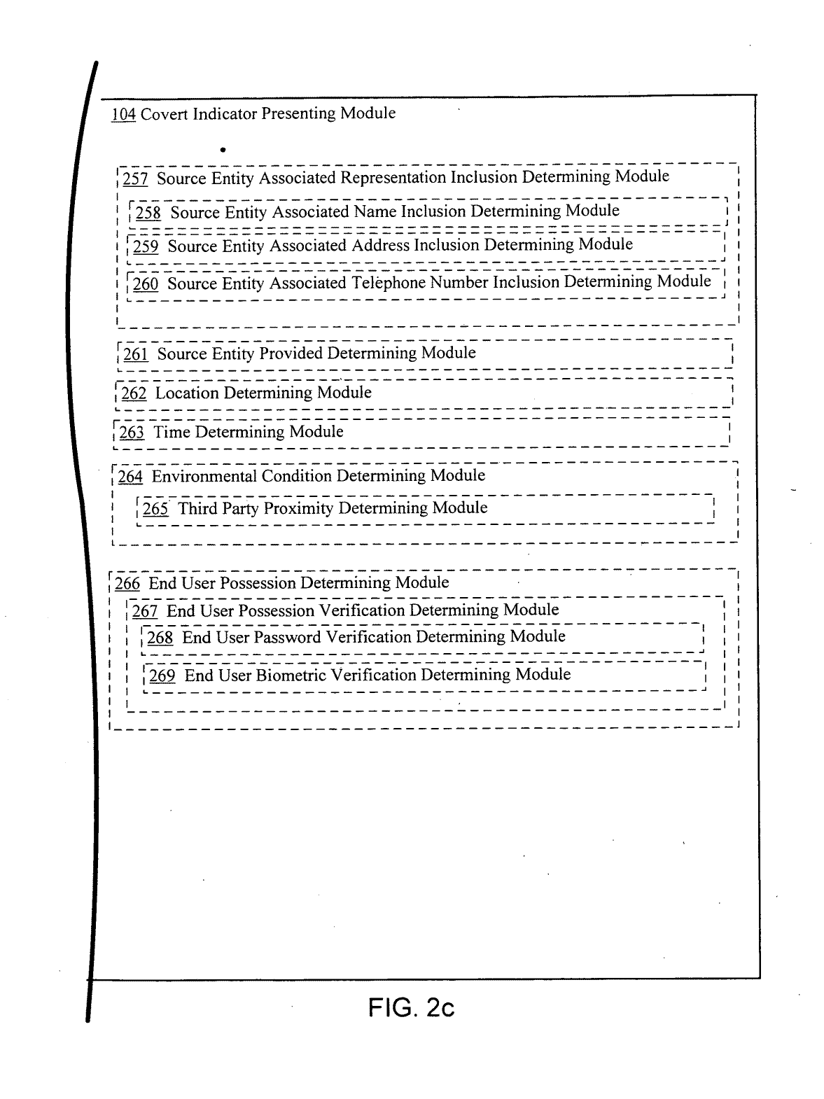

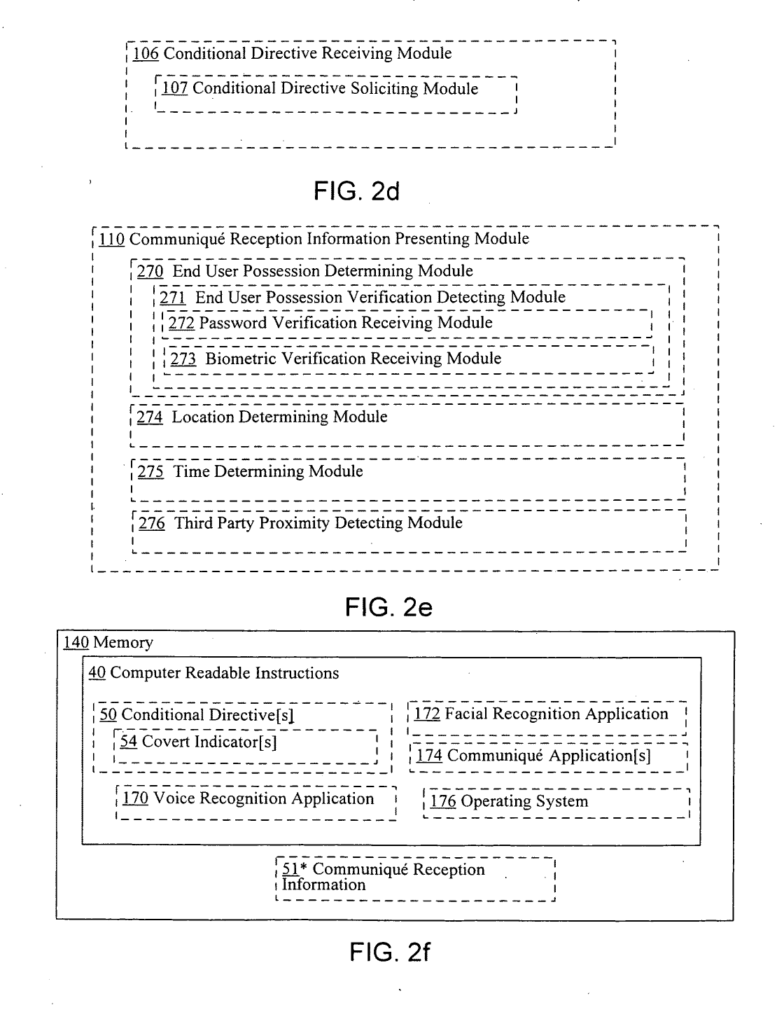

Note that the communication device 10 illustrated in FIGS. 1a and 1b is the “software” implementation of the communication device 10. That is, although the communiqué receiving module 102, the covert indicator presenting module 104, the conditional directive receiving module 106, and the communiqué reception information presenting module 110 illustrated in FIGS. 1a and 1b are depicted as being logic blocks implemented by the one or more processors 101 executing the computer readable instructions 40 (e.g., software) of memory 140, in alternative implementations, the communiqué receiving module 102, the covert indicator presenting module 104, the conditional directive receiving module 106, and the communiqué reception information presenting module 110 (and all their sub-modules as illustrated in FIGS. 2a, 2b, 2c, 2d, and 2e) may be alternatively implemented using hardware (e.g. circuitry such as application specific integrated circuit or ASIC), firmware, or any combination of hardware, firmware, and/or software.

As briefly described above, in various embodiments, the communication device 10 may include one or more sensors 150. For example, in some embodiments, the communication device 10 may include a global positioning system (GPS) 151, one or more image capturing devices 152 (e.g., digital camera or a webcam) that may also be part of the display system 121, one or more audio capturing devices 153 (e.g. one or more microphones) which may be part of the audio system 122, a retinal scanner 156, and/or a fingerprint scanner 157. These sensors 150 may be employed in order to facilitate in the implementation of various processes and operations to be described herein.

In various embodiments, the memory 140 that may be included in the communication device 10 may be designed for storing various types of data including, for example, the computer readable instructions 40. For these embodiments, memory 140 may comprise of one or more of mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

As illustrated in FIG. 2f, memory 140 may store, as part of the computer readable instructions 40 in some cases, one or more conditional directives 50 that may further include one or more covert indicators 54 (which the end user 32 may have selected or designated), a voice recognition application 170, a facial recognition application 172, one or more communiqué applications 174 (e.g., email application, text messaging application, IM application, VoIP application, and so forth), and/or an operating system (OS) 176. In some embodiments, memory 140 may further include communiqué reception information 51* that indicates reception of a communiqué 52* directed to an end user 32 and affiliated with a particular source entity 20. The voice recognition application 170 and the facial recognition application 172 may be employed in order to facilitate various aspects of the operations and processes to be described herein. In some cases, for example, the voice recognition application 170 and the facial recognition application 172 may be employed in order to determine whether the end user 32 has possession of the communication device 10 or whether a third party is within proximate vicinity (e.g., close enough such that the third party may hear/see/sense communiqué s 52 received through the communication device 10) of the communication device 10.

Referring now to FIG. 2a illustrating a particular implementation of the communiqué reception information receiving module 102 of the communication device 10 of FIGS. 1a and 1b. As illustrated, the communiqué reception information receiving module 102 may include one or more sub-modules including, for example, a communiqué reception information intercepting module 202 that may further include a communiqué reception information holding module 204, a source entity representation inclusion determining module 222 (which may further include a source entity associated name inclusion determining module 223, a source entity associated address inclusion determining module 224, and/or a source entity associated telephone number inclusion determining module 225), a source entity provided determining module 226, a communication device location determining module 227, a communication device time determining module 228, an environmental condition determining module 229 (which may further include a third party proximity determining module 230), an end user possession determining module 231 (which may include an end user possession-verification determining module 232 that may further include an end user password verification determining module 233 and/or an end user biometric verification determining module 234), an end user directed determining module 235 (which may include an end user associated representation directed determining module 236), and/or a source entity associated subject heading determining module 237. In embodiments where the communiqué reception information intercepting module 202 includes the communiqué reception information holding module 204, the communiqué reception information holding module 204 may include a triggering event determining module 206 that may further include a communication device possession determining module 208 (which may further include a communication device possession verification module 210 that may have a password verification module 212 and/or a biometric verification module 214), a location detecting module 216, a time detecting module 218, and/or a third party proximity detecting module 220.

Note that although the communiqué reception information receiving module 102 illustrated in FIGS. 1a and 1b was described as being embodied by software in the form of computer readable instructions 40 that is executed by one or more processors 101, in alternative embodiments each of the sub-modules of the communiqué reception information receiving module 102, as well as the communiqué receiving module 102 itself, may be implemented using hardware or firmware, or implemented using any combination of hardware, software (e.g., computer readable instructions 40 executed by one or more processors 101), and/or firmware. Specific details related to the communiqué reception information receiving module 102 as well as the above-described sub-modules of the communiqué reception information receiving module 102 will be provided below in reference to the operations and processes to be described herein.

Referring now to FIGS. 2b and 2c illustrating a particular implementation of the covert indicator presenting module 104 of the communication device 10 of FIGS. 1a and 1b. As illustrated in FIGS. 2b and 2c, the covert indicator presenting module 104 may include one or more sub-modules in various alternative implementations. For example, and as illustrated in FIG. 2b, the covert indicator presenting module 104 may include, in various implementations, a covert audio indicator presenting module 242 that may include a voice message presenting module 243 (which may further comprise a fictional voice message presenting module 244 and/or a modified voice message presenting module 245), a covert visual indicator presenting module 246 that may include a visual message presenting module 247 (which may further comprise a fictional visual message presenting module 248 and/or a modified visual message presenting module 249), a covert vibrating indicator presenting module 250, a graphical user interface (GUI) presenting module 251 that may include a modified graphical user interface (GUI) presenting module 252 (which may further comprise a GUI modifying module 253), and/or a communiqué application interface presenting module 254 that may include a modified communiqué application interface presenting module 255 (which may further comprise a communiqué application interface modifying module 256).

As further illustrated in FIG. 2c, the covert indicator presenting module 104 may also include a source entity associated representation inclusion determining module 257 (which may further comprise of a source entity associated name inclusion determining module 258, a source entity associated address inclusion determining module 259, a source entity associated telephone number inclusion determining module 260), a source entity provided determining module 261, a location determining module 262, a time determining module 263, an environmental condition determining module 264 (that may include a third party proximity determining module 265), and/or an end user possession determining module 266 that may include an end user possession verification determining module 267 (which may further comprise an end user password verification determining module 268 and/or an end user biometric verification determining module 269).

Note again that although the covert indicator presenting module 104 illustrated in FIGS. 1a and 1b was described as being embodied by software in the form of computer readable instructions 40 that is executed by one or more processors 101, in alternative embodiments each of the sub-modules of the covert indicator presenting module 104, as well as the covert indicator presenting module 104 itself, may be implemented using hardware or firmware, or implemented using any combination of hardware, software (e.g., computer readable instructions 40 executed by one or more processors 101), and/or firmware. Specific details related to the covert indicator presenting module 104, as well as the above-described sub-modules of the covert indicator presenting module 104, will be provided below in reference to the operations and processes to be described herein.

Turning now to FIG. 2d illustrating a particular implementation of the conditional directive receiving module 106 of the communication device 10 of FIGS. 1a and 1b. As will be described below, the conditional directive receiving module 106 may be designed to receive one or more conditional directives 50 via, for example, the user interface 120. In some embodiments, the conditional directive receiving module 106 may further include a conditional directive soliciting module 107 that is designed to solicit one or more conditional directives 50 from, for example, an end user 32 via the user interface 120.

Referring now to FIG. 2e illustrating a particular implementation of the communiqué reception information presenting module 110 of the communication device 10 of FIGS. 1a and 1b. As will be further described herein, in various implementations, the communiqué reception information presenting module 110 may be designed to present communiqué reception information 51* that was previously received in response to one or more triggering events associated with the communication device 10. In some instances, the communiqué reception information 51* may be presented via the user interface 120. In various embodiments, the communiqué reception information presenting module 110 may further include an end user possession determining module 270 that may further include an end user possession verification detecting module 271 (which may further comprise a password verification receiving module 272 and/or a biometric verification receiving module 273), a location determining module 274, a time determining module 275, and/or a third party proximity detecting module 276.

Note again that although the conditional directive receiving module 106 and the communiqué reception information presenting module 110 illustrated in FIGS. 1a and 1b and in FIGS. 2d and 2e were briefly described earlier as being embodied by software in the form of computer readable instructions 40 that is executed by one or more processors 101, in alternative embodiments each of the sub-modules of the conditional directive receiving module 106 and the communiqué reception information presenting module 110 described above, as well as the conditional directive receiving module 106 and the communiqué reception information presenting module 110, may be implemented using hardware or firmware, or implemented using any combination of hardware, software (e.g., computer readable instructions 40 executed by one or more processors 101), and/or firmware.

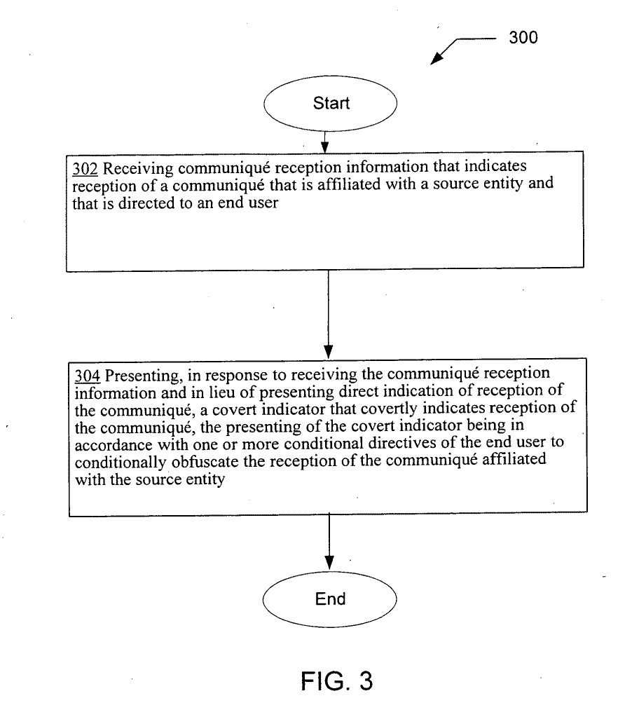

A more detailed discussion related to the communication device 10 of FIGS. 1a and 1b will now be provided with respect to the processes and operations to be described herein. FIG. 3 illustrates an operational flow 300 representing example operations for, among other things, obfuscating reception of a communiqué 52 that is directed to an end user 32 and affiliated with a particular source entity in response to receiving information that indicates the reception of the communiqué 52, the obfuscation being in accordance with one or more conditional directives 50 of the end user 32. In FIG. 3 and in the following figures that include various examples of operational flows, discussions and explanations will be provided with respect to the exemplary environment 100 described above and as illustrated in FIGS. 1a and 1b, and/or with respect to other examples (e.g., as provided in FIGS. 2a, 2b, 2c, 2d, 2e, and 2f) and contexts. However, it should be understood that the operational flows may be executed in a number of other environments and contexts, and/or in modified versions of FIGS. 1a, 1b, 2a, 2b, 2c, 2d, 2e, and 2f. Also, although the various operational flows are presented in the sequence(s) illustrated, it should be understood that the various operations may be performed in other orders other than those which are illustrated, or may be performed concurrently.

Further, in FIG. 3 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 3 as well as the other operations to be described herein may be performed by at least one of a machine, an article of manufacture, or a composition of matter.

In any event, after a start operation, the operational flow 300 of FIG. 3 may move to a communiqué reception information receiving operation 302 for receiving communiqué reception information that indicates reception of a communiqué that is affiliated with a source entity and that is directed to an end user. For instance, and as an illustration, the communiqué reception information receiving module 102 of the communication device 10 of FIGS. 1a and 1b receiving communiqué reception information 51* that indicates reception of a communiqué 52* that is affiliated with (e.g., being sent by) a source entity 20 and that is directed to (e.g., sent to or addressed to) an end user 32.

As described earlier, references to “communiqué 52*” may be in reference to communiqué 52′ that may be received and held by a server 36 or in reference to a “missed” communiqué 52″ that is unsuccessfully received or accepted by the communication device 10 (e.g., a missed telephone call or a message that was not successfully received by the communication device 10 because the communication device 10 was turned off or was in a sleep mode, or the end user 32 was unavailable to pick-up or accept the communiqué 52″) as illustrated in FIGS. 1a and 1b. Similarly, references to communiqué reception information 51* may be in reference to communiqué reception information 51′ that may be provided to the communication device 10 via a server 36 or in reference to communiqué reception information 51″ that may be provided to the communication device 10 in connection with a missed communiqué 52″ (e.g., a missed telephone call) that is unsuccessfully received by the communication device 10.

As also described earlier, the source entity 20 may comprise of a human or robotic source user 22 and/or a source device 24. In some cases, the source entity 20 may be an organization such as a business or a social or interest group. In some cases, the source entity 20 may be a website. Similarly, the end user 32 may be a human or a robotic end user 32 in various alternative implementations. Also described earlier, the communication device 10 of FIGS. 1a and 1b may be a variety of computing devices (e.g., devices having at least a processor 101) capable of receiving/transmitting communiqué s. Examples of a communication device 10 include, for example, a cellular telephone, a personal digital assistant (PDA), a Smartphone, a landline telephone, a laptop or desktop computer, a computer tablet, a workstation, and so forth.

In addition to the communiqué reception information receiving operation 302, operational flow 300 may also include a covert indicator presenting operation 304 for presenting, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity as further illustrated in FIG. 3. For instance, the covert indicator presenting module 104 of the communication device 10 of FIGS. 1a and 1b presenting (e.g., visually and/or audioally indicating), in response to receiving the communiqué reception information 51* and in lieu of presenting direct indication of reception of the communiqué 52*, a covert indicator 54 that covertly indicates (e.g., without alerting one or more third parties) reception of the communiqué 52*(e.g., reception of the communiqué 52′ at a server 36 or the unsuccessful reception of the communiqué 52″ at the communication device 10), the presenting of the covert indicator 54 in lieu of presenting direct indication of reception of the communiqué 52* being in accordance with one or more conditional directives 50 of the end user 32 to conditionally obfuscate (e.g., hide or disguise) the reception of the communiqué 52* affiliated with the source entity 20.

In various embodiments, the covert indicator 54 that may be presented may covertly indicate the reception of the communiqué 52* to only certain parties (e.g., end user 32 and to any others that the end user 32 may have confided in regarding the meaning of the covert indicator 54) without alerting others by providing a covert indicator 54 that may be selected by the end user 32 via one or more conditional directives 50 that may be provided by the end user 32. In some embodiments, the covert indicator 54 may not at least directly describe any aspect of the reception of the communiqué 52* including, for example, the identity of the source entity 20 affiliated with the communiqué 52*, the subject heading of the communiqué 52* if there is one, the reception of the communiqué 52* itself, and so forth.

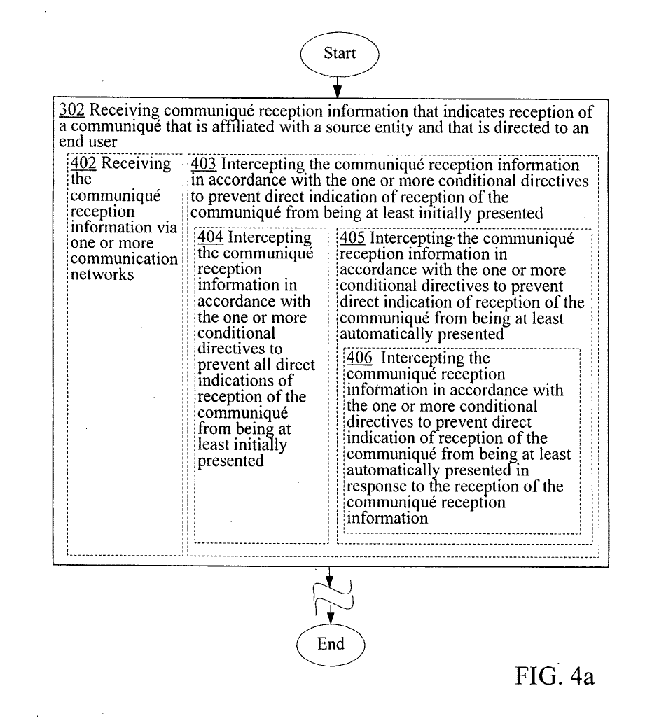

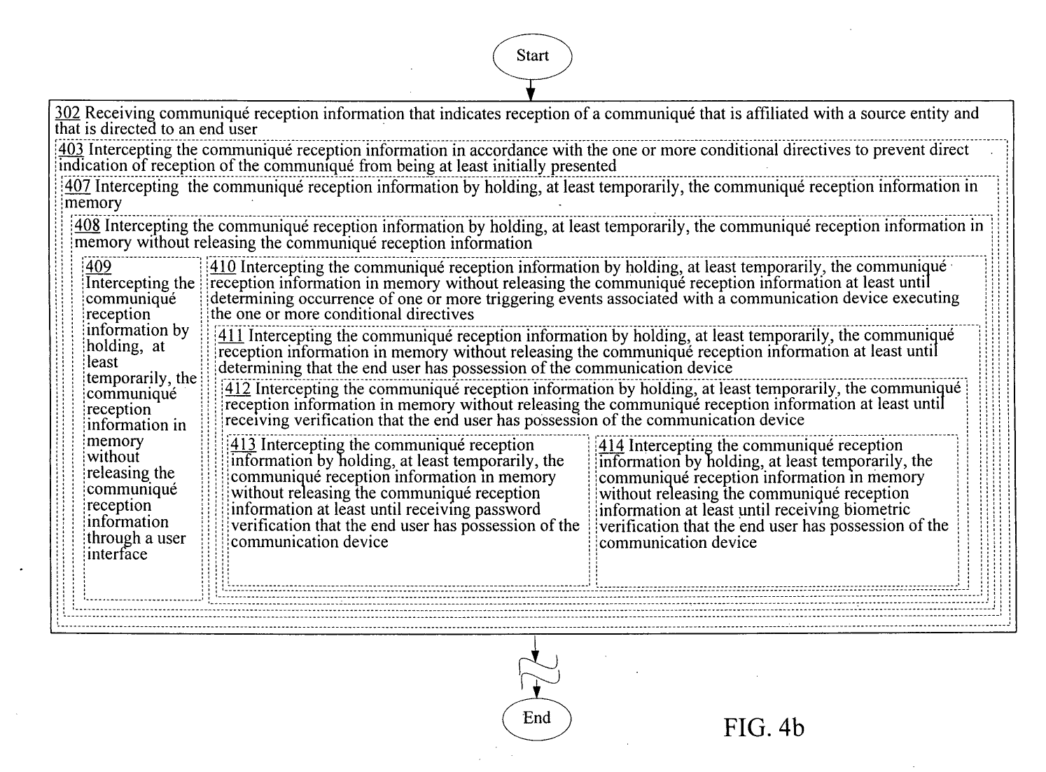

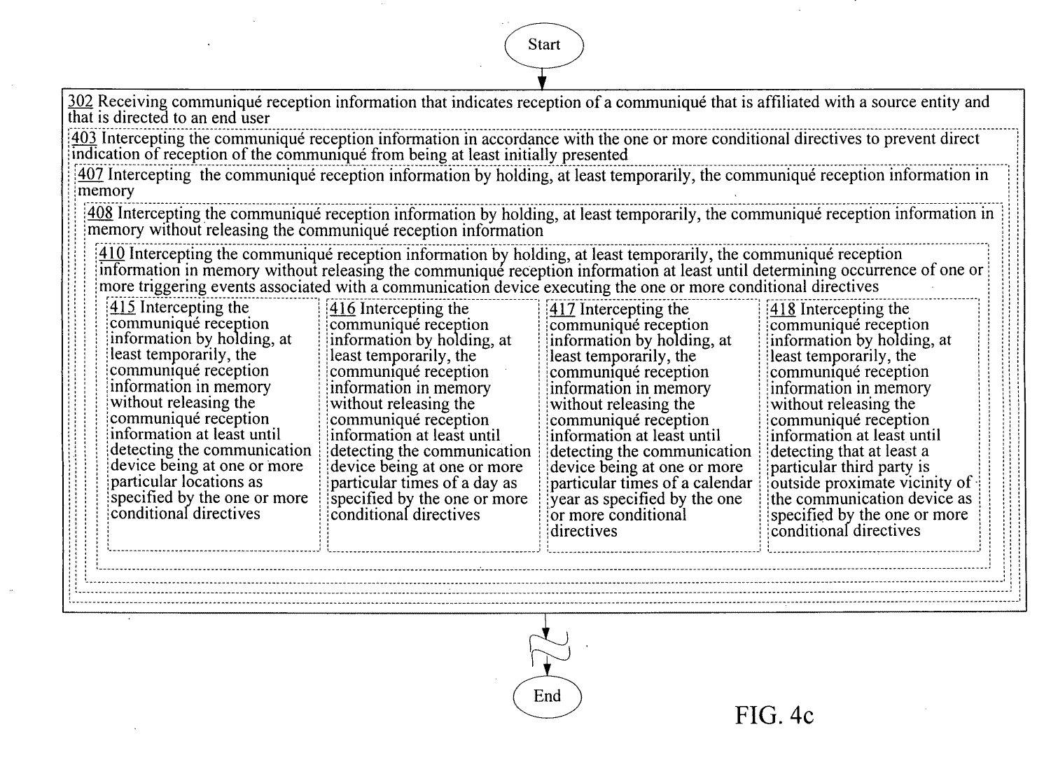

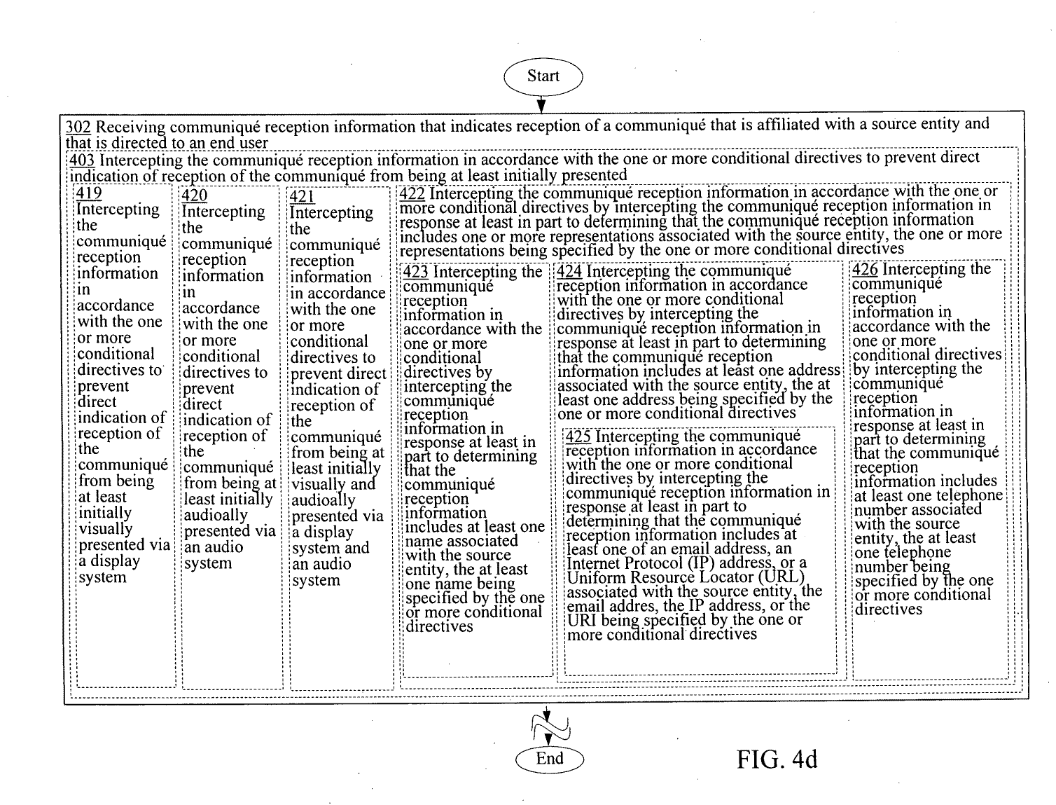

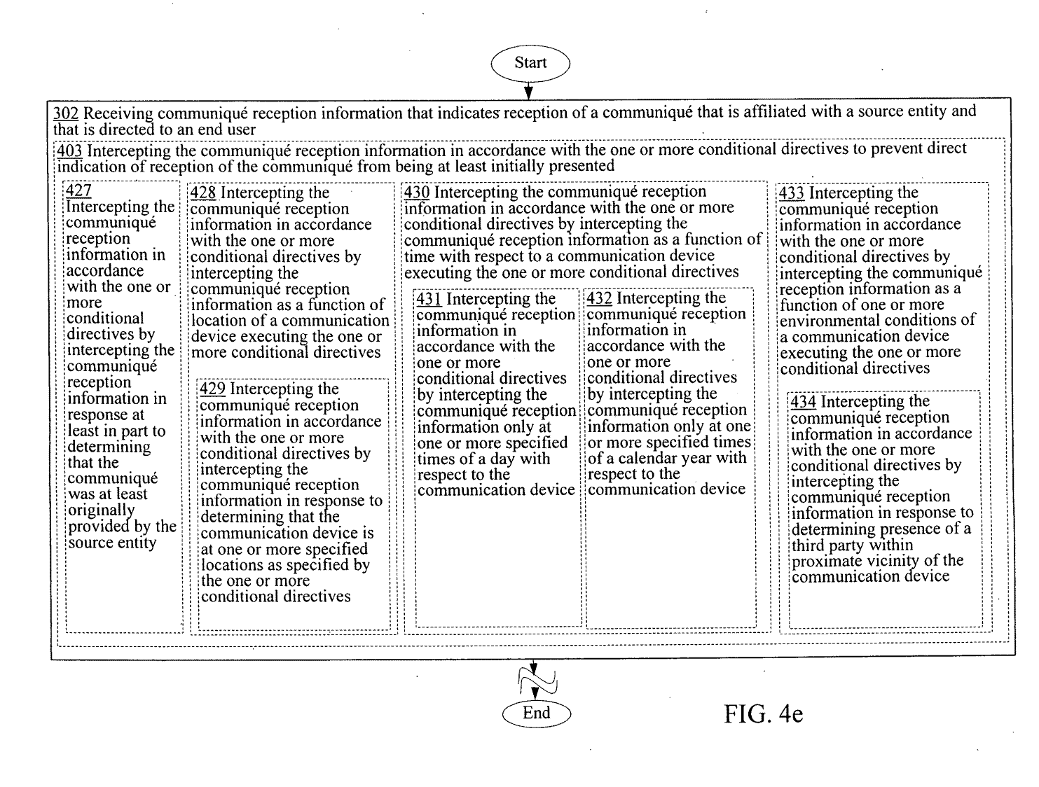

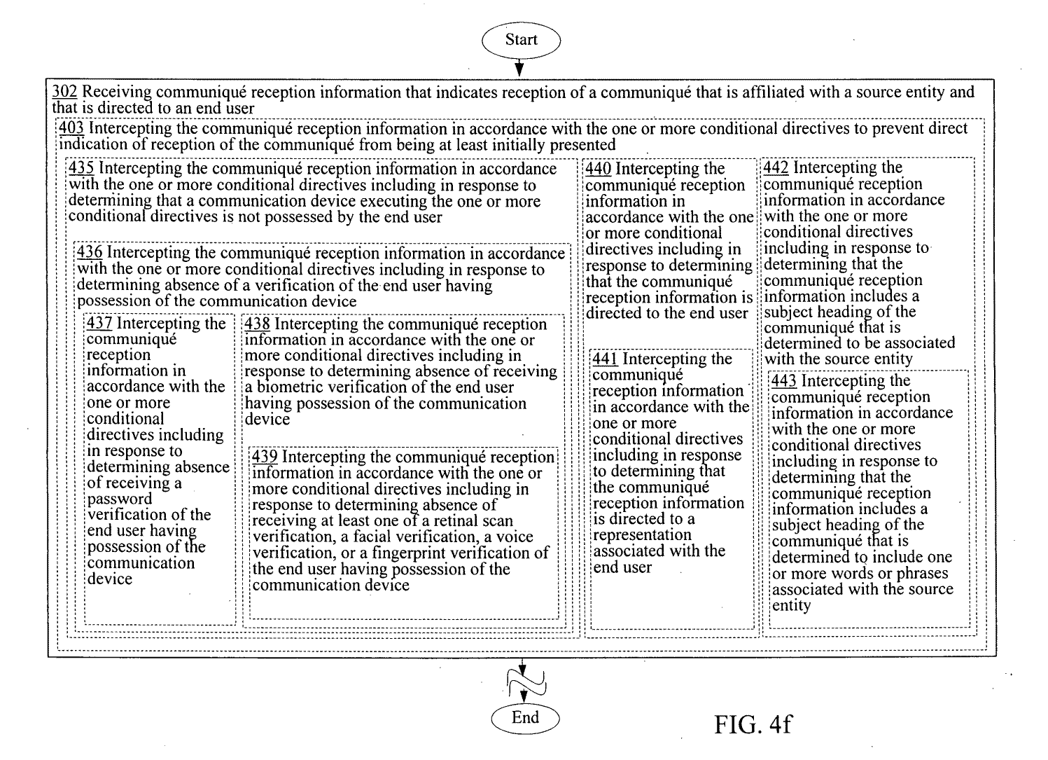

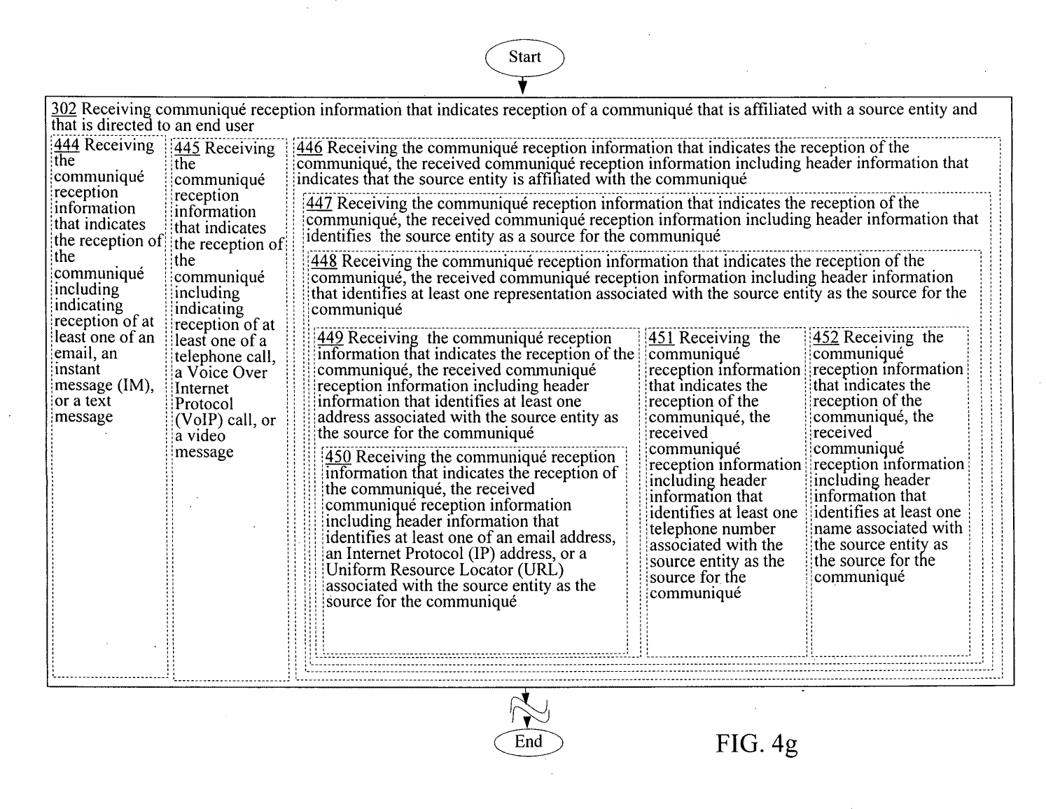

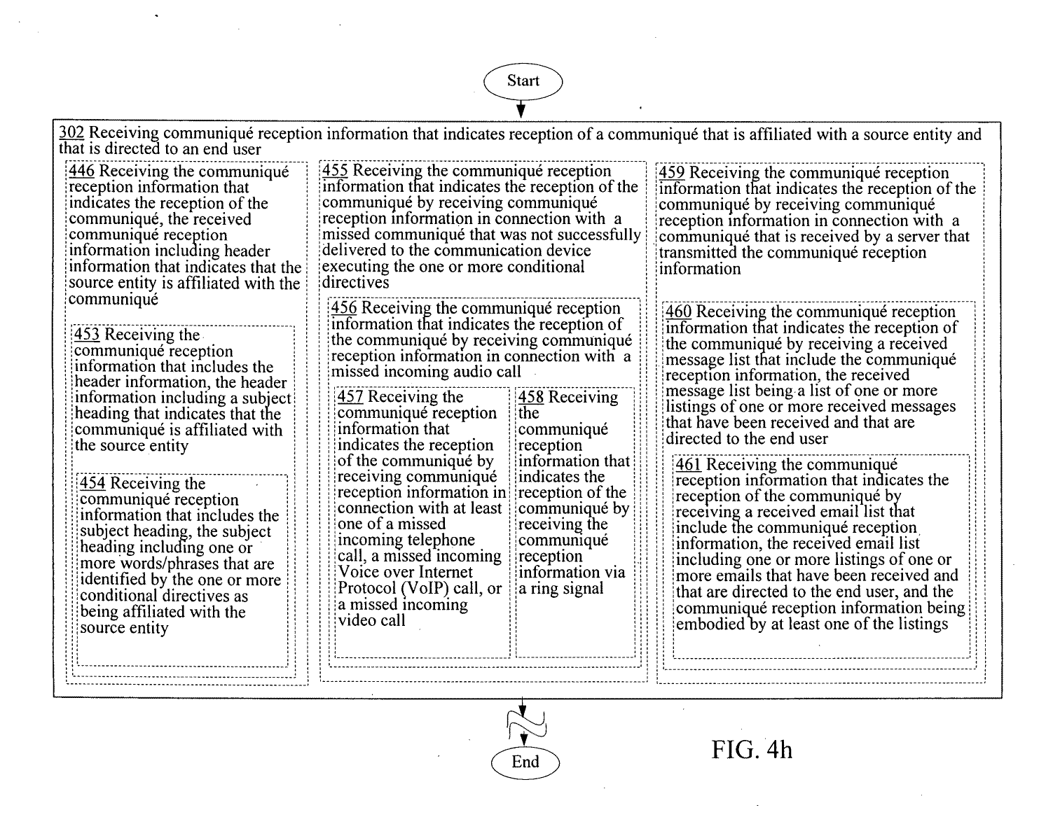

As will be further described herein, the communiqué reception information receiving operation 302 and the covert indicator presenting operation 304 of FIG. 3 may be executed in a number of different ways in various alternative implementations. For example, FIGS. 4a, 4b, 4c, 4d, 4e, 4f, 4g, and 4h illustrate some of the various ways that the communiqué reception information receiving operation 302 of FIG. 3 may be executed in various alternative implementations. In some implementations, for example, the communiqué reception information receiving operation 302 of FIG. 3 may include an operation 402 for receiving the communiqué reception information via one or more communication networks as depicted in FIG. 4a. For instance, the communiqué reception information receiving module 102 of the communication device 10 of FIGS. 1a and 1b receiving the communiqué reception information 51* via one or more communication networks 40 (e.g., WLAN, LAN, WMAN, cellular network, PSTN, and so forth).

As will be further described herein, the communiqué reception information receiving operation 302 of FIG. 3 may actually involve the interception or capture of the communiqué reception information 51. For example, and as will be further illustrated in FIGS. 4a, 4b, 4c, 4d, 4e, and 4f, the communiqué reception information receiving operation 302 of FIG. 3 may include an operation 403 for intercepting the communiqué reception information in accordance with the one or more conditional directives to prevent direct indication of reception of the communiqué from being at least initially presented as further depicted in FIG. 4a. For instance, the communiqué reception information intercepting module 202 (see FIG. 2a) of the communication device 10 of FIGS. 1a and 1b intercepting (e.g., seizing or capturing) the communiqué reception information 51* in accordance with the one or more conditional directives 50 to prevent direct indication (e.g., a ring, a visual and/or audio message identifying the communiqué 52* and/or the source entity 20 affiliated with the communiqué 52*) of reception of the communiqué 52* from being at least initially presented (e.g., prevent direct indications from being presented via a display system 121 such as a LCD and/or via an audio system 122 such as one or more speakers). As will be further described herein, the communiqué 52* may be subsequently presented in some instances when one or more triggering events have occurred.

The operation 403 for intercepting the communiqué reception information 51* may be executed in a number of different ways in various alternative implementations. For example, in various implementations, operation 403 may include an operation 404 for intercepting the communiqué reception information in accordance with the one or more conditional directives to prevent all direct indications of reception of the communiqué from being at least initially presented as further depicted in FIG. 4a. For instance, the communiqué reception information intercepting module 202 of the communication device 10 of FIGS. 1a and 1b intercepting (e.g., seizing or capturing) the communiqué reception information 51* in accordance with the one or more conditional directives 50 to prevent all direct indications (e.g., indications that identify one or more aspects of the reception of the communiqué 52* including, for example, a subject heading for the communiqué 52* if there is one, a telephone number associated with a source entity 20 affiliated with the communiqué 52*, an address such as an email address associated with the source entity 20, reception time, and so forth) of reception of the communiqué 52* from being at least initially presented (e.g., displayed and/or audioally indicated).

In various implementations, operation 403 for intercepting the communiqué reception information may include an operation 405 for intercepting the communiqué reception information in accordance with the one or more conditional directives to prevent direct indication of reception of the communiqué from being at least automatically presented as further depicted in FIG. 4a. For instance, the communiqué reception information intercepting module 202 of the communication device 10 of FIGS. 1a and 1b intercepting the communiqué reception information 51* in accordance with the one or more conditional directives 50 to prevent direct indication (e.g., to prevent explicit showing of one or more aspects) of reception of the communiqué 52* from being at least automatically presented.

In some implementations, operation 405 may further include an operation 406 for intercepting the communiqué reception information in accordance with the one or more conditional directives to prevent direct indication of reception of the communiqué from being at least automatically presented in response to the reception of the communiqué reception information as depicted in FIG. 4a. For instance, the communiqué reception information intercepting module 202 of the communication device 10 of FIGS. 1a and 1b intercepting the communiqué reception information 51* in accordance with the one or more conditional directives 50 to prevent direct indication of reception of the communiqué 52* from being at least automatically presented in response to the reception of the communiqué reception information 51. For example, if the communiqué 52* that is received (e.g., received at a server 36) is an email, then intercepting the communiqué reception information 51*(as provided by the server 36) to prevent direct indication of reception of the communiqué 52*(e.g., direct indication in the form of a listing on a list of received emails) from being presented through, for example, the communication device 10.

In various embodiments, the operation 403 for intercepting the communiqué reception information 51* may involve “holding” the communiqué reception information 51* in order to suppress or at least delay the presentation of the communiqué reception information 51*. For example, in some implementations, operation 403 may include an operation 407 for intercepting the communiqué reception information by holding, at least temporarily, the communiqué reception information in memory as depicted in FIG. 4b. For instance, the communiqué reception information intercepting module 202 including the communiqué reception information holding module 204 (see FIG. 2a) of the communication device 10 of FIGS. 1a and 1b intercepting the communiqué reception information 51* by having the communiqué reception information holding module 204 hold (e.g., seize), at least temporarily, the communiqué reception information 51* in memory 140 (e.g., volatile or non-volatile memory, cache memory, flash memory, or other types of memory).

In some implementations, operation 407 may further include an operation 408 for intercepting the communiqué reception information by holding, at least temporarily, the communiqué reception information in memory without releasing the communiqué reception information as further depicted in FIG. 4b. For instance, the communiqué reception information intercepting module 202 including the communiqué reception information holding module 204 of the communication device 10 of FIGS. 1a and 1b intercepting the communiqué reception information 51* by having the communiqué reception information holding module 204 hold, at least temporarily, the communiqué reception information 51* in memory 140 without releasing (e.g., without displaying or indicating) the communiqué reception information 51.

In some cases, operation 408 may, in turn, include an operation 409 for intercepting the communiqué reception information by holding, at least temporarily, the communiqué reception information in memory without releasing the communiqué reception information through a user interface as further depicted in FIG. 4b. For instance, the communiqué reception information intercepting module 202 including the communiqué reception information holding module 204 of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* through a user interface 120 (e.g., a display monitor such as a touchscreen or a LCD and/or one or more speakers).

In the same or different implementations, operation 408 may also include an operation 410 for intercepting the communiqué reception information by holding, at least temporarily, the communiqué reception information in memory without releasing the communiqué reception information at least until determining occurrence of one or more triggering events associated with a communication device executing the one or more conditional directives as further depicted in FIG. 4b. For instance, the communiqué reception information intercepting module 202 including the communiqué reception information holding module 204 and the triggering event determining module 206 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the triggering event determining module 206 determines occurrence of one or more triggering events associated with a communication device 10 executing the one or more conditional directives 50.

In some cases, operation 410 may further include an operation 411 for intercepting the communiqué reception information by holding, at least temporarily, the communiqué reception information in memory without releasing the communiqué reception information at least until determining that the end user has possession of the communication device as further depicted in FIG. 4b. For instance, the communiqué reception information intercepting module 202 including the communiqué reception information holding module 204 and the communication device possession determining module 208 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the communication device possession determining module 208 determines that the end user 32 has possession (e.g., control) of the communication device 10.

In some implementations, operation 411 may further include an operation 412 for intercepting the communiqué reception information by holding, at least temporarily, the communiqué reception information in memory without releasing the communiqué reception information at least until receiving verification that the end user has possession of the communication device as further depicted in FIG. 4b. For instance, the communiqué reception information intercepting module 202 including the communiqué reception information holding module 204 and the communication device possession verification module 210 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the communication device possession verification module 210 has received verification that the end user 32 has possession of the communication device 10.

Various types of verification may be received in various alternative implementations in order to determine that the end user 32 has possession of the communication device 10. For example, in some cases, operation 412 may include an operation 413 for intercepting the communiqué reception information by holding, at least temporarily, the communiqué reception information in memory without releasing the communiqué reception information at least until receiving password verification that the end user has possession of the communication device as further depicted in FIG. 4b. For instance, the communiqué reception information intercepting module 202 including the communiqué reception information holding module 204 and the password verification module 212 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the password verification module 212 receives password verification (e.g., a password verification entered through a user interface 120 including, for example, through a microphone, through a keypad, through a keyboard, through a touchscreen, and so forth) that the end user 32 has possession of the communication device 10.

In the same or different implementations, operation 412 may include an operation 414 for intercepting the communiqué reception information by holding, at least temporarily, the communiqué reception information in memory without releasing the communiqué reception information at least until receiving biometric verification that the end user has possession of the communication device as further depicted in FIG. 4b. For instance, the communiqué reception information intercepting module 202 including the communiqué reception information holding module 204 and the biometric verification module 214 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the biometric verification module 214 receives biometric verification (e.g., data provided by one or more sensors 150 including a retinal scanner 156, a fingerprint scanner 157, an image capturing device 152, an audio capturing device 153, and so forth) that the end user 32 has possession of the communication device 10.

In various implementations, the operation 410 for intercepting the communiqué reception information by holding, at least temporarily, the communiqué reception information in memory without releasing the communiqué reception information at least until determining occurrence of one or more triggering events associated with a communication device executing the one or more conditional directives may include an operation 415 for intercepting the communiqué reception information by holding, at least temporarily, the communiqué reception information in memory without releasing the communiqué reception information at least until detecting the communication device being at one or more particular locations as specified by the one or more conditional directives as depicted in FIG. 4c. For instance, the communiqué reception information intercepting module 202 including the communiqué reception information holding module 204 and the location detecting module 216 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the location detecting module 216 detects the communication device 10 being at one or more particular locations as specified by the one or more conditional directives 50.

In the same or different implementations, operation 410 may also include an operation 416 for intercepting the communiqué reception information by holding, at least temporarily, the communiqué reception information in memory without releasing the communiqué reception information at least until detecting the communication device being at one or more particular times of a day as specified by the one or more conditional directives as further depicted in FIG. 4c. For instance, the communiqué reception information intercepting module 202 including the communiqué reception information holding module 204 and the time detecting module 218 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the time detecting module 218 detects the communication device 10 being at one or more particular times of a day as specified by the one or more conditional directives 50.

In the same or different implementations, operation 410 may also include an operation 417 for intercepting the communiqué reception information by holding, at least temporarily, the communiqué reception information in memory without releasing the communiqué reception information at least until detecting the communication device being at one or more particular times of a calendar year as specified by the one or more conditional directives as further depicted in FIG. 4c. For instance, the communiqué reception information intercepting module 202 including the communiqué reception information holding module 204 and the time detecting module 218 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the time detecting module 218 detects the communication device 10 being at one or more particular times of a calendar year as specified by the one or more conditional directives 50.

In the same or different implementations, operation 410 may also include an operation 418 for intercepting the communiqué reception information by holding, at least temporarily, the communiqué reception information in memory without releasing the communiqué reception information at least until detecting that at least a particular third party is outside proximate vicinity of the communication device as specified by the one or more conditional directives as further depicted in FIG. 4c. For instance, the communiqué reception information intercepting module 202 including the communiqué reception information holding module 204 and the third party proximity detecting module 220 (see FIG. 2a) of the communication device 10 of FIGS. 1a and 1b intercepting the communiqué reception information 51* by having the communiqué reception information holding module 204 hold, at least temporarily, the communiqué reception information 51* in memory 140 without releasing the communiqué reception information 51* at least until the third party proximity detecting module 220 detects that at least a particular third party is outside proximate vicinity (e.g., outside of three feet, five feet, ten feet, or any other predefined distances from which a third party may not overhear and/or see a communiqué 52* being presented through the communication device 10) of the communication device 10 as specified by the one or more conditional directives 50.

The determination as to whether a particular third party is within or outside the proximate vicinity (e.g., maximum distance from the communication device 10 from which the third party can see/hear/sense a communiqué 52*) of the communication device 10 may be based on data provided from a number of sources. For example, in some implementations, data inputted through a personal management application such as Microsoft Outlook that may indicate the itinerary of the end user 32 (such as when the end user 32 will meet with the particular third party) may be used in order to infer that the particular third party will not be in the proximate vicinity of the communication device 10 at a given moment in time. Alternatively, data inputted through social networking channels such as Microblogs (i.e., “tweets”) may also be used in order to determine whether the particular third party is in the proximate vicinity of the communication device 10 (assuming that the communication device 10 is in the possession of the end user 32). In other implementations, data provided by an image capturing device 152 (e.g., digital camera) and/or an audio capturing device 15e (e.g., microphone) may be processed using a facial recognition application or a voice signature recognition application to determine whether the particular third party is within or outside the proximate vicinity of the communication device 10. In still other implementations, other types of sensors 150 (e.g., GPS 151) may be employed in order to determine whether the particular third party is within or outside the proximate vicinity of the communication device 10.

In some cases, operation 403 for intercepting the communiqué reception information in accordance with the one or more conditional directives to prevent direct indication of reception of the communiqué from being at least initially presented may include an operation 419 for intercepting the communiqué reception information in accordance with the one or more conditional directives to prevent direct indication of reception of the communiqué from being at least initially visually presented via a display system as depicted in FIG. 4d. For instance, the communiqué reception information intercepting module 202 of the communication device 10 of FIGS. 1a and 1b intercepting the communiqué reception information 51* in accordance with the one or more conditional directives 50 to prevent direct indication of reception of the communiqué 52* from being at least initially (e.g., automatically) visually presented via a display system 121 (e.g., display monitor, touchscreen, LCD, and so forth).

In the same or different implementations, operation 403 may include an operation 420 for intercepting the communiqué reception information in accordance with the one or more conditional directives to prevent direct indication of reception of the communiqué from being at least initially audioally presented via an audio system as further depicted in FIG. 4d. For instance, the communiqué reception information intercepting module 202 of the communication device 10 of FIGS. 1a and 1b intercepting the communiqué reception information 51* in accordance with the one or more conditional directives 50 to prevent direct indication of reception of the communiqué 52* from being at least initially audioally presented via an audio system 122 (e.g., one or more speakers).

In the same or different implementations, operation 403 may include an operation 421 for intercepting the communiqué reception information in accordance with the one or more conditional directives to prevent direct indication of reception of the communiqué from being at least initially visually and audioally presented via a display system and an audio system as further depicted in FIG. 4d. For instance, the communiqué reception information intercepting module 202 of the communication device 10 of FIGS. 1a and 1b intercepting the communiqué reception information 51* in accordance with the one or more conditional directives 50 to prevent direct indication of reception of the communiqué 52* from being at least initially visually and audioally presented via a display system 121 and an audio system 122.

In the same or different implementations, operation 403 may include an operation 422 for intercepting the communiqué reception information in accordance with the one or more conditional directives by intercepting the communiqué reception information in response at least in part to determining that the communiqué reception information includes one or more representations associated with the source entity, the one or more representations being specified by the one or more conditional directives as further depicted in FIG. 4d. For instance, the communiqué reception information intercepting module 202 including the source entity representation inclusion determining module 222 (see FIG. 2a) of the communication device 10 of FIGS. 1a and 1b intercepting the communiqué reception information 51* in accordance with the one or more conditional directives 50 by intercepting the communiqué reception information 51* in response at least in part to, for example, the source entity representation inclusion determining module 222 determining that the communiqué reception information 51* includes one or more representations (e.g., identifiers such as a name, address, and so forth) associated with the source entity 20, the one or more representations being specified by the one or more conditional directives 50.

As further illustrated in FIG. 4d, operation 422 may further include one or more additional operations in various alternative implementations. For example, in some implementations, operation 422 may include an operation 423 for intercepting the communiqué reception information in accordance with the one or more conditional directives by intercepting the communiqué reception information in response at least in part to determining that the communiqué reception information includes at least one name associated with the source entity, the at least one name being specified by the one or more conditional directives as further depicted in FIG. 4d. For instance, the communiqué reception information intercepting module 202 including the source entity associated name inclusion determining module 223 (see FIG. 2a) of the communication device 10 of FIGS. 1a and 1b intercepting the communiqué reception information 51* in accordance with the one or more conditional directives 50 by intercepting the communiqué reception information 51* in response at least in part to, for example, the source entity associated name inclusion determining module 223 determining that the communiqué reception information 51* includes at least one name (e.g., username) associated with the source entity 20, the at least one name being specified by the one or more conditional directives 50.

In the same or different implementations, operation 422 may include an operation 424 for intercepting the communiqué reception information in accordance with the one or more conditional directives by intercepting the communiqué reception information in response at least in part to determining that the communiqué reception information includes at least one address associated with the source entity, the at least one address being specified by the one or more conditional directives as further depicted in FIG. 4d. For instance, the communiqué reception information intercepting module 202 including the source entity associated address inclusion determining module 224 (see FIG. 2a) of the communication device 10 of FIGS. 1a and 1b intercepting the communiqué reception information 51* in accordance with the one or more conditional directives 50 by intercepting the communiqué reception information 51* in response at least in part to, for example, the source entity associated address inclusion determining module 224 determining that the communiqué reception information 51* includes at least one address associated with the source entity 20, the at least one address being specified by the one or more conditional directives 50.

In some cases, operation 424 may, in turn, include an operation 425 for intercepting the communiqué reception information in accordance with the one or more conditional directives by intercepting the communiqué reception information in response at least in part to determining that the communiqué reception information includes at least one of an email, address, an Internet Protocol (IP) address, or a Uniform Resource Locator (URL) associated with the source entity, the email address, the IP address, or the URL being specified by the one or more conditional directives as further depicted in FIG. 4d. For instance, the communiqué reception information intercepting module 202 including the source entity associated address inclusion determining module 224 of the communication device 10 of FIGS. 1a and 1b intercepting the communiqué reception information 51* in accordance with the one or more conditional directives 50 by intercepting the communiqué reception information 51* in response at least in part to, for example, the source entity associated address inclusion determining module 224 determining that the communiqué reception information 51* includes at least one of an email address, an Internet Protocol (IP) address, or a Uniform Resource Locator (URL) associated with the source entity 20, the email address, the IP address, or the URI being specified by the one or more conditional directives 50.

In the same or different implementations, operation 422 may also include an operation 426 for intercepting the communiqué reception information in accordance with the one or more conditional directives by intercepting the communiqué reception information in response at least in part to determining that the communiqué reception information includes at least one telephone number associated with the source entity, the at least one telephone number being specified by the one or more conditional directives as further depicted in FIG. 4d. For instance, the communiqué reception information intercepting module 202 including the source entity associated telephone number inclusion determining module 225 (see FIG. 2a) of the communication device 10 of FIGS. 1a and 1b intercepting the communiqué reception information 51* in accordance with the one or more conditional directives 50 by intercepting the communiqué reception information 51* in response at least in part to, for example, the source entity associated telephone number inclusion determining module 225 determining that the communiqué reception information 51* includes at least one telephone number associated with the source entity 20, the at least one telephone number being specified by the one or more conditional directives 50.

Turning now to FIG. 4e, the operation 403 for intercepting the communiqué reception information in accordance with the one or more conditional directives to prevent direct indication of reception of the communiqué from being at least initially presented, in various implementations, may include an operation 427 for intercepting the communiqué reception information in accordance with the one or more conditional directives by intercepting the communiqué reception information in response at least in part to determining that the communiqué was at least originally provided by the source entity. For instance, the communiqué reception information intercepting module 202 including the source entity provided determining module 226 (see FIG. 2a) of the communication device 10 of FIGS. 1a and 1b intercepting the communiqué reception information 51* in accordance with the one or more conditional directives 50 by intercepting the communiqué reception information 51* in response at least in part to, for example, the source entity provided determining module 226 determining that the communiqué 52* was at least originally provided by the source entity 20.

In the same or different implementations, operation 403 may also include an operation 428 for intercepting the communiqué reception information in accordance with the one or more conditional directives by intercepting the communiqué reception information as a function of location of a communication device executing the one or more conditional directives as further depicted in FIG. 4e. For instance, the communiqué reception information intercepting module 202 including the communication device location determining module 227 (see FIG. 2a) of the communication device 10 of FIGS. 1a and 1b intercepting the communiqué reception information 51* in accordance with the one or more conditional directives 50 by intercepting the communiqué reception information 51* as a function of location (e.g., as determined by the communication device location determining module 227 using, for example, data provided by a GPS 151) of a communication device 10 executing the one or more conditional directives 50.

In some implementations, operation 428 may further include an operation 429 for intercepting the communiqué reception information in accordance with the one or more conditional directives by intercepting the communiqué reception information in response to determining that the communication device is at one or more specified locations as specified by the one or more conditional directives as further depicted in FIG. 4e. For instance, the communiqué reception information intercepting module 202 including the communication device location determining module 227 (see FIG. 2a) of the communication device 10 of FIGS. 1a and 1b intercepting the communiqué reception information 51* in accordance with the one or more conditional directives 50 by intercepting the communiqué reception information 51* in response to determining (e.g., as determined by the communication device location determining module 227 using, for example, data provided by a GPS 151) that the communication device 10 is at one or more specified locations as specified by the one or more conditional directives 50.

In the same or different implementations, operation 403 may include an operation 430 for intercepting the communiqué reception information in accordance with the one or more conditional directives by intercepting the communiqué reception information as a function of time with respect to a communication device executing the one or more conditional directives as further depicted in FIG. 4e. For instance, the communiqué reception information intercepting module 202 including the communication device time determining module 228 (see FIG. 2a) of the communication device 10 of FIGS. 1a and 1b intercepting the communiqué reception information 51* in accordance with the one or more conditional directives 50 by intercepting the communiqué reception information 51* as a function of time (e.g., as determined by the communication device time determining module 228) with respect to a communication device 10 executing the one or more conditional directives 50.

In some implementations, operation 430 may further include an operation 431 for intercepting the communiqué reception information in accordance with the one or more conditional directives by intercepting the communiqué reception information only at one or more specified times of a day with respect to the communication device as further depicted in FIG. 4e. For instance, the communiqué reception information intercepting module 202 including the communication device time determining module 228 of the communication device 10 of FIGS. 1a and 1b intercepting the communiqué reception information 51* in accordance with the one or more conditional directives 50 by intercepting the communiqué reception information 51* only at one or more specified times of a day (e.g., as determined by the communication device time determining module 228) with respect to the communication device 10.

In the same or different implementations, operation 430 may also include an operation 432 for intercepting the communiqué reception information in accordance with the one or more conditional directives by intercepting the communiqué reception information only at one or more specified times of a calendar year with respect to the communication device as further depicted in FIG. 4e. For instance, the communiqué reception information intercepting module 202 including the communication device time determining module 228 of the communication device 10 of FIGS. 1a and 1b intercepting the communiqué reception information 51* in accordance with the one or more conditional directives 50 by intercepting the communiqué reception information 51* only at one or more specified times of a calendar year (e.g., as determined by the communication device time determining module 228) with respect to the communication device 10.

In some implementations, the operation 403 for intercepting the communiqué reception information in accordance with the one or more conditional directives to prevent direct indication of reception of the communiqué from being at least initially presented may include an operation 433 for intercepting the communiqué reception information in accordance with the one or more conditional directives by intercepting the communiqué reception information as a function of one or more environmental conditions of a communication device executing the one or more conditional directives as further depicted in FIG. 4e. For instance, the communiqué reception information intercepting module 202 including the environmental condition determining module 229 (see FIG. 2a) of the communication device 10 of FIGS. 1a and 1b intercepting the communiqué reception information 51* in accordance with the one or more conditional directives 50 by intercepting the communiqué reception information 51* as a function of one or more environmental conditions (e.g., as determined by the environmental condition determining module 229) of a communication device 10 executing the one or more conditional directives 50.

In some cases, operation 433 may, in turn, include an operation 434 for intercepting the communiqué reception information in accordance with the one or more conditional directives by intercepting the communiqué reception information in response to determining presence of a third party within proximate vicinity of the communication device as further depicted in FIG. 4e. For instance, the communiqué reception information intercepting module 202 including the third party proximity determining module 230 (see FIG. 2a) of the communication device 10 of FIGS. 1a and 1b intercepting the communiqué reception information 51* in accordance with the one or more conditional directives 50 by intercepting the communiqué reception information 51* in response to, for example, the third party proximity determining module 230 determining presence of a third party (e.g., as identified by the one or more conditional directives 50) within proximate vicinity (e.g., within three feet, five feet, ten feet, or within any other maximum predefined distances from which a third party may hear and/or see a communiqué 52* being presented through the communication device 10) of the communication device 10.

In various implementations, the operation 403 for intercepting the communiqué reception information in accordance with the one or more conditional directives to prevent direct indication of reception of the communiqué from being at least initially presented may include an operation 435 for intercepting the communiqué reception information in accordance with the one or more conditional directives including in response to determining that a communication device executing the one or more conditional directives is not possessed by the end user as depicted in FIG. 4f. For instance, the communiqué reception information intercepting module 202 including the end user possession determining module 231 (see FIG. 2a) of the communication device 10 of FIGS. 1a and 1b intercepting the communiqué reception information 51* in accordance with the one or more conditional directives 50 including in response to, for example, the end user possession determining module 231 (which may be designed to determine whether or not a particular end user 32 does or does not have possession of a communication device 10) determining that a communication device 10 executing the one or more conditional directives 50 is not possessed (e.g., not controlled) by the end user 32.

As further illustrated in FIG. 4f, operation 435 may include one or more additional operations in various alternative implementations. For example, in some implementations, operation 435 may include an operation 436 for intercepting the communiqué reception information in accordance with the one or more conditional directives including in response to determining absence of a verification of the end user having possession of the communication device as further depicted in FIG. 4f. For instance, the communiqué reception information intercepting module 202 including the end user possession verification determining module 232 (see FIG. 2a) of the communication device 10 of FIGS. 1a and 1b intercepting the communiqué reception information 51* in accordance with the one or more conditional directives 50 including in response to, for example, the end user possession verification determining module 232 (which may be designed to determine absence or presence of verification that a particular end user 32 has possession of the communication device 10) determining absence of a verification of the end user 32 having possession of the communication device 10.

In some cases, operation 436 may further include an operation 437 for intercepting the communiqué reception information in accordance with the one or more conditional directives including in response to determining absence of receiving a password verification of the end user having possession of the communication device as further depicted in FIG. 4f. For instance, the communiqué reception information intercepting module 202 including the end user password verification determining module 233 (see FIG. 2a) of the communication device 10 of FIGS. 1a and 1b intercepting the communiqué reception information 51* in accordance with the one or more conditional directives 50 including in response to, for example, the end user password verification determining module 233 (which may be designed to determine whether a password verification that verifies that the end user 32 has possession of communication device 10 has or has not been entered or inputted) determining absence of receiving a password verification of the end user 32 having possession of the communication device 10.

In the same or different implementations, operation 436 may include an operation 438 for intercepting the communiqué reception information in accordance with the one or more conditional directives including in response to determining absence of receiving a biometric verification of the end user having possession of the communication device as further depicted in FIG. 4f. For instance, the communiqué reception information intercepting module 202 including the end user biometric verification determining module 234 (see FIG. 2a) of the communication device 10 of FIGS. 1a and 1b intercepting the communiqué reception information 51* in accordance with the one or more conditional directives 50 including in response to, for example, the end user biometric verification determining module 234 (which may be designed to determine whether a biometric verification that verifies that the end user 32 is in possession of the communication device 10 has or has not been received) determining absence of receiving a biometric verification of the end user 32 having possession of the communication device 10.

In some implementations, operation 438 may further include an operation 439 for intercepting the communiqué reception information in accordance with the one or more conditional directives including in response to determining absence of receiving at least one of a retinal scan verification, a facial verification, a voice verification, or a fingerprint verification of the end user having possession of the communication device as further depicted in FIG. 4f. For instance, the communiqué reception information intercepting module 202 including the end user biometric verification determining module 234 (see FIG. 2a) of the communication device 10 of FIGS. 1a and 1b intercepting the communiqué reception information 51* in accordance with the one or more conditional directives 50 including in response to, for example, the end user biometric verification determining module 234 determining absence of receiving at least one of a retinal scan verification, a facial verification, a voice verification, or a fingerprint verification of the end user 32 having possession of the communication device 10.

Referring back to FIG. 4f, in various implementations, the operation 403 for intercepting the communiqué reception information in accordance with the one or more conditional directives to prevent direct indication of reception of the communiqué from being at least initially presented may include an operation 440 for intercepting the communiqué reception information in accordance with the one or more conditional directives including in response to determining that the communiqué reception information is directed to the end user. For instance, the communiqué reception information intercepting module 202 including the end user directed determining module 235 (see FIG. 2a) of the communication device 10 of FIGS. 1a and 1b intercepting the communiqué reception information 51* in accordance with the one or more conditional directives 50 including in response to, for example, the end user directed determining module 235 determining that the communiqué reception information 51* is directed to (e.g., being sent to or relayed to) the end user 32.

In some implementations, operation 440 may further include an operation 441 for intercepting the communiqué reception information in accordance with the one or more conditional directives including in response to determining that the communiqué reception information is directed to a representation associated with the end user as further depicted in FIG. 4f. For instance, the communiqué reception information intercepting module 202 including the end user associated representation directed determining module 236 (see FIG. 2a) of the communication device 10 of FIGS. 1a and 1b intercepting the communiqué reception information 51* in accordance with the one or more conditional directives 50 including in response to, for example, the end user associated representation directed determining module 236 determining that the communiqué reception information 51* is directed to a representation (e.g., a name, an address, a telephone number, and so forth) associated with the end user 32.

In some cases, the operation 403 for intercepting the communiqué reception information in accordance with the one or more conditional directives to prevent direct indication of reception of the communiqué from being at least initially presented may include an operation 442 for intercepting the communiqué reception information in accordance with the one or more conditional directives including in response to determining that the communiqué reception information includes a subject heading of the communiqué that is determined to be associated with the source entity as further depicted in FIG. 4f. For instance, the communiqué reception information intercepting module 202 including the source entity associated subject heading determining module 237 (see FIG. 2a) of the communication device 10 of FIGS. 1a and 1b intercepting the communiqué reception information 51* in accordance with the one or more conditional directives 50 including in response to, for example, the source entity associated subject heading determining module 237 determining that the communiqué reception information 51* includes a subject heading of the communiqué 52*(e.g., an email) that is determined to be associated with the source entity 20.

In some cases, operation 442 may further include an operation 443 for intercepting the communiqué reception information in accordance with the one or more conditional directives including in response to determining that the communiqué reception information includes a subject heading of the communiqué that is determined to include one or more words or phrases associated with the source entity as further depicted in FIG. 4f. For instance, the communiqué reception information intercepting module 202 including the source entity associated subject heading determining module 237 (see FIG. 2a) of the communication device 10 of FIGS. 1a and 1b intercepting the communiqué reception information 51* in accordance with the one or more conditional directives 50 including in response to, for example, the source entity associated subject heading determining module 237 determining that the communiqué reception information 51* includes a subject heading of the communiqué 52* that is determined to include one or more words or phrases (e.g., a motto or a favorite phrase) associated with the source entity 20.

Turning now to FIG. 4g, the communiqué reception information receiving operation 302 of FIG. 3 for receiving communiqué reception information that indicates reception of a communiqué that is affiliated with a source entity and that is directed to an end user may include, in various implementations, an operation 444 for receiving the communiqué reception information that indicates the reception of the communiqué including indicating reception of at least one of an email, an instant message (IM), or a text message. For instance, the communiqué reception information receiving module 102 of the communication device 10 of FIGS. 1a and 1b receiving the communiqué reception information 51* that indicates the reception of the communiqué 52* including indicating reception of at least one of an email, an instant message (IM), or a text message.

In some implementations, the communiqué reception information receiving operation 302 may include an operation 445 for receiving the communiqué reception information that indicates the reception of the communiqué including indicating reception of at least one of a telephone call, a Voice Over Internet Protocol (VoIP) call, or a video message as further depicted in FIG. 4g. For instance, the communiqué reception information receiving module 102 of the communication device 10 of FIGS. 1a and 1b receiving the communiqué reception information 51* that indicates the reception of the communiqué 52* including indicating reception of at least one of a telephone call, a Voice Over Internet Protocol (VoIP) call, or a video message.

In the same or different implementations, the communiqué reception information receiving operation 302 may include an operation 446 for receiving the communiqué reception information that indicates the reception of the communiqué, the received communiqué reception information including header information that indicates that the source entity is affiliated with the communiqué as further depicted in FIG. 4g. For instance, the communiqué reception information receiving module 102 of the communication device 10 of FIGS. 1a and 1b receiving the communiqué reception information 51* that indicates the reception of the communiqué 52*, the received communiqué reception information 51* including header information that indicates that the source entity 20 is affiliated with the communiqué 52*(e.g., header information that identifies the source entity 20 as the source for the communiqué 52*). In some implementations, header information may be supplemental data that may be placed at the beginning of a block of data, such as a data packet, that is being transmitted. For example, in the case of an email, the text (body) of the email may be preceded by header information in the form of header lines that may indicate the sender, recipient, subject, sending time stamp, receiving time stamps, and other aspects of the email. In the case of a telephone or a VoIP call, the header information may similarly indicate a telephone number or a name associated with the caller.

As further illustrated in FIG. 4g, operation 446 may further include one or more additional operations in various alternative implementations. For example, in some implementations, operation 446 may include an operation 447 for receiving the communiqué reception information that indicates the reception of the communiqué, the received communiqué reception information including header information that identifies the source entity as a source for the communiqué as depicted in FIG. 4g. For instance, the communiqué reception information receiving module 102 of the communication device 10 of FIGS. 1a and 1b receiving the communiqué reception information 51* that indicates the reception of the communiqué 52*, the received communiqué reception information 51* including header information that identifies the source entity 20 as a source (e.g., sender or caller) for the communiqué 52*.

In various implementations, operation 447 may, in turn, further include an operation 448 for receiving the communiqué reception information that indicates the reception of the communiqué, the received communiqué reception information including header information that identifies at least one representation associated with the source entity as the source for the communiqué as further depicted in FIG. 4g. For instance, the communiqué reception information receiving module 102 of the communication device 10 of FIGS. 1a and 1b receiving the communiqué reception information 51* that indicates the reception of the communiqué 52*, the received communiqué reception information 51* including header information that identifies at least one representation associated with the source entity 20 as the source for the communiqué 52*.

As further illustrated in FIG. 4g, operation 448 may include one or more additional operations in various alternative implementations. For example, in some implementations, operation 448 may include an operation 449 for receiving the communiqué reception information that indicates the reception of the communiqué, the received communiqué reception information including header information that identifies at least one address associated with the source entity as the source for the communiqué as depicted in FIG. 4g. For instance, the communiqué reception information receiving module 102 of the communication device 10 of FIGS. 1a and 1b receiving the communiqué reception information 51* that indicates the reception of the communiqué 52*, the received communiqué reception information 51* including header information that identifies at least one address (e.g., email address) associated with the source entity 20 as the source (e.g., sender) for the communiqué 52*(e.g., email).

In some cases, operation 449 may further include an operation 450 for receiving the communiqué reception information that indicates the reception of the communiqué, the received communiqué reception information including header information that identifies at least one of an email address, an Internet Protocol (IP) address, or a Uniform Resource Locator (URL) associated with the source entity as the source for the communiqué as depicted in FIG. 4g. For instance, the communiqué reception information receiving module 102 of the communication device 10 of FIGS. 1a and 1b receiving the communiqué reception information 51* that indicates the reception of the communiqué 52*, the received communiqué reception information 51* including header information that identifies at least one of an email address, an Internet Protocol (IP) address, or a Uniform Resource Locator (URL) associated with the source entity 20 as the source for the communiqué 52*.

In various implementations, operation 448 for receiving the communiqué reception information that indicates the reception of the communiqué, the received communiqué reception information including header information that identifies at least one representation associated with the source entity as the source for the communiqué may include an operation 451 for receiving the communiqué reception information that indicates the reception of the communiqué, the received communiqué reception information including header information that identifies at least one telephone number associated with the source entity as the source for the communiqué as further depicted in FIG. 4g. For instance, the communiqué reception information receiving module 102 of the communication device 10 of FIGS. 1a and 1b receiving the communiqué reception information 51* that indicates the reception of the communiqué 52*, the received communiqué reception information 51* including header information that identifies at least one telephone number associated with the source entity 20 as the source (e.g., caller) for the communiqué 52*(e.g., telephone-call).

In the same or different implementations, operation 448 may include an operation 452 for receiving the communiqué reception information that indicates the reception of the communiqué, the received communiqué reception information including header information that identifies at least one name associated with the source entity as the source for the communiqué as further depicted in FIG. 4g. For instance, the communiqué reception information receiving module 102 of the communication device 10 of FIGS. 1a and 1b receiving the communiqué reception information 51* that indicates the reception of the communiqué 52*, the received communiqué reception information 51* including header information that identifies at least one name (e.g., username) associated with the source entity 20 as the source for the communiqué 52* (e.g., Instant Message).

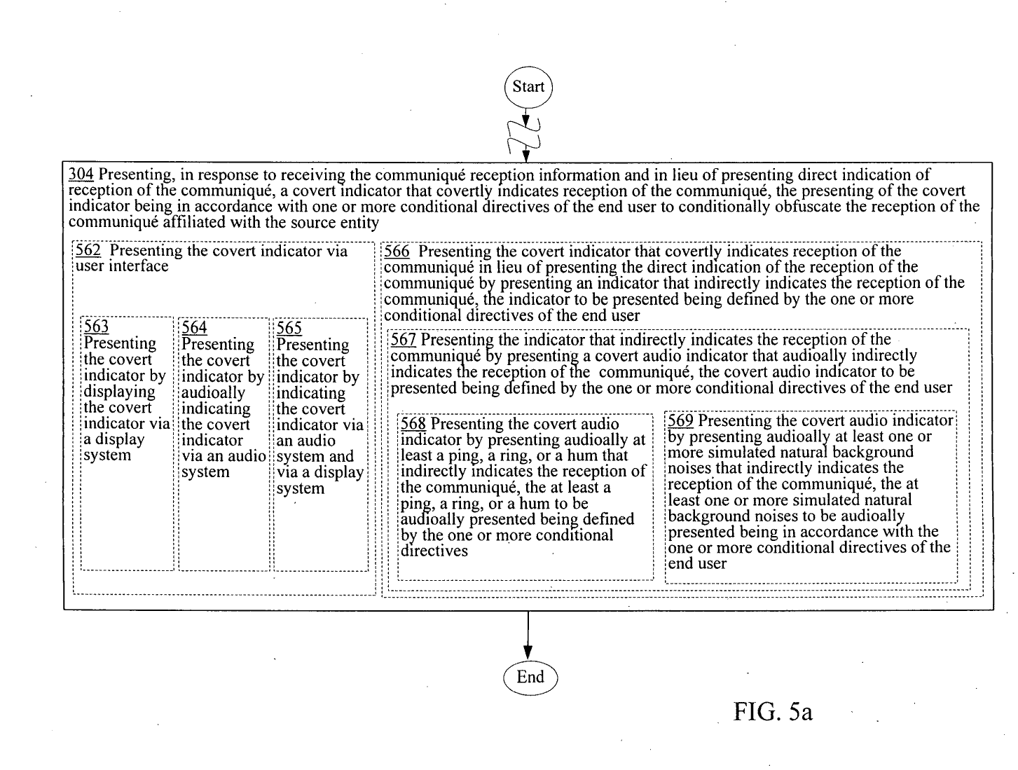

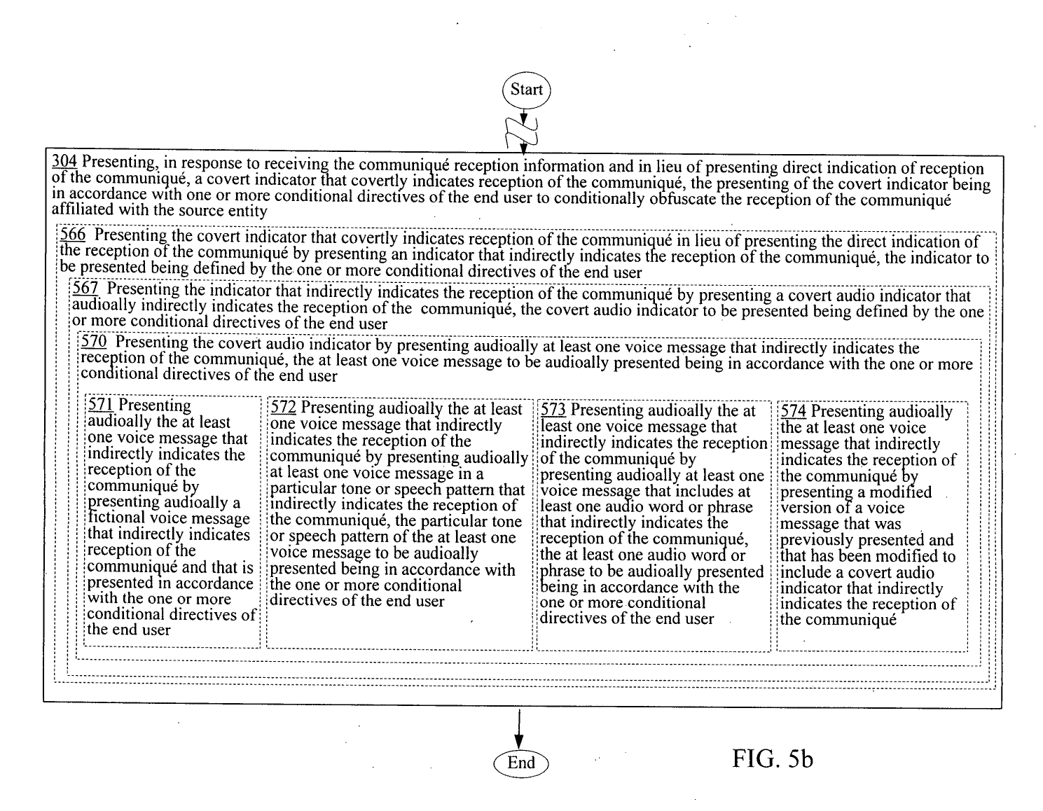

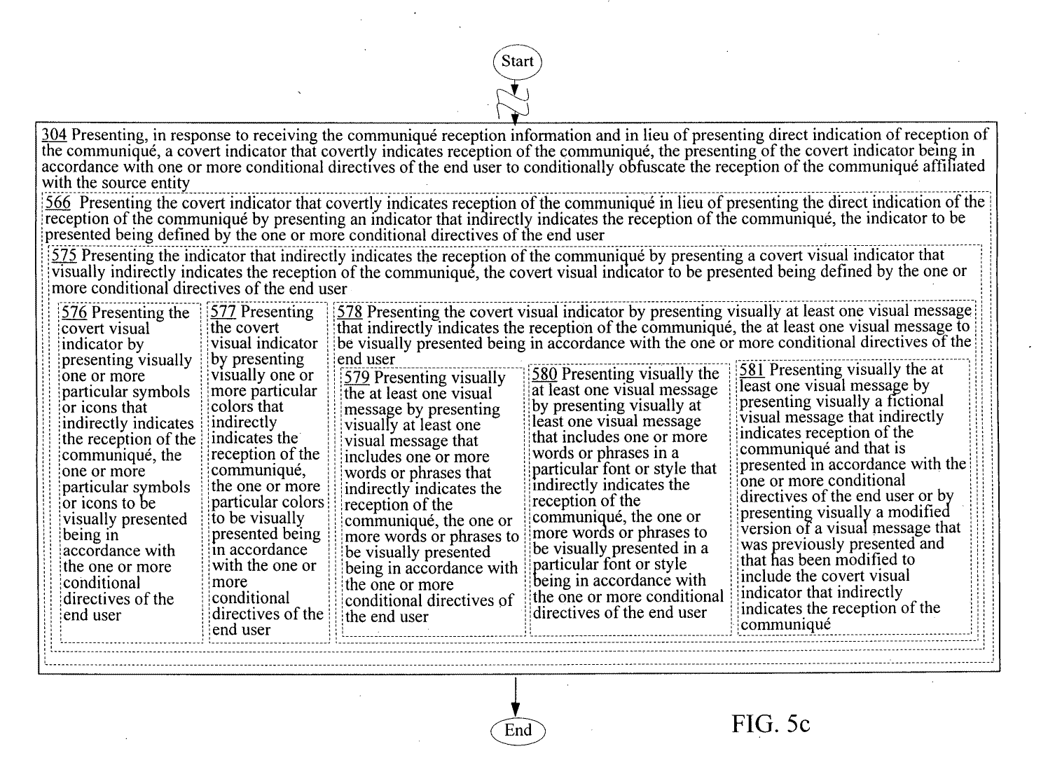

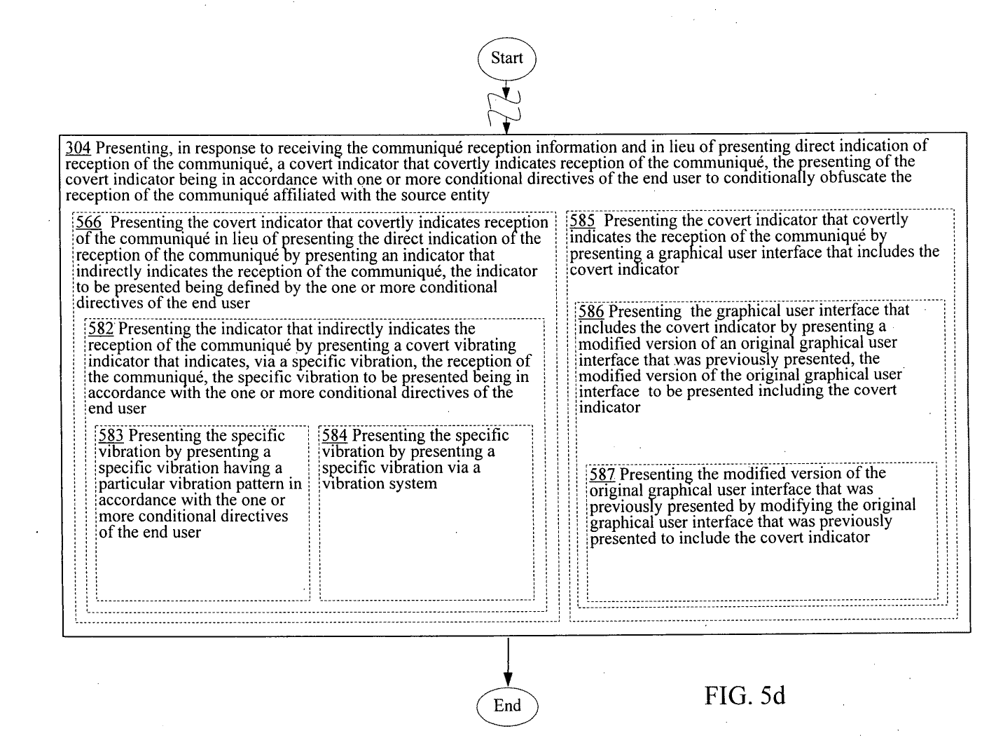

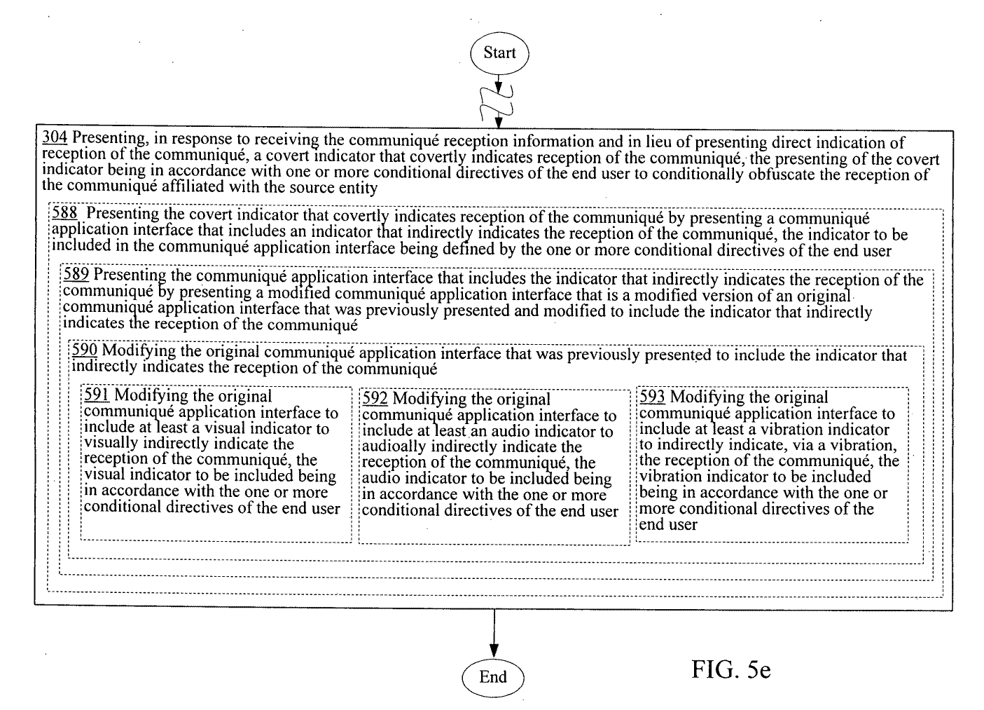

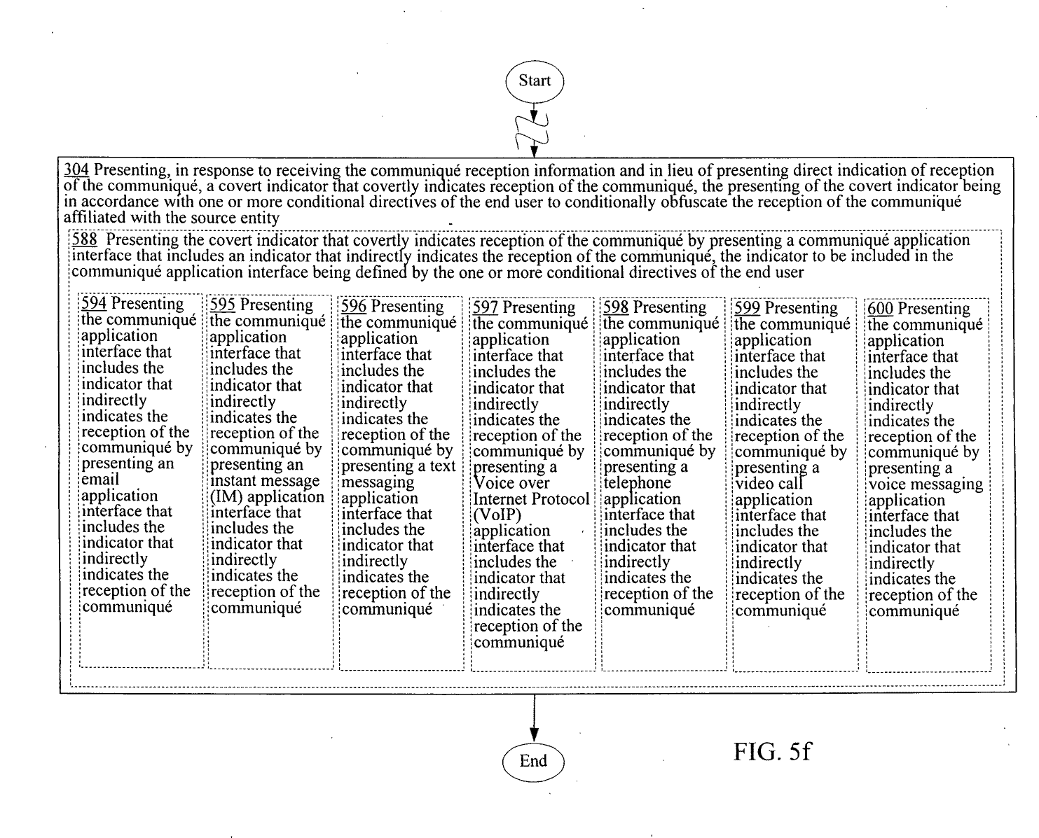

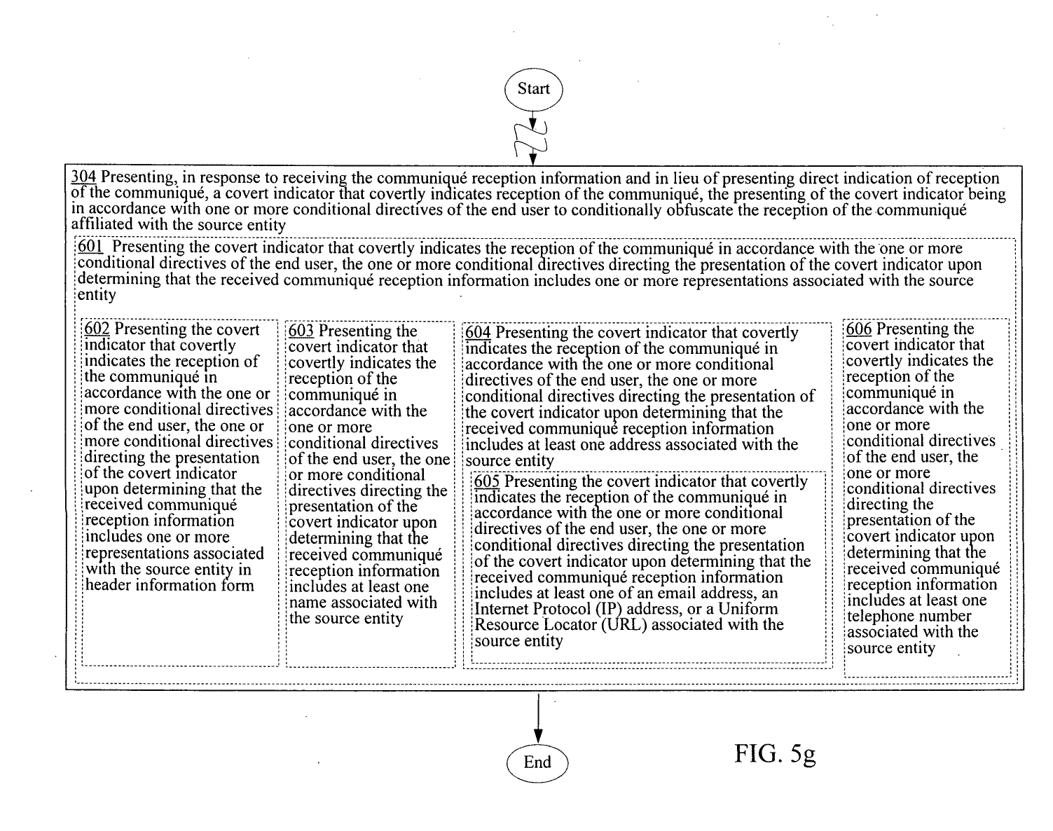

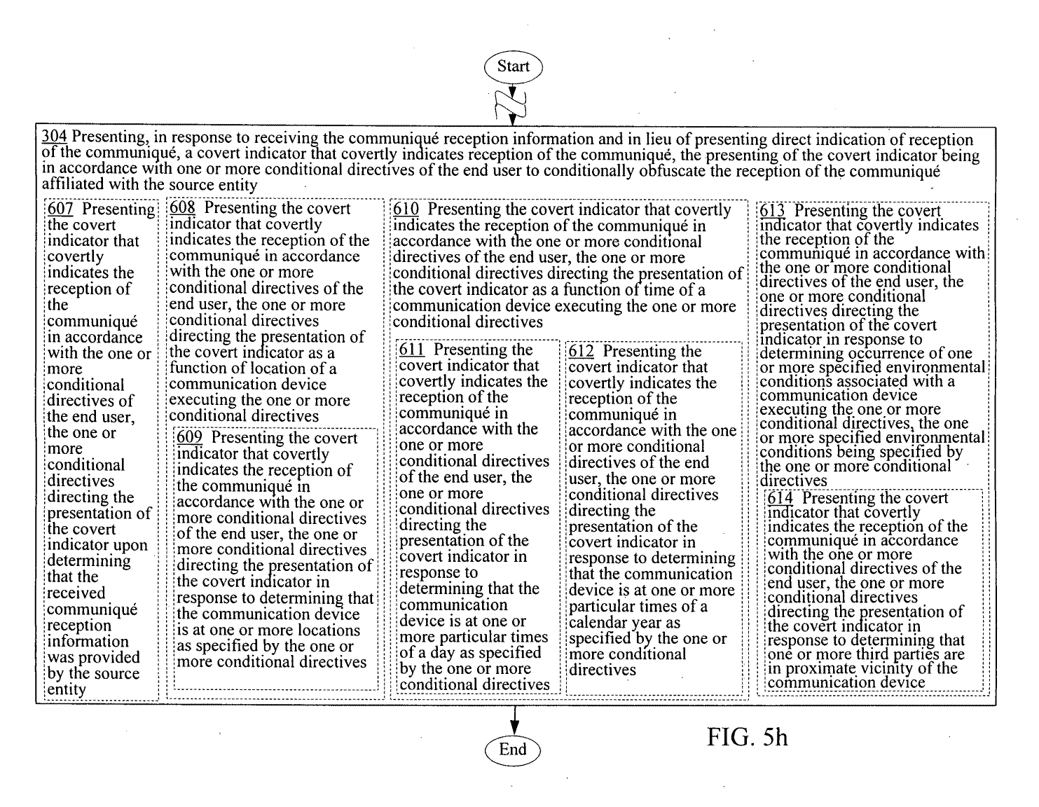

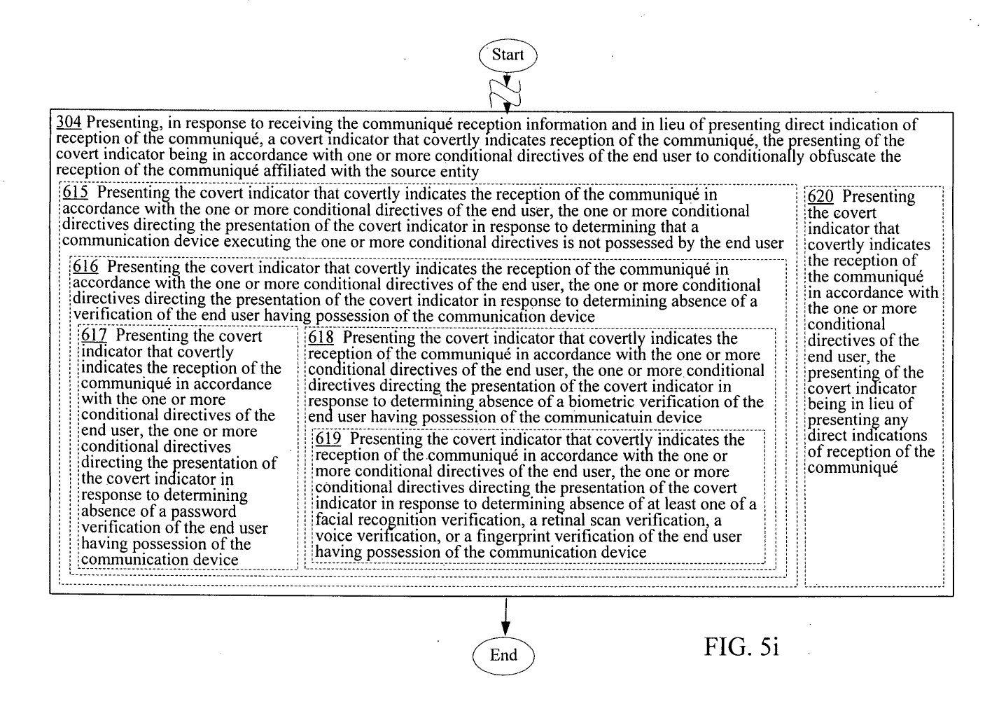

In some instances, the operation 446 of FIG. 4g for receiving the communiqué reception information that include the header information that indicates that the source entity is affiliated with the communiqué may further include an operation 453 for receiving the communiqué reception information that includes the header information, the header information including a subject heading that indicates that the communiqué is affiliated with the source entity as depicted in FIG. 5h. For instance, the communiqué reception information receiving module 102 of the communication device 10 of FIGS. 1a and 1b receiving the communiqué reception information 51* that includes the header information, the header information including a subject heading (a subject heading for the communiqué 52*) that indicates that the communiqué 52*(e.g., an email) is affiliated with the source entity 20.

Operation 453 may, in turn, further include an operation 454 for receiving the communiqué reception information that includes the subject heading, the subject heading including one or more words/phrases that are identified by the one or more conditional, directives as being affiliated with the source entity as depicted in FIG. 5h. For instance, the communiqué reception information receiving module 102 of the communication device 10 of FIGS. 1a and 1b receiving the communiqué reception information 51* that includes the subject heading, the subject heading including one or more words/phrases (e.g., a motto or a favorite saying) that are identified by the one or more conditional directives 50 as being affiliated with the source entity 20.

In various implementations, the communiqué reception information receiving operation 302 of FIG. 3 may be implemented in situations in which the communiqué 52′ is a missed communiqué 52′ that is received is unsuccessfully received (e.g., not successfully “picked-up” or accepted) by the communication device 10 that is executing the one or more conditional directives 50. For example, in some implementations, the communiqué reception information receiving operation 302 of FIG. 3 may include an operation 455 for receiving the communiqué reception information that indicates the reception of the communiqué by receiving communiqué reception information in connection with a missed communiqué that was not successfully delivered to the communication device executing the one or more conditional directives as further depicted in FIG. 4h. For instance, the communiqué reception information receiving module 102 of the communication device 10 of FIGS. 1a and 1b receiving the communiqué reception information 51″ that indicates the reception of the communiqué. 52″ by receiving communiqué reception information 51″ in connection with a missed communiqué 52″ that was not successfully delivered to the communication device 10 (e.g., not successfully accepted, received, or picked-up at the communication device 10) executing the one or more conditional directives 50. A communiqué 52″ may be unsuccessfully received or may be missed when, for example, the end user 32 is unavailable to accept the communiqué 52″ (e.g., a missed telephone call that was not picked-up by the end user 32) or when the communication device 10 is shut off or at least in a lower power mode such as sleep mode, which may prevent the communication device 10 from wholly receiving the communiqué 52″.

Operation 455 may, in turn, further include an operation 456 for receiving the communiqué reception information that indicates the reception of the communiqué by receiving communiqué reception information in connection with a missed incoming audio call as further depicted in FIG. 4h. For instance, the communiqué reception information receiving module 102 of the communication device 10 of FIGS. 1a and 1b receiving the communiqué reception information 51″ that indicates the reception of the communiqué 52″ by receiving communiqué reception information in 51″ in connection with a missed incoming audio call (e.g., an audio communiqué).

In some implementations, operation 456 may further include an operation 457 for receiving the communiqué reception information that indicates the reception of the communiqué by receiving communiqué reception information in connection with at least one of a missed incoming telephone call, a missed incoming Voice over Internet Protocol (VoIP) call, or a missed incoming video call as further depicted in FIG. 4h. For instance, the communiqué reception information receiving module 102 of the communication device 10 of FIGS. 1a and 1b receiving the communiqué reception information 51″ that indicates the reception of the communiqué 52″ by receiving communiqué reception information 51″ in connection with at least one of a missed incoming telephone call, a missed incoming Voice over Internet Protocol (VoIP) call, or a missed incoming video call.

In the same or different implementations, operation 456 may also include an operation 458 for receiving the communiqué reception information that indicates the reception of the communiqué by receiving the communiqué reception information via a ring signal as further depicted in FIG. 4h. For instance, the communiqué reception information receiving module 102 of the communication device 10 of FIGS. 1a and 1b receiving the communiqué reception information 51″ that indicates the reception of the communiqué 52″ by receiving communiqué reception information 51′ via a ring signal. For example, if the communiqué 52″ is a telephone call, than the communiqué reception information 51″ may be received embedded in the ring signal (which alerts the called party to an incoming call) of the incoming telephone call.

In some implementations, the communiqué reception information receiving operation 302 of FIG. 3 may be implemented in situations where the communiqué 52′ is received at a server 36 rather than at a communication device 10 that is executing the one or more conditional directives 50. These types of scenarios may be commonly encountered with, for example, systems that employ pull-technology in which communication messages, rather than being directly transmitted and stored at client devices (e.g., communication devices 10), may be stored at one or more network servers before being disseminated to the client devices. For instance, certain types of email services such as Hotmail, Yahoo mail, Gmail, and so forth, employ pull-type communication systems where emails or at least copies of emails directed to end users are normally stored at one or more network servers, and the emails are only distributed to client devices only upon receiving requests from the client devices. Thus, in some implementations, the communiqué reception information receiving operation 302 of FIG. 3 may include an operation 459 for receiving the communiqué reception information that indicates the reception of the communiqué by receiving communiqué reception information in connection with a communiqué that is received by a server that transmitted the communiqué reception information as further depicted in FIG. 4h. For instance, the communiqué reception information receiving module 102 of the communication device 10 of FIGS. 1a and 1b receiving the communiqué reception information 51′ that indicates the reception of the communiqué 52′ (e.g., email) by receiving communiqué reception information 51′ in connection with a communiqué 52′ that is received by a server 36 that transmitted (e.g., provided) the communiqué reception information 51′.

In some cases, operation 459 may, in turn, include an operation 460 for receiving the communiqué reception information that indicates the reception of the communiqué by receiving a received message list that include the communiqué reception information, the received message list being a list of one or more listings of one or more received messages that have been received and that are directed to the end user as further depicted in FIG. 4h. For instance, the communiqué reception information receiving module 102 of the communication device 10 of FIGS. 1a and 1b receiving the communiqué reception information 51′ that indicates the reception of the communiqué 52′ by receiving a received message list that include the communiqué reception information 51′, the received message list being a list of one or more listings of one or more received messages (e.g., emails, text messages, IMs, and so forth) that have been received by the server 36 and that are directed to the end user 32.

Operation 460 may further include, in some implementations, an operation 461 for receiving the communiqué reception information that indicates the reception of the communiqué by receiving a received email list that include the communiqué reception information, the received email list including one or more listings of one or more emails that have been received and that are directed to the end user, and the communiqué reception information being embodied by at least one of the listings as further depicted in FIG. 4h. For instance, the communiqué reception information receiving module 102 of the communication device 10 of FIGS. 1a and 1b receiving the communiqué reception information 51′ that indicates the reception of the communiqué 52′ by receiving a received email list that include the communiqué reception information 51′, the received email list including one or more listings of one or more emails that have been received by the server 36 and that are directed to the end user 32, and the communiqué reception information 51′ being embodied by at least one of the listings (e.g., each listing may indicate various header type information related to a corresponding email including subject heading, sender email address, sender name, receiving time stamp, and so forth).

Referring back to the covert indicator presenting operation 304 of FIG. 3, the covert indicator presenting operation 304 similar to the communiqué reception information receiving operation 302 of FIG. 3 may be executed in a number of different ways in various alternative implementations as illustrated in FIGS. 5a, 5b, 5c, 5d, 5e, 5f, 5g, 5h, and 5i. For example, in some implementations, the covert indicator presenting operation 304 of FIG. 3 may include an operation 562 for presenting the covert indicator via user interface as depicted in FIG. 5a. For instance, the covert indicator presenting module 104 of the communication device 10 of FIGS. 1a and 1b presenting the covert indicator 54 via user interface 120 (e.g., a display monitor, a touchscreen, one or more speakers, vibration system, and/or other hardware devices for interfacing with an end user 32).

As further illustrated in FIG. 5a, the covert indicator 54 that may be presented through operation 562 may be presented through any one or more of a variety of hardware systems in various alternative implementations. For example, in some implementations, operation 562 may further include an operation 563 for presenting the covert indicator by displaying the covert indicator via a display system as further depicted in FIG. 5a. For instance, the covert indicator presenting module 104 of the communication device 10 of FIGS. 1a and 1b presenting the covert indicator 54 by displaying the covert indicator 54 via a display system 121 (e.g., display monitor such as a LCD or a touchscreen).

In some alternative implementations, operation 562 may include an operation 564 for presenting the covert indicator by audioally indicating the covert indicator via an audio system as further depicted in FIG. 5a. For instance, the covert indicator presenting module 104 of the communication device 10 of FIGS. 1a and 1b presenting the covert indicator 54 by audioally indicating the covert indicator 54 (e.g., an audio indicator that covertly indicates the reception of the communiqué 52″) via an audio system 122 (e.g., one or more speakers).

In still other implementations, operation 562 may include an operation 565 for presenting the covert indicator by indicating the covert indicator via an audio system and via a display system as further depicted in FIG. 5a. For instance, the covert indicator presenting module 104 of the communication device 10 of FIGS. 1a and 1b presenting the covert indicator 54 by indicating the covert indicator 54 via an audio system 122 and via a display system 121. This may be the case, for example, when the covert indicator 54 to be presented has both a visual component (e.g., a still or moving image) and an audio component (e.g., a voice or a particular music) such as a talking iconic indicator (e.g., a talking cartoon character).

In various implementations, the covert indicator presenting operation 304 of FIG. 3 may include an operation 566 for presenting the covert indicator that covertly indicates reception of the communiqué in lieu of presenting the direct indication of the reception of the communiqué by presenting an indicator that indirectly indicates the reception of the communiqué, the indicator to be presented being defined by the one or more conditional directives of the end user as further depicted in FIG. 5a. For instance, the covert indicator presenting module 104 of the communication device 10 of FIGS. 1a and 1b presenting the covert indicator 54 that covertly indicates reception of the communiqué 52* in lieu of presenting the direct indication of the reception of the communiqué 52* by presenting an indicator (e.g., the covert indicator 54) that indirectly indicates (e.g., covertly indicates without explicitly identifying the communiqué 52* or the source entity 20 affiliated with the communiqué 52*) the reception of the communiqué 52*, the indicator to be presented being defined by the one or more conditional directives of the end user 32.

In other words, to present a covert indicator 54 (the meaning of which may not be known by one or more third parties) that when presented would convey a particular meaning (e.g., indicating reception of the communiqué 52* affiliated with the source entity 20) to only certain individuals or entities. For example, such an indicator (e.g., the covert indicator 54), when presented, may covertly indicate the reception of the communiqué 52* to only the receiver user 32 and to other individuals that the end user 32 may have confided in regarding the meaning of the covert indicator 54. In order to do so, the presented indicator (e.g., covert indicator 54) may not, at least, directly identify the reception of the communiqué 52*, the communiqué 52* itself, the source entity 20 affiliated with the communiqué 52*, and/or other aspects of the communiqué 52* that would alert a third party that the communiqué 52* affiliated with the particular source entity 20 has been received. In some cases, the covert nature of the indicator to be presented may be made possible by having the end user 32 select the indicator (e.g., the covert indicator 54) to be presented via the one or more conditional directives 50, which the end user 32 may provide.

As further illustrated in FIGS. 5a, 5b, 5c, and 5d, operation 566 may include one or more additional operations in various alternative implementations. For example, in some implementations, operation 566 may include an operation 567 for presenting the indicator that indirectly indicates the reception of the communiqué by presenting a covert audio indicator that audioally indirectly indicates the reception of the communiqué, the covert audio indicator to be presented being defined by the one or more conditional directives of the end user as depicted in FIG. 5a. For instance, the covert indicator presenting module 104 including the covert audio indicator presenting module 242 (see FIG. 2b) of the communication device 10 of FIGS. 1a and 1b presenting the indicator (e.g., the covert indicator 54) that indirectly indicates the reception of the communiqué 52* by having the covert audio indicator presenting module 242 presenting a covert audio indicator that audioally indirectly indicates the reception of the communiqué 52*, the covert audio indicator to be presented (e.g., audioally presented via one or more speakers) being defined by the one or more conditional directives 50 of the end user 32.

In some cases, operation 567 may further include an operation 568 for presenting the covert audio indicator by presenting audioally at least a ping, a ring, or a hum that indirectly indicates the reception of the communiqué, the at least a ping, a ring, or a hum to be audioally presented being defined by the one or more conditional directives as depicted in FIG. 5a. For instance, the covert audio indicator presenting module 242 (see FIG. 2b) of the communication device 10 of FIGS. 1a and 1b presenting the covert audio indicator by presenting audioally at least a ping, a ring, or a hum that indirectly indicates the reception of the communiqué 52*, the at least a ping, a ring, or a hum to be audioally presented being defined by the one or more conditional directives 50.

In the same or different implementations, operation 567 may further include an operation 569 for presenting the covert audio indicator by presenting audioally at least one or more simulated natural background noises that indirectly indicates the reception of the communiqué, the at least one or more simulated natural background noises to be audioally presented being in accordance with the one or more conditional directives of the end user as further depicted in FIG. 5a. For instance, the covert audio indicator presenting module 242 of the communication device 10 of FIGS. 1a and 1b presenting the covert audio indicator (e.g., covert indicator 54) by presenting audioally at least one or more simulated natural background noises (e.g., dog barking, noise of a train or a truck passing, sound of someone speaking in the background, and so forth) that indirectly indicates the reception of the communiqué 52*(e.g., a telephone call or a voice message), the at least one or more simulated natural background noises to be audioally presented (e.g., via an audio system 122 including one or more speakers) being in accordance with the one or more conditional directives 50 of the end user 32. Note that in some cases, the one or more simulated natural background noises may merely be recordings of natural background noise. In order to present such a covert audio indicator, in some implementations the covert audio indicator may be combined with a voice message that may have been previously presented such as an actual or “real” voice message previously recorded, or combined with a fictional voice message.

In the same or different implementations, operation 567 may further include an operation 570 for presenting the covert audio indicator by presenting audioally at least one voice message that indirectly indicates the reception of the communiqué, the at least one voice message to be audioally presented being in accordance with the one or more conditional directives of the end user as depicted in FIG. 5b. For instance, the covert audio indicator presenting module 242 including the voice message presenting module 243 (see FIG. 2b) of the communication device 10 of FIGS. 1a and 1b presenting the covert audio indicator (e.g., covert indicator 54) by having the voice message presenting module 243 presenting audioally at least one voice message that indirectly indicates (e.g., via simulated natural background noise or the use of a particular phrase or word in the voice message) the reception of the communiqué 52*, the at least one voice message to be audioally presented being in accordance with the one or more conditional directives 50 of the end user 32.

As further illustrated in FIG. 5b, operation 570 may further include one or more additional operations in various alternative implementations. For example, in some implementations, operation 570 may include an operation 571 for presenting audioally the at least one voice message that indirectly indicates the reception of the communiqué by presenting audioally a fictional voice message that indirectly indicates reception of the communiqué and that is presented in accordance with the one or more conditional directives of the end user as depicted in FIG. 5b. For instance, the voice message presenting module 243 including the fictional voice message presenting module 244 (see FIG. 2b) of the communication device 10 of FIGS. 1a and 1b presenting audioally the at least one voice message that indirectly indicates the reception of the communiqué 52* by having the fictional voice message presenting module 244 presenting audioally a fictional voice message (e.g., covert indicator 54) that indirectly indicates reception of the communiqué 52* and that is presented in accordance with the one or more conditional directives 50 of the end user 32.

The fictional voice message to be presented may be a fictional voice message from a fictional third party, or may be a fictional operational audio message related to a communiqué application (e.g., an email application) or other types of applications (e.g., an operating system such as Microsoft Vista or Windows 7.0). The fictional voice message may covertly indicate to the end user 32 the reception of the communiqué 52* in any number of ways since the fictional voice message (e.g., covert indicator 54) will be presented in accordance with the one or more conditional directives 50 of the end user 32. For example, in some cases, the mere presentation of the fictional voice message may be sufficient to covertly indicate to the end user 32 of the reception of the communiqué 52*. Alternatively, insertion of particular words or phrases or insertion of particular simulated background noise (e.g., passing train) into the fictional voice message may be employed in order to covertly alert the end user 32 to the reception of the communiqué 52.

In the same or different implementations, operation 570 may also include an operation 572 for presenting audioally the at least one voice message that indirectly indicates the reception of the communiqué by presenting audioally at least one voice message in a particular tone or speech pattern that indirectly indicates the reception of the communiqué, the particular tone or speech pattern of the at least one voice message to be audioally presented being in accordance with the one or more conditional directives of the end user as further depicted in FIG. 5b. For instance, the voice message presenting module 243 of the communication device 10 of FIGS. 1a and 1b presenting audioally the at least one voice message that indirectly indicates the reception of the communiqué 52* by presenting audioally at least one voice message in a particular tone or speech pattern (e.g., covert indicator 54) that indirectly indicates the reception of the communiqué 52*, the particular tone or speech pattern of the at least one voice message to be audioally presented being in accordance with the one or more conditional directives 50 of the end user 32.

In the same or different implementations, operation 570 may also include an operation 573 for presenting audioally the at least one voice message that indirectly indicates the reception of the communiqué by presenting audioally at least one voice message that includes at least one audio word or phrase that indirectly indicates the reception of the communiqué, the at least one audio word or phrase to be audioally presented being in accordance with the one or more conditional directives of the end user as depicted in FIG. 5b. For instance, the voice message presenting module 243 of the communication device 10 of FIGS. 1a and 1b presenting audioally the at least one voice message that indirectly indicates the reception of the communiqué 52* by presenting audioally at least one voice message that includes at least one audio word or phrase (e.g., covert indicator 54) that indirectly indicates the reception of the communiqué 52*, the at least one audio word or phrase to be audioally presented being in accordance with the one or more conditional directives 50 of the end user 32.

In the same or different implementations, operation 570 may also include an operation 574 for presenting audioally the at least one voice message that indirectly indicates the reception of the communiqué by presenting a modified version of a voice message that was previously presented and that has been modified to include a covert audio indicator that indirectly indicates the reception of the communiqué as further depicted in FIG. 5b. For instance, the voice message presenting module 243 including the modified voice message presenting module 245 (see FIG. 2b) of the communication device 10 of FIGS. 1a and 1b presenting audioally the at least one voice message that indirectly indicates the reception of the communiqué 52* by having the modified voice message presenting module 245 presenting a modified version of a voice message that was previously presented and that has been modified to include a covert audio indicator (e.g, words or phrases, or simulated background noise) that indirectly indicates the reception of the communiqué 52*. For these implementations, the voice message that is modified may have been, for example, a real (non-fictional) voice message that was previously obtained from a third party, a fictional voice message, or a “real” or fictional operational message related to operational aspects of the communication device 10.

In some cases, operation 566 for presenting the covert indicator that covertly indicates reception of the communiqué in lieu of presenting the direct indication of the reception of the communiqué by presenting an indicator that indirectly indicates the reception of the communiqué, the indicator to be presented being defined by the one or more conditional directives of the end user may include an operation 575 for presenting the indicator that indirectly indicates the reception of the communiqué by presenting a covert visual indicator that visually indirectly indicates the reception of the communiqué, the covert visual indicator to be presented being defined by the one or more conditional directives of the end user as depicted in FIG. 5c. For instance, the covert indicator presenting module 104 including the covert visual indicator presenting module 246 (see FIG. 2b) of the communication device 10 of FIGS. 1a and 1b presenting the indicator (e.g., covert indicator 54) that indirectly indicates the reception of the communiqué 52* by having the covert visual indicator presenting module 246 presenting a covert visual indicator that visually indirectly indicates the reception of the communiqué 52*, the covert visual indicator to be presented being defined by the one or more conditional directives 50 of the end user 32. As will be further described herein, a variety of covert visual indicators may be used in various alternative implementations in order to indirectly indicate (e.g., to the end user 32) the reception of the communiqué 52*.

For example, in some implementations, operation 575 may further include an operation 576 for presenting the covert visual indicator by presenting visually one or more particular symbols or icons that indirectly indicates the reception of the communiqué, the one or more particular symbols or icons to be visually presented being in accordance with the one or more conditional directives of the end user as further depicted in FIG. 5c. For instance, the covert visual indicator presenting module 246 of the communication device 10 of FIGS. 1a and 1b presenting the covert visual indicator (e.g., covert indicator 54) by presenting visually (e.g., via a display system 121 including a display monitor or a touchscreen) one or more particular symbols or icons that indirectly indicates the reception of the communiqué 52*, the one or more particular symbols or icons to be visually presented being in accordance with the one or more conditional directives 50 of the end user 32.

In the same or different implementations, operation 575 may also include an operation 577 for presenting the covert visual indicator by presenting visually one or more particular colors that indirectly indicates the reception of the communiqué, the one or more particular colors to be visually presented being in accordance with the one or more conditional directives of the end user as further depicted in FIG. 5c. For instance, the covert visual indicator presenting module 246 of the communication device 10 of FIGS. 1a and 1b presenting the covert visual indicator (e.g., covert indicator 54) by presenting visually (e.g., via a display system 121 including a display monitor or a touchscreen) one or more particular colors that indirectly indicates the reception of the communiqué 52*, the one or more particular colors to be visually presented being in accordance with the one or more conditional directives 50 of the end user 32. The one or more particular colors to be presented may be in the form of background colors of a display screen or in the form of colors for one or more visual items (e.g., icons, lettering, or figures) that are displayed through a display screen.

In the same or different implementations, operation 575 may also include an operation 578 for presenting the covert visual indicator by presenting visually at least one visual message that indirectly indicates the reception of the communiqué, the at least one visual message to be visually presented being in accordance with the one or more conditional directives of the end user as further depicted in FIG. 5c. For instance, the covert visual indicator presenting module 246 including the visual message presenting module 247 (see FIG. 2b) of the communication device 10 of FIGS. 1a and 1b presenting the covert visual indicator (e.g., covert indicator 54) by having the visual message presenting module 247 presenting visually (e.g., via a display system 121 including a display monitor or a touchscreen) at least one visual message (e.g., visual textual message) that indirectly indicates the reception of the communiqué 52*, the at least one visual message to be visually presented being in accordance with the one or more conditional directives 50 of the end user 32. The visual message to be presented may be fictional message (e.g., a message created for indirectly indicating reception of the communiqué 52*) or non-fictional message (e.g., an actual message that may or may not have been modified). The visual message to be presented may also be in the form of a communiqué message such as an email or text message, or a message that appears to be an operational message related to, for example, a communiqué application (e.g., instant messaging application), or a message that appears to be an operational message related to an operating system (e.g., Symbian OS or Windows 7).

Various types of visual messages that indirectly indicates the reception of the communiqué 52* may be presented through operation 578 in various alternative implementations. For example, in some implementations, operation 578 may include an operation 579 for presenting visually the at least one visual message by presenting visually at least one visual message that includes one or more words or phrases that indirectly indicates the reception of the communiqué, the one or more words or phrases to be visually presented being in accordance with the one or more conditional directives of the end user as further depicted in FIG. 5c. For instance, the visual message presenting module 247 of the communication device 10 of FIGS. 1a and 1b presenting visually (e.g., via display system 121) the at least one visual message by presenting visually at least one visual message that includes one or more words or phrases (e.g., covert indicator 54) that indirectly indicates the reception of the communiqué 52*, the one or more words or phrases to be visually presented being in accordance with the one or more conditional directives 50 of the end user 32.

In the same or different implementations, operation 578 may also include an operation 580 for presenting visually the at least one visual message by presenting visually at least one visual message that includes one or more words or phrases in a particular font or style that indirectly indicates the reception of the communiqué, the one or more words or phrases to be visually presented in a particular font or style being in accordance with the one or more conditional directives of the end user as further depicted in FIG. 5c. For instance, the visual message presenting module 247 of the communication device 10 of FIGS. 1a and 1b presenting visually the at least one visual message by presenting visually (e.g., via display system 121 including a display monitor or a touchscreen) at least one visual message that includes one or more words or phrases in a particular font or style that indirectly indicates the reception of the communiqué 52*, the one or more words or phrases to be visually presented in a particular font or style being in accordance with the one or more conditional directives 50 of the end user 32.

In the same or different implementations, operation 578 may also include an operation 581 for presenting visually the at least one visual message by presenting visually a fictional visual message that indirectly indicates reception of the communiqué and that is presented in accordance with the one or more conditional directives of the end user or by presenting visually a modified version of a visual message that was previously presented and that has been modified to include the covert visual indicator that indirectly indicates the reception of the communiqué as further depicted in FIG. 5c. For instance, the visual message presenting module 247 including the fictional visual message presenting module 248 or the modified visual message presenting module 249 (see FIG. 2b) of the communication device 10 of FIGS. 1a and 1b presenting visually (e.g., via display system 121) the at least one visual message by having the fictional visual message presenting module 248 presenting visually a fictional visual message (a message that was created for this purpose) that indirectly indicates reception of the communiqué 52* and that is presented in accordance with the one or more conditional directives 50 of the end user 32 or by having the modified visual message presenting module 249 presenting visually a modified version of a visual message that was previously presented and that has been modified to include the covert visual indicator (e.g., background color, particular symbols or icons, one or more particular words or phrases, and so forth) that indirectly indicates the reception of the communiqué 52*.

Referring-now to FIG. 5d, the operation 566 for presenting the covert indicator that covertly indicates reception of the communiqué in lieu of presenting the direct indication of the reception of the communiqué by presenting an indicator that indirectly indicates the reception of the communiqué, the indicator to be presented being defined by the one or more conditional directives of the end user may include, in various implementations, an operation 582 for presenting the indicator that indirectly indicates the reception of the communiqué by presenting a covert vibrating indicator that indicates, via a specific vibration, the reception of the communiqué, the specific vibration to be presented being in accordance with the one or more conditional directives of the end user. For instance, the covert indicator presenting module 104 including the covert vibrating indicator presenting module 250 (see FIG. 2b) of the communication device 10 of FIGS. 1a and 1b presenting the indicator (e.g., covert indicator 54) that indirectly indicates the reception of the communiqué 52* by having the covert vibrating indicator presenting module 250 presenting a covert vibrating indicator that indicates, via a specific vibration, the reception of the communiqué 52*, the specific vibration (e.g., specific pattern of vibration or specific vibration strength) to be presented being in accordance with the one or more conditional directives 50 of the end user 32. In some cases, the specific vibration that may be generated may be presented in conjunction with the presentation of one or more other covert indicators 54 (e.g., audio or visual indicators that covertly or indirectly indicates the reception of the communiqué 52*).

As further illustrated in FIG. 5d, operation 582 may further include one or more additional operations in various alternative implementations. For example, in some implementations, operation 582 may include an operation 583 for presenting the specific vibration by presenting a specific vibration having a particular vibration pattern in accordance with the one or more conditional directives of the end user as further depicted in FIG. 5d. For instance, the covert vibrating indicator presenting module 250 of the communication device 10 of FIGS. 1a and 1b presenting the specific vibration by presenting a specific vibration having a particular vibration pattern in accordance with the one or more conditional directives 50 of the end user 32.

In the same or different implementations, operation 582 may include an operation 584 for presenting the specific vibration by presenting a specific vibration via a vibration system as further depicted in FIG. 5d. For instance, the covert vibrating indicator presenting module 250 of the communication device 10 of FIGS. 1a and 1b presenting the specific vibration by presenting a specific vibration (e.g., specific vibration rhythm) via a vibration system 123.

Referring back to FIG. 5d, in various implementations, the covert indicator presenting operation 304 of FIG. 3 may include an operation 585 for presenting the covert indicator that covertly indicates the reception of the communiqué by presenting a graphical user interface that includes the covert indicator as further depicted in FIG. 5d. For instance, the covert indicator presenting module 104 including the graphical user interface presenting module 251 (see FIG. 2b) of the communication device 10 of FIGS. 1a and 1b presenting the covert indicator 54 that covertly indicates the reception of the communiqué 52* by having the graphical user interface (GUI) presenting module 251 presenting a graphical user interface (e.g., an operating system (OS) application interface such as the interface for Google's Android, Symbian OS interface, Vista Smartphone interface, Windows 7 interface, and so forth) that includes the covert indicator 54 (e.g., a covert audio indicator, a covert visual indicator, and/or a covert vibrating indicator).

As further illustrated in FIG. 5d, operation 585 may further include one or more additional operations in various implementations. For example, in some cases, operation 585 may include an operation 586 for presenting the graphical user interface that includes the covert indicator by presenting a modified version of an original graphical user interface that was previously presented, the modified version of the original graphical user interface to be presented including the covert indicator as further depicted in FIG. 5d. For instance, the GUI presenting module 251 including the modified GUI presenting module 252 (see FIG. 2b) of the communication device 10 of FIGS. 1a and 1b presenting the graphical user interface (GUI) that includes the covert indicator 54 by having the modified graphical user interface presenting module 252 presenting a modified version of an original graphical user interface that was previously presented through, for example, a display system 121, the modified version of the original graphical user interface to be presented including the covert indicator 54 (e.g., a covert visual indicator, a covert audio indicator, and/or a covert vibrating indicator that may be presented in conjunction with the graphical user interface).

In some cases, operation 586 may, in turn, include an operation 587 for presenting the modified version of the original graphical user interface that was previously presented by modifying the original graphical user interface that was previously presented to include the covert indicator as further depicted in FIG. 5d. For instance, the modified GUI presenting module 252 including the GUI modifying module 253 (see FIG. 2b) of the communication device 10 of FIGS. 1a and 1b presenting the modified version of the original graphical user interface that was previously presented by having the GUI modifying module 253 modifying the original graphical user interface that was previously presented to include the covert indicator 54.

Turning now to FIG. 5e, in various implementations, the covert indicator presenting operation 304 of FIG. 3 may include an operation 588 for presenting the covert indicator that covertly indicates reception of the communiqué by presenting a communiqué application interface that includes an indicator that indirectly indicates the reception of the communiqué, the indicator to be included in the communiqué application interface being defined by the one or more conditional directives of the end user. For instance, the covert indicator presenting module 104 including the communiqué application interface presenting module 254 (see FIG. 2b) of the communication device 10 of FIGS. 1a and 1b presenting the covert indicator 54 that covertly indicates reception of the communiqué by having the communiqué application interface presenting module 254 presenting a communiqué application interface (e.g., email application interface or a VoIP application interface) that includes an indicator that indirectly indicates the reception of the communiqué 52*, the indicator to be included in the communiqué application interface being defined by the one or more conditional directives 50 of the end user 32.

As further illustrated in FIG. 5e, operation 588 may further include one or more additional operations in various implementations. For example, in some implementations, operation 588 may further include an operation 589 for presenting the communiqué application interface that includes the indicator that indirectly indicates the reception of the communiqué by presenting a modified communiqué application interface that is a modified version of an original communiqué application interface that was previously presented and modified to include the indicator that indirectly indicates the reception of the communiqué as further depicted in FIG. 5e. For instance, the communiqué application interface presenting module 254 including the modified communiqué application interface presenting module 255 (see FIG. 2b) of the communication device 10 of FIGS. 1a and 1b presenting the communiqué application interface that includes the indicator that indirectly indicates the reception of the communiqué 52* by having the modified communiqué application interface presenting module 255 presenting a modified communiqué application interface that is a modified version of an original communiqué application interface that was previously presented and modified to include the indicator (e.g., covert indicator 54) that indirectly indicates the reception of the communiqué 52*. Note that in various implementations the modified communiqué application interface to be presented may be a visual interface (e.g., as provided through a display monitor) and/or an audio interface (e.g., as provided through one or more speakers).

In various implementations, operation 589 may, in turn, further include an operation 590 for modifying the original communiqué application interface that was previously presented to include the indicator that indirectly indicates the reception of the communiqué as further depicted in FIG. 5e. For instance, the communiqué application interface modifying module 256 (see FIG. 2b) of the communication device 10 of FIGS. 1a and 1b modifying (e.g., revising, adding, or subtracting) the original communiqué application interface (e.g., an email application interface, an IM application interface, an VoIP application interface, and so forth) that was previously presented to include the indicator (e.g., covert indicator 54) that indirectly indicates the reception of the communiqué 52*:

In some implementations, operation 590 may further include an operation 591 for modifying the original communiqué application interface to include at least a visual indicator to visually indirectly indicate the reception of the communiqué, the visual indicator to be included being in accordance with the one or more conditional directives of the end user as depicted in FIG. 5e. For instance, the communiqué application interface modifying module 256 of the communication device 10 of FIGS. 1a and 1b modifying the original communiqué application interface to include at least a visual indicator (e.g., a color, a visual symbol, a visual icon, a visual word, and/or a visual phrase) to visually indirectly indicate the reception of the communiqué 52*, the visual indicator to be included being in accordance with the one or more conditional directives 50 of the end user 32.

In the same or different implementations, operation 590 may include an operation 592 for modifying the original communiqué application interface to include at least an audio indicator to audioally indirectly indicate the reception of the communiqué, the audio indicator to be included being in accordance with the one or more conditional directives of the end user as further depicted in FIG. 5e. For instance, the communiqué application interface modifying module 256 of the communication device 10 of FIGS. 1a and 1b modifying the original communiqué application interface to include at least an audio indicator (e.g., an audio ping, an audio buzz, a simulated natural background noise, audio words/phrases, and so forth) to audioally indirectly indicate the reception of the communiqué 52*, the audio indicator to be included being in accordance with the one or more conditional directives 50 of the end user 32.

In the same or different implementations, operation 590 may include an operation 593 for modifying the original communiqué application interface to include at least a vibration indicator to indirectly indicate, via a vibration, the reception of the communiqué, the vibration indicator to be included being in accordance with the one or more conditional directives of the end user as depicted in FIG. 5e. For instance, the communiqué application interface modifying module 256 of the communication device 10 of FIGS. 1a and 1b modifying the original communiqué application interface to include at least a vibration indicator to indirectly indicate, via a vibration, the reception of the communiqué 52*, the vibration indicator to be included being in accordance with the one or more conditional directives 50 of the end user 32. In some cases, the vibration indicator may be presented in conjunction with the presentation of other covert indicators 54 (e.g., visual and/or audio covert indicators).

The communiqué application interface that may be presented through operation 588 of FIG. 5e may be any one of a variety of communiqué application interfaces that may be used in order to access a variety of communiqué types (e.g., text messages, IMs, emails, VoIP calls, and so forth). For example, in some cases, operation 588 may include an operation 594 for presenting the communiqué application interface that includes the indicator that indirectly indicates the reception of the communiqué by presenting an email application interface that includes the indicator that indirectly indicates the reception of the communiqué as depicted in FIG. 5f. For instance, the communiqué application interface presenting module 254 (see FIG. 2b) of the communication device 10 of FIGS. 1a and 1b presenting the communiqué application interface that includes the indicator (e.g., covert indicator 54) that indirectly indicates the reception of the communiqué 52* by presenting an email application interface that includes the indicator (e.g., a covert audio indicator, a covert visual indicator, and/or a covert vibration indicator) that indirectly indicates the reception of the communiqué 52*.

In some implementations, operation 588 may include an operation 595 for presenting the communiqué application interface that includes the indicator that indirectly indicates the reception of the communiqué by presenting an instant message (IM) application interface that includes the indicator that indirectly indicates the reception of the communiqué as depicted in FIG. 5f. For instance, the communiqué application interface presenting module 254 of the communication device 10 of FIGS. 1a and 1b presenting the communiqué application interface that includes the indicator (e.g., covert indicator 54) that indirectly indicates the reception of the communiqué 52* by presenting an instant message (IM) application interface that includes the indicator (e.g., covert audio indicator, covert visual indicator, and/or covert vibration indicator) that indirectly indicates the reception of the communiqué 52*.

In some implementations, operation 588 may include an operation 596 for presenting the communiqué application interface that includes the indicator that indirectly indicates the reception of the communiqué by presenting a text messaging application interface that includes the indicator that indirectly indicates the reception of the communiqué as further depicted in FIG. 5f. For instance, the communiqué application interface presenting module 254 of the communication device 10 of FIGS. 1a and 1b presenting the communiqué application interface that includes the indicator (e.g., covert indicator 54) that indirectly indicates the reception of the communiqué 52* by presenting a text messaging application interface that includes the indicator (e.g., covert audio indicator, covert visual indicator, and/or covert vibration indicator) that indirectly indicates the reception of the communiqué 52*.

In some implementations, operation 588 may include an operation 597 for presenting the communiqué application interface that includes the indicator that indirectly indicates the reception of the communiqué by presenting a Voice over Internet Protocol (VoIP) application interface that includes the indicator that indirectly indicates the reception of the communiqué as depicted in FIG. 5f. For instance, the communiqué application interface presenting module 254 of the communication device 10 of FIGS. 1a and 1b presenting the communiqué application interface that includes the indicator (e.g., covert indicator 54) that indirectly indicates the reception of the communiqué 52* by presenting a Voice over Internet Protocol (VoIP) application interface that includes the indicator (e.g., covert audio indicator, covert visual indicator, and/or covert vibration indicator) that indirectly indicates the reception of the communiqué 52*.

In some implementations, operation 588 may include an operation 598 for presenting the communiqué application interface that includes the indicator that indirectly indicates the reception of the communiqué by presenting a telephone application interface that includes the indicator that indirectly indicates the reception of the communiqué as further depicted in FIG. 5f. For instance, the communiqué application interface presenting module 254 of the communication device 10 of FIGS. 1a and 1b presenting the communiqué application interface that includes the indicator (e.g., covert indicator 54) that indirectly indicates the reception of the communiqué 52* by presenting a telephone application interface that includes the indicator (e.g., covert audio indicator, covert visual indicator, and/or covert vibration indicator) that indirectly indicates the reception of the communiqué 52*.

In some implementations, operation 588 may include an operation 599 for presenting the communiqué application interface that includes the indicator that indirectly indicates the reception of the communiqué by presenting a video call application interface that includes the indicator that indirectly indicates the reception of the communiqué as further depicted in FIG. 5f. For instance, the communiqué application interface presenting module 254 of the communication device 10 of FIGS. 1a and 1b presenting the communiqué application interface that includes the indicator (e.g., covert indicator 54) that indirectly indicates the reception of the communiqué 52* by presenting a video call application interface that includes the indicator (e.g., covert audio indicator, covert visual indicator, and/or covert vibration indicator) that indirectly indicates the reception of the communiqué 52*.

In some implementations, operation 588 may include an operation 600 for presenting the communiqué application interface that includes the indicator that indirectly indicates the reception of the communiqué by presenting a voice messaging application interface that includes the indicator that indirectly indicates the reception of the communiqué as depicted in FIG. 5f. For instance, the communiqué application interface presenting module 254 of the communication device 10 of FIGS. 1a and 1b presenting the communiqué application interface that includes the indicator (e.g., covert indicator 54) that indirectly indicates the reception of the communiqué 52* by presenting a voice messaging application interface that includes the indicator (e.g., covert audio indicator, covert visual indicator, and/or covert vibration indicator) that indirectly indicates the reception of the communiqué 52*.

The covert indicator presenting operation 304 of FIG. 3 may be executed in accordance with a variety of conditional directives 50 that may be provided by the end user 32 in various alternative implementations. For example, in some implementations, the covert indicator presenting operation 304 of FIG. 3 may include an operation 601 for presenting the covert indicator that covertly indicates the reception of the communiqué in accordance with the one or more conditional directives of the end user, the one or more conditional directives directing the presentation of the covert indicator upon determining that the received communiqué reception information includes one or more representations associated with the source entity as depicted in FIG. 5g. For instance, the covert indicator presenting module 104 including the source entity associated representation inclusion determining module 257 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 (e.g., in lieu of presenting the direct indication of the reception of the communiqué 52*) upon determining (e.g., as determined by the source entity associated representation inclusion determining module 257) that the received communiqué reception information 51* includes one or more representations (e.g., identifiers such as an address, a username, a telephone number, and so forth) associated with the source entity 20.

As further illustrated in FIG. 5g, operation 601 may further include one or more additional operations in various alternative implementations. For example, in some implementations, operation 601 may include an operation 602 for presenting the covert indicator that covertly indicates the reception of the communiqué in accordance with the one or more conditional directives of the end user, the one or more conditional directives directing the presentation of the covert indicator upon determining that the received communiqué reception information includes one or more representations associated with the source entity in header information form as depicted in FIG. 5g. For instance, the covert indicator presenting module 104 including the source entity associated representation inclusion determining module 257 of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 upon determining (e.g., as determined by the source entity associated representation inclusion determining module 257) that the received communiquéreception information 51* includes one or more representations associated with the source entity 20 in header data form (e.g., in the form of header information).

In the same or different implementations, operation 601 may include an operation 603 for presenting the covert indicator that covertly indicates the reception of the communiqué in accordance with the one or more conditional directives of the end user, the one or more conditional directives directing the presentation of the covert indicator upon determining that the received communiqué reception information includes at least one name associated with the source entity as depicted in FIG. 5g. For instance, the covert indicator presenting module 104 including the source entity associated name inclusion determining module 258 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 upon determining (e.g., as determined by the source entity associated name inclusion determining module 258) that the received communiqué reception information 51* includes at least one name (e.g., a legal name, a username, a website name, a business name, a nickname, and so forth) associated with the source entity 20.

In the same or different implementations, operation 601 may also include an operation 604 for presenting the covert indicator that covertly indicates the reception of the communiqué in accordance with the one or more conditional directives of the end user, the one or more conditional directives directing the presentation of the covert indicator upon determining that the received communiqué reception information includes at least one address associated with the source entity as depicted in FIG. 5g. For instance, the covert indicator presenting module 104 including the source entity associated address inclusion determining module 259 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 upon determining (e.g., as determined by the source entity associated address inclusion determining module 259) that the received communiqué reception information 51* includes at least one address associated with the source entity 20.

In some implementations, operation 604 may further include an operation 605 for presenting the covert indicator that covertly indicates the reception of the communiqué in accordance with the one or more conditional directives of the end user, the one or more conditional directives directing the presentation of the covert indicator upon determining that the received communiqué reception information includes at least one of an email address, an Internet Protocol (IP) address, or a Uniform Resource Locator (URL) associated with the source entity as depicted in FIG. 5g. For instance, the covert indicator presenting module 104 including the source entity associated address inclusion determining module 259 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 upon determining (e.g., as determined by the source entity associated address inclusion determining module 259) that the received communiqué reception information 51* includes at least one of an email address, an Internet Protocol (IP) address, or a Uniform Resource Locator (URL) associated with the source entity 20.

In the same or different implementations, operation 601 may also include an operation 606 for presenting the covert indicator that covertly indicates the reception of the communiqué in accordance with the one or more conditional directives of the end user, the one or more conditional directives directing the presentation of the covert indicator upon determining that the received communiqué reception information includes at least one telephone number associated with the source entity as depicted in FIG. 5h. For instance, the covert indicator presenting module 104 including the source entity associated telephone number inclusion determining module 260 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 upon determining (e.g., as determined by the source entity associated telephone number inclusion determining module 260) that the received communiqué reception information 51* includes at least one telephone number associated with the source entity 20.

In various implementations, the covert indicator presenting operation 304 of FIG. 3 may include an operation 607 for presenting the covert indicator that covertly indicates the reception of the communiqué in accordance with the one or more conditional directives of the end user, the one or more conditional directives directing the presentation of the covert indicator upon determining that the received communiqué reception information was provided by the source entity as further depicted in FIG. 5h. For instance, the covert indicator presenting module 104 including the source entity provided determining module 261 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 upon determining (e.g., as determined by the source entity provided determining module 261) that the received communiqué reception information 51* was provided by the source entity 20.

In the same or different implementations, the covert indicator presenting operation 304 may also include an operation 608 for presenting the covert indicator that covertly indicates the reception of the communiqué in accordance with the one or more conditional directives of the end user, the one or more conditional directives directing the presentation of the covert indicator as a function of location of a communication device executing the one or more conditional directives as depicted in FIG. 5h. For instance, the covert indicator presenting module 104 including the location determining module 262 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 as a function of location (e.g., as determined by the location determining module 262) of a communication device 10 executing the one or more conditional directives 50.

Operation 608, in turn, may further include an operation 609 for presenting the covert indicator that covertly indicates the reception of the communiqué in accordance with the one or more conditional directives of the end user, the one or more conditional directives directing the presentation of the covert indicator in response to determining that the communication device is at one or more locations as specified by the one or more conditional directives as further depicted in FIG. 5h. For instance, the covert indicator presenting module 104 including the location determining module 262 of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to determining by, for example, the location determining module 262 that the communication device 10 is at one or more locations as specified by the one or more conditional directives 50.

In the same or different implementations, the covert indicator presenting operation 304 may include an operation 610 for presenting the covert indicator that covertly indicates the reception of the communiqué in accordance with the one or more conditional directives of the end user, the one or more conditional directives directing the presentation of the covert indicator as a function of time of a communication device executing the one or more conditional directives as further depicted in FIG. 5h. For instance, the covert indicator presenting module 104 including the time determining module 263 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 as a function of time (e.g., as determined by the time determining module 263) of a communication device 10 executing the one or more conditional directives 50.

In various implementations, operation 610 may further include an operation 611 for presenting the covert indicator that covertly indicates the reception of the communiqué in accordance with the one or more conditional directives of the end user, the one or more conditional directives directing the presentation of the covert indicator in response to determining that the communication device is at one or more particular times of a day as specified by the one or more conditional directives as further depicted in FIG. 5h. For instance, the covert indicator presenting module 104 including the time determining module 263 of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to the time determining module 263 determining that the communication device 10 is at one or more particular times (e.g., between 6 and 8 AM and 6 PM and 10 PM) of a day as specified by the one or more conditional directives 50.

In some implementations, operation 610 may include an operation 612 for presenting the covert indicator that covertly indicates the reception of the communiqué in accordance with the one or more conditional directives of the end user, the one or more conditional directives directing the presentation of the covert indicator in response to determining that the communication device is at one or more particular times of a calendar year as specified by the one or more conditional directives as further depicted in FIG. 5h. For instance, the covert indicator presenting module 104 including the time determining module 263 of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to the time determining module 263 determining that the communication device 10 is at one or more particular times of a calendar year (e.g., month of January) as specified by the one or more conditional directives 50.

As further illustrated in FIG. 5h, the covert indicator presenting operation 304 of FIG. 3, in various implementations, may include an operation 613 for presenting the covert indicator that covertly indicates the reception of the communiqué in accordance with the one or more conditional directives of the end user, the one or more conditional directives directing the presentation of the covert indicator in response to determining occurrence of one or more specified environmental conditions associated with a communication device executing the one or more conditional directives, the one or more specified environmental conditions being specified by the one or more conditional directives. For instance, the covert indicator presenting module 104 including the environmental condition determining module 264 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to, for example, the environmental condition determining module 264 determining occurrence of one or more specified environmental conditions associated with a communication device 10 executing the one or more conditional directives 50, the one or more specified environmental conditions (e.g., presence or absence of one or more third parties in the proximate vicinity of the communication device 10, whether the communication device 10 is in a work environment or social environment, and so forth) being specified by the one or more conditional directives 50.

In some implementations, operation 613 may further include an operation 614 for presenting the covert indicator that covertly indicates the reception of the communiqué in accordance with the one or more conditional directives of the end user, the one or more conditional directives directing the presentation of the covert indicator in response to determining that one or more third parties are in proximate vicinity of the communication device as further depicted in FIG. 5h. For instance, the covert indicator presenting module 104 including the third party proximity determining module 265 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to the third party proximity determining module 265 determining that one or more third parties (e.g., one or more third parties as specified by the one or more conditional directives 50) are in proximate vicinity (e.g., within 3 feet, 5 feet, 8 feet, or within any other maximum distance from the communication device 10 from which a third party can see/hear/sense a communiqué being presented through the communication device 10) of the communication device 10.

In various implementations, the covert indicator presenting operation 304 of FIG. 3 may be implemented when the communication device 10 is determined not to be in the possession of the end user 32. For example, in some implementations, the covert indicator presenting operation 304 may include an operation 615 for presenting the covert indicator that covertly indicates the reception of the communiqué in accordance with the one or more conditional directives of the end user, the one or more conditional directives directing the presentation of the covert indicator in response to determining that a communication device executing the one or more conditional directives is not possessed by the end user as depicted in FIG. 5i. For instance, the covert indicator presenting module 104 including the end user possession determining module 266 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to, for example, the end user possession determining module 266 determining that a communication device 10 executing the one or more conditional directives 50 is not possessed (e.g., controlled) by the end user 32. Note that in various implementations the end user possession determining module 266 may be designed to determine whether the end user 32 does or does not have possession of the communication device 10. Such a determination may be based on a number of factors as will be further described herein.

As further illustrated in FIG. 5i, operation 615 may further include one or more additional operations in various alternative implementations. For example, in some implementations, operation 615 may further include an operation 616 for presenting the covert indicator that covertly indicates the reception of the communiqué in accordance with the one or more conditional directives of the end user, the one or more conditional directives directing the presentation of the covert indicator in response to determining absence of a verification of the end user having possession of the communication device as further illustrated in FIG. 5i. For instance, the covert indicator presenting module 104 including the end user possession verification determining module 267 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to, for example, the end user possession verification determining module 267 determining absence of a verification (e.g., absence of verifying data or input) of the end user 32 having possession of the communication device 10.

In some implementations, operation 616 may further include an operation 617 for presenting the covert indicator that covertly indicates the reception of the communiqué in accordance with the one or more conditional directives of the end user, the one or more conditional directives directing the presentation of the covert indicator in response to determining absence of a password verification of the end user having possession of the communication device as further depicted in FIG. 5i. For instance, the covert indicator presenting module 104 including the end user password verification determining module 268 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to the end user password verification determining module 268 determining absence of a password verification of the end user 32 having possession (e.g., control) of the communication device 10. In other words, the communication device 10 may request that the end user 32 provide a particular password, which may or may not have been originally selected by the end user 32, in order to verify that the communication device 10 is in the possession of the end user 32. If the correct password has not been provided then a determination is made that the end user 32 is not in the possession of the communication device 10.

In the same or different implementations, operation 616 may also include an operation 618 for presenting the covert indicator that covertly indicates the reception of the communiqué in accordance with the one or more conditional directives of the end user, the one or more conditional directives directing the presentation of the covert indicator in response to determining absence of a biometric verification of the end user having possesion of the communication device as further depicted in FIG. 5i. For instance, the covert indicator presenting module 104 including the end user biometric verification determining module 269 (see FIG. 2c) of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to, for example, the end user biometric verification determining module 269 determining absence of a biometric verification (e.g., absence of biometric data provided by sensors 150) of the end user 32 having possession of the communication device 10.

In some cases, operation 618 may, in turn, further include an operation 619 for presenting the covert indicator that covertly indicates the reception of the communiqué in accordance with the'one or more conditional directives of the end user, the one or more conditional directives directing the presentation of the covert indicator in response to determining absence of at least one of a facial recognition verification, a retinal scan verification, a voice verification, or a fingerprint verification of the end user having possession of the communication device as further depicted in FIG. 5i. For instance, the covert indicator presenting module 104 including the end user biometric verification determining module 269 of the communication device 10 of FIGS. 1a and 1b presenting the covert indicator 54 that covertly indicates the reception of the communiqué 52* in accordance with the one or more conditional directives 50 of the end user 32, the one or more conditional directives 50 directing the presentation of the covert indicator 54 in response to, for example, the end user biometric verification determining module 269 determining absence of at least one of a facial recognition verification, a retinal scan verification, a voice verification, or a fingerprint verification of the end user 32 having possession of the communication device 10.

In various implementations, the covert indicator presenting operation 304 of FIG. 3 may include an operation 620 for presenting the covert indicator that covertly indicates the reception of the communiqué in accordance with the one or more conditional directives of the end user, the presenting of the covert indicator being in lieu of presenting any direct indications of reception of the communiqué as further depicted in FIG. 5i. For instance, the covert indicator presenting module 104 of the communication device 10 of FIGS. 1a and 1b presenting the covert indicator 54 that covertly indicates the reception of the communiqué 52* in accordance with the one or more conditional directives 50 of the end user 32, the presenting of the covert indicator being in lieu of presenting any (e.g., all) direct indications of reception of the communiqué 52*.

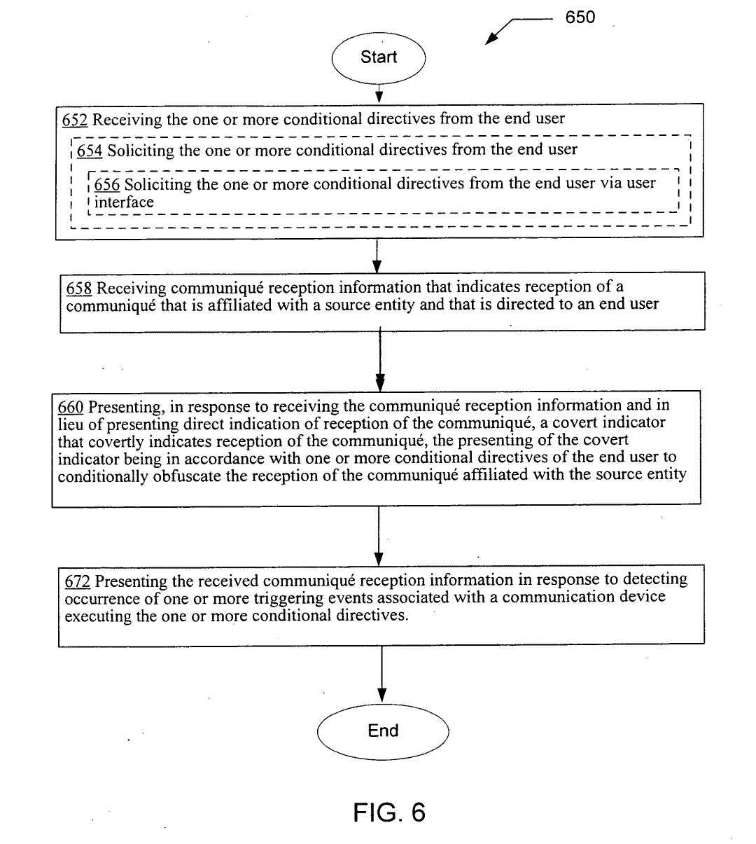

Referring to FIG. 6 illustrating another operational flow 650 in accordance with various embodiments. Operational flow 650 includes certain operations that mirror the operations included in operational flow 300 of FIG. 3. These operations include a communiqué reception information receiving operation 658 and a covert indicator presenting operation 660 that corresponds to and mirror the communiqué receiving reception information receiving operation 302 and the covert indicator presenting operation 304, respectively, of FIG. 3.

In addition, operational flow 650 may include a conditional directive receiving operation 652 for receiving the one or more conditional directives from the end user as depicted in FIG. 6. For instance, the conditional directive receiving module 106 of the communication device 10 receiving (e.g., via the user interface 120 including a microphone, a keypad or keyboard, a mouse, a touchscreen, and/or other hardware devices) the one or more conditional directives 50 from the end user 32.

In some cases, the conditional directive receiving operation 652 may include an operation 654 for soliciting the one or more conditional directives from the end user as further depicted in FIG. 6. For instance, the conditional directive soliciting module 107 (see FIG. 2d) of the communication device 10 of FIGS. 1a and 1b soliciting the one or more conditional directives 50 from the end user 32. Such a solicitation may be made through a display system 121 (e.g., display monitor, touchscreen, keyboard, keypad, mouse, and so forth) and/or an audio system (e.g., one or more speakers, microphone, and so forth) by visually and/or audioally requesting the end user 32 to at least indicate conditions for presenting a covert indicator 54 that covertly indicates reception of a communiqué 52* that is affiliated with a particUlar source entity 20 and that is directed to the end user 32 in lieu of presenting any direct indication of the reception of the communiqué 52.

In some implementations, operation 654 may further include an operation 656 for soliciting the one or more conditional directives from the end user via user interface as further depicted in FIG. 6. For instance, the conditional directive soliciting module 107 of the communication device 10 soliciting the one or more conditional directives 50 from the end user 32 via user interface 120 (e.g., display monitor including an LCD or a touchscreen, keypad, mouse, one or more speakers, and/or a microphone)

In some cases, operational flow 650 may further include a communiqué reception information presenting operation 672 for presenting the received communiqué reception information in response to detecting occurrence of one or more triggering events associated with a communication device executing the one or more conditional directives as further illustrated in FIG. 6. For instance, the communiqué reception information presenting module 110 of the communication device 10 of FIGS. 1a and 1b presenting the received communiqué reception information 51* in response to detecting occurrence of one or more triggering events associated with a communication device 10 executing the one or more conditional directives 50. In some cases, in order to present the received communiqué reception information 51*, the received communiqué reception information 51* may be retrieved from a memory 140 where the received communiqué reception information 51* may have been previously stored.

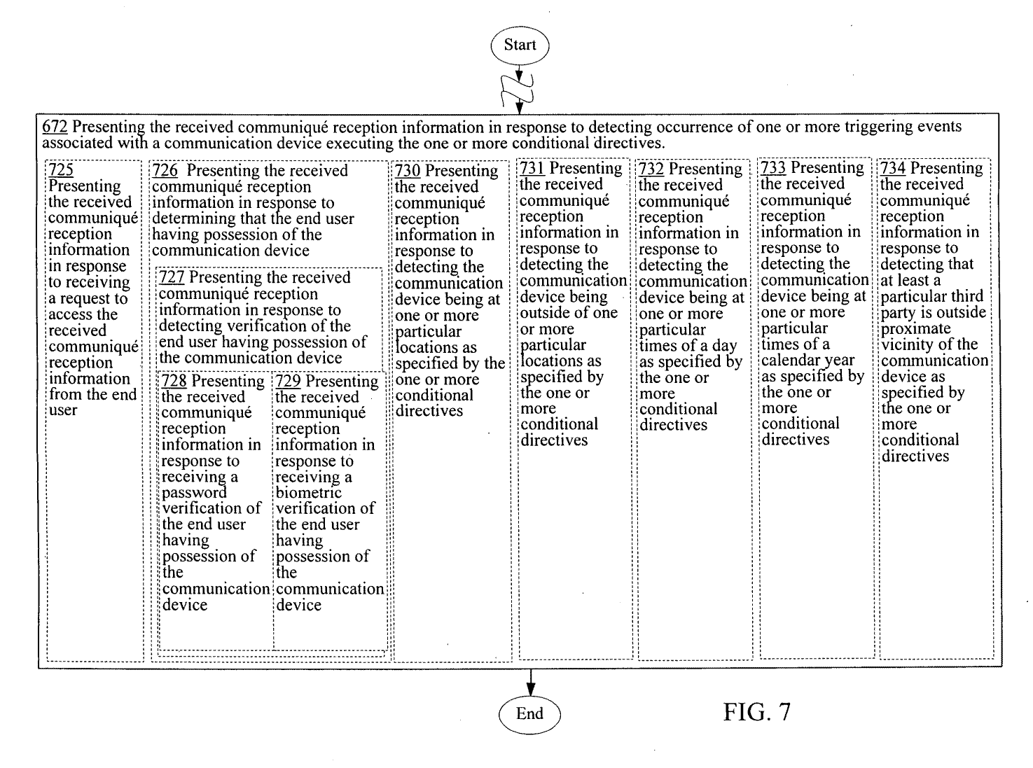

As further illustrated in FIG. 7, the communiqué reception information presenting operation 672 of FIG. 6 may be implemented in a number of different ways in various alternative implementations. For example, in some implementations, the communiqué reception information presenting operation 672 may include an operation 725 for presenting the received communiqué reception information in response to receiving a request to access the received communiqué reception information from the end user as depicted in FIG. 7. For instance, the communiqué reception information presenting module 110 of the communication device 10 of FIGS. 1a and 1b presenting (audioally and/or visually presenting) the received communiqué reception information 51* in response to receiving a request to access the received communiqué reception information 51* from the end user 32.

In the same or different implementations, the communiqué reception information presenting operation 672 may include an operation 726 for presenting the received communiqué reception information in response to determining that the end user having possession of the communication device as further depicted in FIG. 7. For instance, the communiqué reception information presenting module 110 including the end user possession determining module 270 (see FIG. 2e) of the communication device 10 of FIGS. 1a and 1b presenting the received communiqué reception information 51* in response to, for example, the end user possession determining module 270 determining that the end user 32 having possession of the communication device 10.

In some cases, operation 726 may further include an operation 727 for presenting the received communiqué reception information in response to detecting verification of the end user having possession of the communication device as further depicted in FIG. 7. For instance, the communiqué reception information presenting module 110 including the end user possession verification detecting module 271 (see FIG. 2e) of the communication device 10 of FIGS. 1a and 1b presenting the received communiqué reception information 51* in response to, for example, the end user possession verification detecting module 271 detecting verification of the end user 32 having possession of the communication device 10.

Operation 727, in turn, may further include one or more additional operations in various implementations. For example, in some implementations, operation 727 may include an operation 728 for presenting the received communiqué reception information in response to receiving a password verification of the end user having possession of the communication device as further depicted in FIG. 7. For instance, the communiqué reception information presenting module 110 including the password verification receiving module 272 (see FIG. 2e) of the communication device 10 of FIGS. 1a and 1b presenting the received communiqué reception information 51* in response to, for example, the password verification receiving module 272 receiving a password verification of the end user 32 having possession of the communication device 10. Such password verification may be provided through, for example, a microphone, a keypad, a keyboard, a mouse, a touchscreen and/or other hardware devices designed to receive data from an end user 32.

In the same or different implementations, operation 727 may include an operation 729 for presenting the received communiqué reception information in response to receiving a biometric verification of the end user having possession of the communication device as further depicted in FIG. 7. For instance, the communiqué reception information presenting module 110 including the biometric verification receiving module 273 (see FIG. 2e) of the communication device 10 of FIGS. 1a and 1b presenting the received communiqué reception information 51* in response to, for example, the biometric verification receiving module 273 receiving a biometric verification (e.g., a facial recognition verification, a retinal scan verification, a voice verification, or a fingerprint verification) of the end user 32 having possession of the communication device 10.

In the same or different implementations, the communiqué reception information presenting operation 672 may include an operation 730 for presenting the received communiqué reception information in response to detecting the communication device being at one or more particular locations as specified by the one or more conditional directives as further depicted in FIG. 7. For instance, the communiqué reception information presenting module 110 including the location determination module 274 (see FIG. 2e) of the communication device 10 of FIGS. 1a and 1b presenting the received communiqué reception information 51* in response to, for example, the location determination module 274 (using data provided by GPS 151) detecting the communication device 10 being at one or more particular locations as specified by the one or more conditional directives 50.

In the same or different implementations, the communiqué reception information presenting operation 672 may include an operation 731 for presenting the received communiqué reception information in response to detecting the communication device being outside of one or more particular locations as specified by the one or more conditional directives as further depicted in FIG. 7. For instance, the communiqué reception information presenting module 110 including the location determination module 274 of the communication device 10 of FIGS. 1a and 1b presenting the received communiqué reception information 51* in response to, for example, the location determination module 274 (using data provided by GPS 151) detecting the communication device 10 being outside of one or more particular locations as specified by the one or more conditional directives 50.

In the same or different implementations, the communiqué reception information presenting operation 672 may include an operation 732 for presenting the received communiqué reception information in response to detecting the communication device being at one or more particular times of a day as specified by the one or more conditional directives as further depicted in FIG. 7. For instance, the communiqué reception information presenting module 110 including the time determination module 275 of the communication device 10 of FIGS. 1a and 1b presenting the received communiqué reception information 51* in response to, for example, the time determination module 275 detecting the communication device 10 being at one or more particular times of a day as specified by the one or more conditional directives 50.

In the same or different implementations, the communiqué reception information presenting operation 672 may include an operation 733 for presenting the received communiqué reception information in response to detecting the communication device being at one or more particular times of a calendar year as specified by the one or more conditional directives as further depicted in FIG. 7. For instance, the communiqué reception information presenting module 110 including the time determination module 275 of the communication device 10 of FIGS. 1a and 1b presenting the received communiqué reception information 51* in response to, for example, the time determination module 275 detecting the communication device 10 being at one or more particular times of a calendar year as specified by the one or more conditional directives 50.

In the same or different implementations, the communiqué reception information presenting operation 672 may include an operation 734 for presenting the received communiqué reception information in response to detecting that at least a particular third party is outside proximate vicinity of the communication device as specified by the one or more conditional directives as further depicted in FIG. 7. For instance, the communiqué reception information presenting module 110 including the third party proximity detecting module 276 of the communication device 10 of FIGS. 1a and 1b presenting the received communiqué reception information 51* in response to, for example, the third party proximity detecting module 276 detecting that at least a particular third party is outside proximate vicinity (e.g., outside of 3 feet, 5 feet, 8 feet, or outside any other maximum distance from the communication device 10 from which a third party can see/hear/sense a communiqué being presented through the communication device 10) of the communication device 10 as specified by the one or more conditional directives 50.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g.; a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1.-271. (canceled)

272. A system, comprising:
a communiqué reception information receiving module configured to receive communiqué reception information that indicates reception of a communiqué affiliated with a source entity and that is directed to an end user; and
a covert indicator presenting module configured to present a covert indicator that covertly indicates reception of the communiqué, the presenting of the covert indicator being in accordance with one or more conditional directives of the end user to conditionally obfuscate the reception of the communiqué affiliated with the source entity, the presenting of the covert indicator being in response to receiving the communiqué reception information and in lieu of presenting direct indication of reception of the communiqué.

273. (canceled)

274. The system of claim 272, wherein said communiqué reception information receiving module comprises:
a communiqué reception information intercepting module configured to intercept the communiqué reception information to prevent direct indication of reception of the communiqué from being at least initially presented, the interception being in accordance with the one or more conditional directives.

275. (canceled)

276. The system of claim 274, wherein said communiqué reception information intercepting module comprises:
a communiqué reception information intercepting module configured to intercept the communiqué reception information to prevent direct indication of reception of the communiqué from being at least automatically presented.

277. The system of claim 276, wherein said communiqué reception information intercepting module comprises:
a communiqué reception information intercepting module configured to intercept the communiqué reception information to prevent direct indication of reception of the communiqué from being at least automatically presented in response to the reception of the communiqué reception information.

278. The system of claim 274, wherein said communiqué reception information intercepting module comprises:
a communiqué reception information intercepting module including a communiqué reception information holding module configured to intercept the communiqué reception information by having the communiqué reception information holding module hold the communiqué reception information at least temporarily in memory.

279. The system of claim 278, wherein said a communiqué reception information intercepting module including a communiqué reception information holding module comprises:
a communiqué reception information intercepting module including a communiqué reception information holding module configured to intercept the communiqué reception information by having the communiqué reception information holding module hold the communiqué reception information at least temporarily in memory without releasing the communiqué reception information.

280. (canceled)

281. The system of claim 279, wherein said communiqué reception information intercepting module including a communiqué reception information holding module comprises:
a communiqué reception information intercepting module including a communiqué reception information holding module and a triggering event determining module configured to intercept the communiqué reception information by having the communiqué reception information holding module hold the communiqué reception information at least temporarily in memory without releasing the communiqué reception information at least until the triggering event determining module determines occurrence of one or more triggering events associated with a communication device executing the one or more conditional directives.

282.-285. (canceled)

286. The system of claim 281, wherein said communiqué reception information intercepting module including a communiqué reception information holding module and a triggering event determining module comprises:
a communiqué reception information intercepting module including a communiqué reception information holding module and a location detecting module configured to intercept the communiqué reception information by having the communiqué reception information holding module hold the communiqué reception information at least temporarily in memory without releasing the communiqué reception information at least until the location detecting module detects the communication device being at one or more particular locations as specified by the one or more conditional directives.

287. The system of claim 281, wherein said communiqué reception information intercepting module including a communiqué reception information holding module and a triggering event determining module comprises:
a communiqué reception information intercepting module including a communiqué reception information holding module and a time detecting module configured to intercept the communiqué reception information by having the communiqué reception information holding module hold the communiqué reception information at least temporarily in memory without releasing the communiqué reception information at least until the time detecting module detects the communication device being at one or more particular times of a day as specified by the one or more conditional directives.

288. (canceled)

289. The system of claim 281, wherein said communiqué reception information intercepting module including a communiqué reception information holding module and a triggering event determining module comprises:
a communiqué reception information intercepting module including a communiqué reception information holding module and a third party proximity detecting module configured to intercept the communiqué reception information by having the communiqué reception information holding module hold the communiqué reception information at least temporarily in memory without releasing the communiqué reception information at least until the third party proximity detecting module detects that at least a particular third party is outside proximate vicinity of the communication device as specified by the one or more conditional directives.

290.-292. (canceled)

293. The system of claim 274, wherein said communiqué reception information intercepting module comprises:
a communiqué reception information intercepting module including a source entity representation inclusion determining module configured to intercept the communiqué reception information by intercepting the communiqué reception information in response at least in part to the source entity representation inclusion determining module determining that the communiqué reception information includes one or more representations associated with the source entity, the one or more representations being specified by the one or more conditional directives.

294.-298. (canceled)

299. The system of claim 274, wherein said communiqué reception information intercepting module comprises:
a communiqué reception information intercepting module including a communication device location determining module configured to intercept the communiqué reception information by intercepting the communiqué reception information as a function of location, as determined by the communication device location determining module, of a communication device executing the one or more conditional directives.

300. The system of claim 299, wherein said communiqué reception information intercepting module including a communication device location determining module comprises:
a communiqué reception information intercepting module including a communication device location determining module configured to intercept the communiqué reception information by intercepting the communiqué reception information in response to the communication device location determining module determining that the communication device is at one or more specified locations as specified by the one or more conditional directives.

301. The system of claim 274, wherein said communiqué reception information intercepting module comprises:
a communiqué reception information intercepting module including a communication device time determining module configured to intercept the communiqué reception information by intercepting the communiqué reception information as a function of time, as determined by the communication device time determining module, with respect to a communication device executing the one or more conditional directives.

302.-303. (canceled)

304. The system of claim 274, wherein said communiqué reception information intercepting module comprises:
a communiqué reception information intercepting module including an environmental condition determining module configured to intercept the communiqué reception information by intercepting the communiqué reception information as a function of one or more environmental conditions, as determined by the environmental condition determining module, of a communication device executing the one or more conditional directives.

305. The system of claim 304, wherein said communiqué reception information intercepting module including an environmental condition determining module comprises:
a communiqué reception information intercepting module including a third party proximity determining module configured to intercept the communiqué reception information by intercepting the communiqué reception information in response to the third party proximity determining module determining presence of a third party within proximate vicinity of the communication device.

306.-332. (canceled)

333. The system of claim 272, wherein said covert indicator presenting module comprises:
a covert indicator presenting module configured to present the covert indicator via user interface.

334. (canceled)

335. The system of claim 333, wherein said covert indicator presenting module comprises:
a covert indicator presenting module configured to present the covert indicator by audioally indicating the covert indicator via an audio system.

336. (canceled)

337. The system of claim 272, wherein said covert indicator presenting module comprises:
a covert indicator presenting module configured to present the covert indicator by presenting an indicator that indirectly indicates the reception of the communiqué, the indicator to be presented being defined by the one or more conditional directives of the end user.

338. The system of claim 337, wherein said covert indicator presenting module comprises:
a covert indicator presenting module including a covert audio indicator presenting module configured to present the indicator by having the covert audio indicator presenting module present a covert audio indicator that audioally indirectly indicates the reception of the communiqué, the covert audio indicator to be presented being defined by the one or more conditional directives of the end user.

339. The system of claim 338, wherein said covert indicator presenting module including a covert audio indicator presenting module comprises:
a covert audio indicator presenting module configured to present audioally at least a ping, a ring, or a hum that indirectly indicates the reception of the communiqué, the at least a ping, a ring, or a hum to be audioally presented being defined by the one or more conditional directives.

340. The system of claim 338, wherein said covert indicator presenting module including a covert audio indicator presenting module comprises:
a covert audio indicator presenting module configured to present audioally at least one or more simulated natural background noises that indirectly indicates the reception of the communiqué, the at least one or more simulated natural background noises to be audioally presented being in accordance with the one or more conditional directives of the end user.

341. The system of claim 338, wherein said covert indicator presenting module including a covert audio indicator presenting module comprises:
a covert audio indicator presenting module including a voice message presenting module configured to present the covert audio indicator by having the voice message presenting module present audioally at least one voice message that indirectly indicates the reception of the communiqué, the at least one voice message to be audioally presented being in accordance with the one or more conditional directives of the end user.

342. The system of claim 341, wherein said covert audio indicator presenting module including a voice message presenting module comprises:
a voice message presenting module including a fictional voice message presenting module configured to present audioally the at least one voice message by having the fictional voice message presenting module present audioally a fictional voice message that indirectly indicates reception of the communiqué and that is presented in accordance with the one or more conditional directives of the end user.

343. The system of claim 341, wherein said covert audio indicator presenting module including a voice message presenting module comprises:
a voice message presenting module configured to present audioally the at least one voice message by presenting audioally at least one voice message in a particular tone or speech pattern that indirectly indicates the reception of the communiqué, the particular tone or speech pattern of the at least one voice message to be audioally presented being in accordance with the one or more conditional directives of the end user.

344. (canceled)

345. The system of claim 341, wherein said covert audio indicator presenting module including a voice message presenting module comprises:
a voice message presenting module including a modified voice message presenting module configured to present audioally the at least one voice message by having the modified voice message presenting module present a modified version of a voice message that was previously presented and that has been modified to include a covert audio indicator that indirectly indicates the reception of the communiqué.

346. The system of claim 337, wherein said covert indicator presenting module comprises:
a covert indicator presenting module including a covert visual indicator presenting module configured to present the indicator by having the covert visual indicator presenting module present a covert visual indicator that visually indirectly indicates the reception of the communiqué, the covert visual indicator to be presented being defined by the one or more conditional directives of the end user.

347. (canceled)

348. The system of claim 346, wherein said covert indicator presenting module including a covert visual indicator presenting module comprises:
a covert visual indicator presenting module configured to present visually one or more particular colors that indirectly indicates the reception of the communiqué, the one or more particular colors to be visually presented being in accordance with the one or more conditional directives of the end user.

349. The system of claim 346, wherein said covert indicator presenting module including a covert visual indicator presenting module comprises:
a covert visual indicator presenting module including a visual message presenting module configured to present the covert visual indicator by having the visual message presenting module present visually at least one visual message that indirectly indicates the reception of the communiqué, the at least one visual message to be visually presented being in accordance with the one or more conditional directives of the end user.

350. The system of claim 349, wherein said covert visual indicator presenting module including a visual message presenting module comprises:
a visual message presenting module configured to present visually at least one visual message that includes one or more words or phrases that indirectly indicates the reception of the communiqué, the one or more words or phrases to be visually presented being in accordance with the one or more conditional directives of the end user.

351. The system of claim 349, wherein said covert visual indicator presenting module including a visual message presenting module comprises:
a visual message presenting module configured to present visually at least one visual message that includes one or more words or phrases in a particular font or style that indirectly indicates the reception of the communiqué, the one or more words or phrases to be visually presented in a particular font or style being in accordance with the one or more conditional directives of the end user.

352. The system of claim 349, wherein said covert visual indicator presenting module including a visual message presenting module comprises:
a visual message presenting module including a fictional visual message presenting module or a modified visual message presenting module configured to present visually the at least one visual message by having the fictional visual message presenting module present visually a fictional visual message that indirectly indicates reception of the communiqué and that is presented in accordance with the one or more conditional directives of the end user or by having the modified visual message presenting module present visually a modified version of a visual message that was previously presented and that has been modified to include the covert visual indicator that indirectly indicates the reception of the communiqué.

353. The system of claim 337, wherein said covert indicator presenting module comprises:
a covert indicator presenting module including a covert vibrating indicator presenting module configured to present the indicator by having the covert vibrating indicator presenting module present a covert vibrating indicator that indicates, via a specific vibration, the reception of the communiqué, the specific vibration to be presented being in accordance with the one or more conditional directives of the end user.

354. The system of claim 353, wherein said covert indicator presenting module including a covert vibrating indicator presenting module comprises:
a covert vibrating indicator presenting module configured to present a specific vibration having a particular vibration pattern in accordance with the one or more conditional directives of the end user.

355. (canceled)

356. The system of claim 272, wherein said covert indicator presenting module comprises:
a covert indicator presenting module including a graphical user interface (GUI) presenting module configured to present the covert indicator by having the graphical user interface (GUI) presenting module present a graphical user interface that includes the covert indicator.

357. The system of claim 356, wherein said covert indicator presenting module including a graphical user interface (GUI) presenting module comprises:
a graphical user interface (GUI) presenting module including a modified GUI presenting module configured to present the graphical user interface that includes the covert indicator by having the modified GUI presenting module present a modified version of an original graphical user interface that was previously presented, the modified version of the original graphical user interface to be presented including the covert indicator.

358. (canceled)

359. The system of claim 272, wherein said covert indicator presenting module comprises:
a covert indicator presenting module including a communiqué application interface presenting module configured to present the covert indicator by having the communiqué application interface presenting module present a communiqué application interface that includes an indicator that indirectly indicates the reception of the communiqué, the indicator to be included in the communiqué application interface being defined by the one or more conditional directives of the end user.

360.-378. (canceled)

379. The system of claim 272, wherein said covert indicator presenting module comprises:
a covert indicator presenting module including a location determining module configured to present the covert indicator in accordance with the one or more conditional directives of the end user, the one or more conditional directives directing the presentation of the covert indicator as a function of location as determined by the location determining module of a communication device executing the one or more conditional directives.

380. The system of claim 379, wherein said covert indicator presenting module including a location determining module comprises:
a covert indicator presenting module including a location determining module configured to present the covert indicator in accordance with the one or more conditional directives of the end user, the one or more conditional directives directing the presentation of the covert indicator in response to determining by the location determining module that the communication device is at one or more locations as specified by the one or more conditional directives.

381. The system of claim 272, wherein said covert indicator presenting module comprises:
a covert indicator presenting module including a time determining module configured to present the covert indicator in accordance with the one or more conditional directives of the end user, the one or more conditional directives directing the presentation of the covert indicator as a function of time, as determined by the time determining module, of a communication device executing the one or more conditional directives.

382.-383. (canceled)

384. The system of claim 272, wherein said covert indicator presenting module comprises:
a covert indicator presenting module including an environmental condition determining module configured to present the covert indicator in accordance with the one or more conditional directives of the end user, the one or more conditional directives directing the presentation of the covert indicator in response to the environmental condition determining module determining occurrence of one or more specified environmental conditions associated with a communication device executing the one or more conditional directives, the one or more specified environmental conditions being specified by the one or more conditional directives.

385. The system of claim 384, wherein said covert indicator presenting module including an environmental condition determining module comprises:
a covert indicator presenting module including a third party presence determining module configured to present the covert indicator in accordance with the one or more conditional directives of the end user, the one or more conditional directives directing the presentation of the covert indicator in response to the third party presence determining module determining that one or more third parties are in proximate vicinity of the communication device.

386.-391. (canceled)

392. A computationally-implemented system comprising:
means for receiving communiqué reception information that indicates reception of a communiqué that is affiliated with a source entity and that is directed to an end user; and
means for presenting, in response to receiving the communiqué reception information and in lieu of presenting direct indication of reception of the communiqué, a covert indicator that covertly indicates reception of the communiqué, the presenting of the covert indicator being in accordance with one or more conditional directives of the end user to conditionally obfuscate the reception of the communiqué affiliated with the source entity.
